(19) United States
(12) Patent Application Publication
(10) Pub. No.: US 2023/0342519 A1
(43) Pub. Date: Oct. 26, 2023

(54) ADJUSTMENT SIMULATION METHOD FOR ENERGY CONSUMPTION

(71) Applicant: Cenergistic LLC, Dallas, TX (US)

(72) Inventors: Jack Bullock, Dallas, TX (US); Bryan Sons, Dallas, TX (US); Sean Monroe, Frisco, TX (US)

(73) Assignee: Cenergistic LLC, Dallas, TX (US)

(21) Appl. No.: 18/326,874

(22) Filed: May 31, 2023

Related U.S. Application Data
(63) Continuation-in-part of application No. 16/667,672, filed on Oct. 29, 2019.
Application No. 16/667,672 is a continuation-in-part of application No. 15/214,211, filed on Jul. 19, 2016, now Pat. No. 10,460,049.
Application No. 15/214,211 is a continuation of application No. 13/670,287, filed on Nov. 6, 2012, now Pat. No. 9,396,293.
(60) Provisional application No. 63/478,180, filed on Jan. 2, 2023.

(51) Int. Cl. G06Q 30/0201; G06F 30/367; G06F 30/20; G06Q 30/0204; G06F 30/13

(52) U.S. Cl. CPC G06F 30/20; G06F 30/13; G06F 30/367; G06Q 30/0201; G06Q 30/0205; G06Q 30/0206; Y02T 10/82

(57) ABSTRACT

Analyzing energy savings for a building includes receiving historical energy usage and weather data for a building, a set of operations parameters describing building operations and a set of building system parameters describing building systems. A baseline configuration is submitted to a first energy consumption simulation to determine a baseline energy usage profile A calibrated configuration is determined from the baseline configuration and the historical energy usage. An energy usage aberration is identified in the current year. The calibrated energy usage profile is adjusted to account for it. The difference between actual energy usage for the current year and the adjusted calibrated energy usage profile is an accurate measure of savings.

### CROSS REFERENCE TO RELATED APPLICATIONS

This application is a continuation-in-part of U.S. Application No. 16/667,672 filed on Oct. 29, 2019, which is a continuation-in-part of U.S. Application No. 15/214,211 filed Jul. 19, 2016, now U.S. Pat. No. 10,460,049 granted on Oct. 29, 2019 which is a continuation of U.S. Application No. 13/670,287 filed Nov. 6, 2012, now U.S. Pat. No. 9,396,293 granted on Jul. 19, 2016. This application claims priority benefit from U.S. Provisional Application No. 63/478,180, filed on Jan. 2, 2023. The patent applications identified above are incorporated here by reference in their entirety to provide continuity of disclosure.

### REFERENCE TO COMPUTER PROGRAM LISTING

This application includes multiple computer program listings that are grouped into Computer Program Listing Appendix 1, Computer Program Listing Appendix 2, Computer Program Listing Appendix 3, Computer Program Listing Appendix 4, Computer Program Listing Appendix 5, Computer Program Listing Appendix 6, Computer Program Listing Appendix 7, Computer Program Listing Appendix 8, Computer Program Listing Appendix 9, Computer Program Listing Appendix 10, Computer Program Listing Appendix 11, Computer Program Listing Appendix 12, Computer Program Listing Appendix 13, Computer Program Listing Appendix 14, Computer Program Listing Appendix 15, Computer Program Listing Appendix 16, Computer Program Listing Appendix 18, Computer Program Listing Appendix 19, Computer Program Listing Appendix 20 and Computer Program Listing Appendix 21.

### FIELD OF THE INVENTION

The present invention relates to assessment, calibration and modification of the energy usage profile for a building to impact energy consumption by the building and occupants.

### BACKGROUND OF THE INVENTION

Control of energy costs is a high priority with businesses and governments. The assessment of a baseline energy usage profile for a building as related to mechanical systems consumption due to heating and cooling loads is fairly well understood according to building science principles. The baseline energy costs may be inaccurate due to unverified and unreported occupant and systems behavior which is not directly discoverable. Furthermore, there are a large number of variables involved in the modeling of energy consumption such as occupant behavioral factors and unknown equipment efficiencies that feed inaccuracy of the results and lead to poor decision making. Calibration of the baseline energy usage profile to historical energy usage is possible; however, calibration methods are not an exact science due to the large number of variables involved.

Among the many technical challenges which exist in the area of calculating energy savings is logging data and lack of data integrity with billing and meter read data supplied by transmission and distribution service providers (TDSP) such as public utilities companies. The data integrity issues can typically occur between the TDSP and those who request the data such as a retail electric provider (REP). Typically the data integrity issues include missing data and/or errors in meter reads which can be inconsistent with past energy usage. Without appropriate correction savings calculations are inaccurate and unreliable.

Another technical challenge is presenting savings to the user in real time, as settings and other measures are taken to change energy usage. Without quick feedback, savings changes are more difficult to implement.

U.S. Pat. No. 6,134,511 to Subbarao discloses a method and apparatus for improving building energy simulations where the calibration of building energy simulations with performance data is accomplished by introducing corrective heat flows. Subbarao utilizes the energy simulator DOE-2 which requires complex evaluation of a large number of inputs and outputs and is not suitable for providing rapid feedback.

U.S. Pat. No. 6,968,295 to Carr discloses a method of and system for auditing the energy-usage by a facility, where the facility includes an energy-using system having an operational parameter with a value. Carr does not disclose a calibration process for energy-usage.

U.S. Pat. No. 7,881,889 to Barclay, et al. discloses a computer implemented method to facilitate determining energy cost savings in an energy consuming facility using an artificial intelligence model. The drawback of Barclay et al. is that the disclosed method requires a wide variety of training data sets to predict energy savings accurately.

U.S. Pat. Publication No. 2011/0153103 to Brown, et al. discloses a system and method for predictive modeling of building energy consumption providing predicted building energy load values determined by smoothing of historical building energy load values for a building. Brown requires complex optimization training to optimize prediction of building energy load values by “cross-validation error minimization.”

U.S. Pat. Publication No. 2011/0246381 to Fitch, et al. discloses a method of modeling energy usage and cost impacts for a building and comparing a theoretical data set to an actual building performance to determine a margin of error. Fitch requires complex evaluation of a large number of inputs and outputs.

U.S. Pat. Publication No. 2011/0251933 to Egnor, et al. discloses a system and method for modeling a building’s energy usage over time based on historic data. Egnor uses a regression analysis which requires extensive data sets for predicting the energy usage of the building.

U.S. Pat. Publication No. 2012/0084063 to Drees, et al. discloses a system for detecting changes in energy usage in a building. A baseline energy usage model is determined from a least squares regression analysis.

### BRIEF DESCRIPTION OF THE DRAWINGS

Embodiments of the present invention and its advantages are best understood by referring to the Figures provided.

FIG. 1A is a block diagram of a building energy delivery and consumption system and the dedicated calculation processor.

FIG. 1B is an architecture diagram of a preferred dedicated calculation processor.

FIG. 1C is an architecture diagram of a preferred administrator device.

FIG. 1D is an architecture diagram of a preferred data correction processor.

FIG. 2A is a flowchart of a preferred embodiment of a method to determine, calibrate and modify an energy usage profile for a building to improve energy consumption.

FIG. 2B is a network diagram of an energy usage calibration model.

FIG. 2C is a flowchart of a preferred embodiment of a method of transforming low integrity data into high integrity data for use in calculation of accurate savings.

FIG. 3 is a preferred embodiment of an electronic form to receive historical energy usage data.

FIG. 4 is a preferred embodiment of an electronic form to receive a building configuration including occupancy information and a set of building physical parameters and to control the operation of an energy simulation, calibration and modification process.

FIG. 5 is a flow chart of a preferred embodiment of a method to construct a building configuration.

FIG. 6 is a flow chart of a preferred embodiment of a method to determine heating and cooling equipment loads and sizes.

FIG. 7 is a flow chart of a preferred embodiment of a method to simulate energy consumption which determines an energy usage profile for a building including a monthly electrical consumption and a monthly heating fuel consumption.

FIG. 8 is a flow chart of a preferred embodiment of a method to calibrate a baseline energy usage profile to an actual energy usage profile for a building.

FIG. 9 is a preferred embodiment of a graphical calibration of a baseline energy usage profile and an actual energy usage profile based on historical energy usage.

FIG. 10 is a flow chart of a preferred embodiment of a method to modify a building configuration based on a set of energy efficiency improvements.

FIG. 11 is a flow chart of a preferred embodiment of a method to report, monthly and annual, electrical and heating fuel consumptions and project a monetary benefit based on a hypothetical energy usage profile.

FIG. 12A is a preferred embodiment of a graphical report of a monthly electrical consumption for a building.

FIG. 12B is a preferred embodiment of a graphical report of monthly heating fuel consumption for a building.

FIGS. 13A, 13B, 13C, and 13D are preferred embodiments of a tabular report of electrical and heating fuel energy and monetary savings between a calibrated baseline energy usage profile and a hypothetical energy usage profile.

FIG. 14 is a preferred embodiment of an electronic form configured to receive a set of building envelope parameters for a building.

FIG. 15 is a preferred embodiment of an electronic form configured to receive a set of fan parameters for the mechanical systems of a building.

FIG. 16 is a preferred embodiment of an electronic form configured to receive a set of cooling system parameters for a building.

FIG. 17 is a preferred embodiment of an electronic form configured to receive a set of heating system parameters for a building.

FIG. 18 is a preferred embodiment of an electronic form configured to receive a set of lighting energy usage parameters for a building.

FIG. 19 is a preferred embodiment of an electronic form configured to receive a set of plug load parameters for a building.

FIG. 20 is a preferred embodiment of an electronic form configured to receive a set of domestic hot water heating parameters for a building.

FIG. 21 is a preferred embodiment of an electronic form configured to report and allow modification of a set of peak building load parameters determined for a building.

FIG. 22 is a preferred embodiment of an electronic form configured to receive general building information, lighting operational data and lighting fixture data and to control the operation of a lighting systems energy simulation.

FIG. 23 is a flow chart of a preferred embodiment of a method to create a baseline lighting model and a modified lighting model to determine a lighting based energy savings.

FIG. 24 is a preferred embodiment of an electronic form configured to receive general building information, accessory equipment operational data and accessory equipment energy data and to control the operation of an accessory equipment energy simulation.

FIG. 25 is a flow chart of a preferred embodiment of a method to create a baseline accessory equipment model and a modified accessory equipment model to determine accessory equipment based energy savings.

FIG. 26 is a preferred embodiment of an electronic form configured to receive user login data to access the simulation software.

FIG. 27 is a preferred embodiment of an electronic form configured to report and allow selection of a client, site or building, and a simulation.

FIG. 28 is a preferred embodiment of an electronic form configured to report and allow modification of parameters determined for a new simulation.

FIG. 29 is a preferred embodiment of an electronic form configured to report and allow modification of a set of parameters determined for a simulation.

FIG. 30 is a preferred embodiment of an electronic form configured to report electrical consumption data.

FIG. 31 is a preferred embodiment of an electronic form configured to report natural gas consumption data.

FIG. 32 is a preferred embodiment of an electronic form configured to report and allow configuring segments (sets) of operational parameters determined for a base simulation.

FIG. 33 is a preferred embodiment of an electronic form configured to report information determined for a segment of a simulation comprising a layout image file.

FIG. 34 is a preferred embodiment of an electronic form configured to report and allow modification of a set of parameters determined for a segment of a simulation comprising physical dimensions and number of occupants.

FIG. 35 is a preferred embodiment of an electronic form configured to report and allow modification of a set of operational parameters determined for a segment of a simulation comprising occupancy and schedules for HVAC and lighting.

FIG. 36 is a preferred embodiment of an electronic form configured to report and allow modification of a set of operational parameters determined for a segment of a simulation comprising ventilation loads.

FIG. 37 is a preferred embodiment of an electronic form configured to report and allow modification of a set of operational parameters determined for a segment of a simulation comprising fan loads.

FIG. 38 is a preferred embodiment of an electronic form configured to report and allow modification of a set of operational parameters determined for a segment of a simulation comprising cooling load.

FIG. 39 is a preferred embodiment of an electronic form configured to report and allow modification of a set of operational parameters determined for a segment of a simulation comprising heating load.

FIG. 40 is a preferred embodiment of an electronic form configured to report and allow modification of a set of operational parameters determined for a segment of a simulation comprising lighting loads.

FIG. 41 is a preferred embodiment of an electronic form configured to report and allow modification of a set of operational parameters determined for a segment of a simulation comprising plug loads.

FIG. 42 is a preferred embodiment of an electronic form configured to report and allow modification of a set of operational parameters determined for a segment of a simulation comprising domestic hot water loads.

FIG. 43 is a preferred embodiment of an electronic form configured to report and allow modification of a set of operational parameters determined for a segment of a simulation comprising electrical special loads and heating utility special loads.

FIG. 44 is a preferred embodiment of an electronic form configured to report and allow modification of a set of operational parameters determined for a segment of a simulation comprising cooling and heating loads.

FIG. 45 is a preferred embodiment of an electronic form configured to report a set of operational parameters determined for a segment of a simulation comprising simulated electrical consumption profile with load type detail.

FIG. 46 is a preferred embodiment of an electronic form configured to report a set of operational parameters determined for a segment of a simulation comprising simulated heating utility consumption profile with load type detail.

FIG. 47 is a preferred embodiment of an electronic form configured to report a set of operational parameters determined for a segment of a simulation comprising both electrical meter consumption data and simulated electrical consumption data with calculated calibration deviation month-by-month.

FIG. 48 is a preferred embodiment of an electronic form configured to report a set of operational parameters determined for a segment of a simulation comprising heating utility meter consumption data and simulated heating utility consumption data with calculated calibration deviation month-by-month.

FIG. 49 is a preferred embodiment of an electronic form configured to report and allow configuration of segments (sets) of operational parameters for both a base simulation and a modified simulation.

FIG. 50 is a preferred embodiment of an electronic form configured to report and allow modification of a set of operational parameters determined for a segment of the modified simulation comprising schedules for occupancy, HVAC, and lighting.

FIG. 51 is a preferred embodiment of an electronic form configured to report and allow configuration of sets of operational parameters for building segments for both the base simulation and the modified simulation and provide a display of simulation statistics.

FIG. 52 is a preferred embodiment of an electronic form configured to report a set of operational parameters determined for both the base simulation and the modified simulation comprising calculated adjustment summary differences month-by-month for both electricity and heating utility.

FIG. 53 is a preferred embodiment of an electronic form configured to report a set of operational parameters determined for a base simulation, a modified simulation, and the metered electricity consumption comprising percentage differences month-by-month.

FIG. 54 is a preferred embodiment of an electronic form configured to report and export a set of validated operational parameters determined for the modified simulation.

FIG. 55 is a flow chart of a preferred embodiment of a method for calculating savings.

FIG. 56 is a flow chart of a preferred method of calculating a set of monthly heating degree days.

FIG. 57 is a flow chart of a preferred method of calculating a set of monthly cooling degree days.

FIG. 58 shows a preferred embodiment of a display system.

FIG. 59A shows a preferred embodiment of a savings trends functional card.

FIG. 59B shows filter options for the savings trends functional card.

FIG. 60A shows a preferred embodiment of a cost and consumption trends functional card.

FIG. 60B shows filter options for the cost and consumption trends functional card.

FIG. 61A is shows a preferred embodiment of an Energy Usage Index functional card.

FIG. 61B shows filter options for the Energy Usage Index functional card.

FIG. 62A shows a preferred embodiment of an energy program savings functional card.

FIG. 62B shows filter options for the energy program savings functional card.

FIG. 63A shows a preferred display of energy program savings equations.

FIG. 63B shows a preferred display of utility consumption data from actual utility bills from the utility company for the base period.

FIG. 63C shows a preferred display of consumption adjustments the user entered into the database.

FIG. 63D shows a preferred display of consumption data from utility bills for the current billing period.

FIG. 63E shows a preferred display of an “All-In-Rate” display.

FIG. 63F shows a preferred display of a rate changes display.

### DETAILED DESCRIPTION OF THE INVENTION

The system and methods described are implemented using digital computer systems. In one aspect of the present disclosure, the systems and methods are implemented on a digital computer having a processor for executing the methods embodied within a set of program instructions. The program instructions are stored in an electronic memory and in digital storage media connected to the digital computer. The digital computer includes a user interface system including a display device and a keying device. The digital storage media can include a compact disc, a hard drive, a flash drive or any other form of portable or non-portable persistent storage suitable for electronically storing program instructions.

In a preferred embodiment, the set of program instructions are implemented within a spreadsheet program on the digital computer, for example, a set of macros and Visual Basic code in a Microsoft Excel™ spreadsheet. However, implementation of the methods of the present disclosure is not intended to be limited to a spreadsheet implementation. Interactive applications through the internet or with distributed computing systems are envisioned.

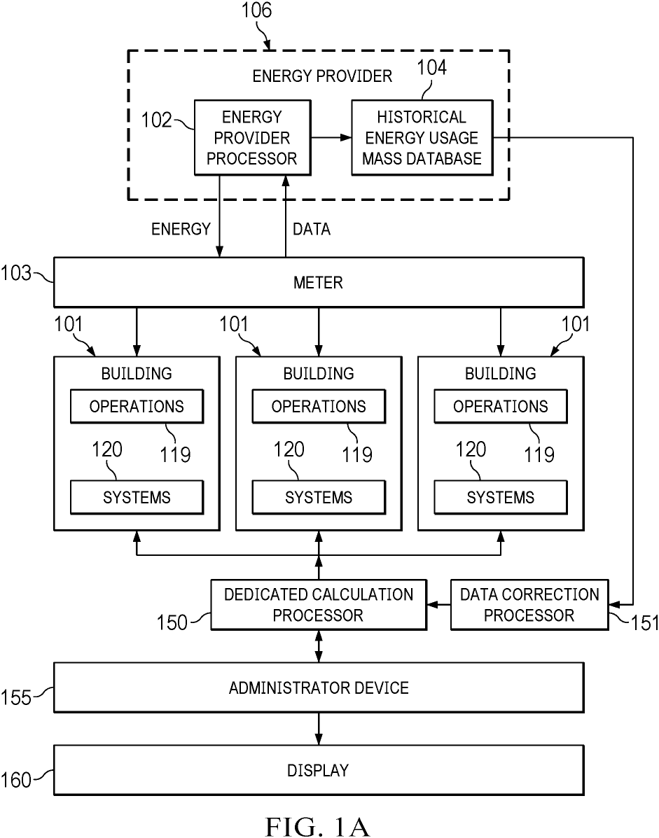

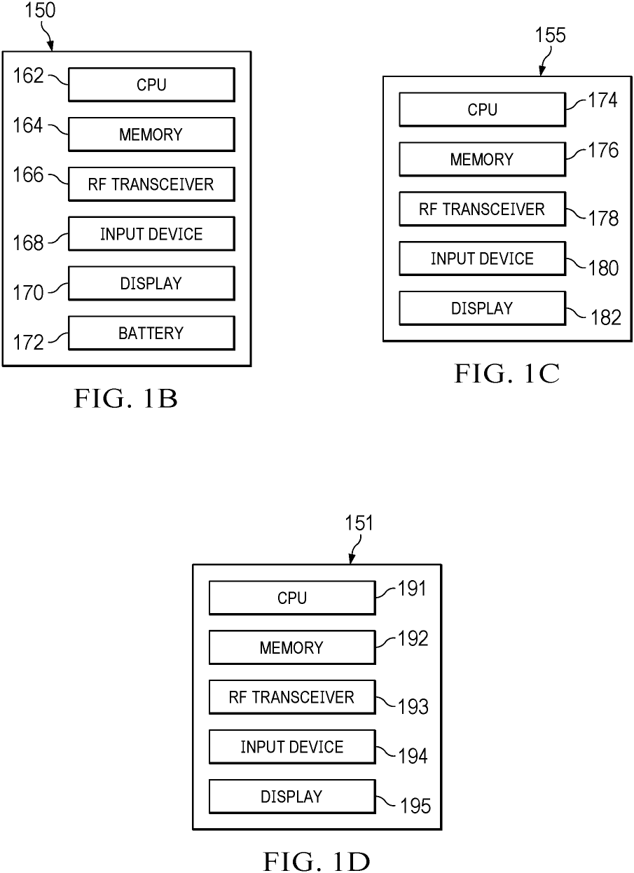

Referring to FIG. 1A, buildings 101 are analyzed for energy cost savings according to adjustments to building systems 120. Building systems 120, as they relate to energy consumption, include the thermal envelope of the building, HVAC systems installed in the building, lighting systems used throughout the building and accessory equipment used in the building. Buildings 101 also experience environmental factors such as weather and human interaction primarily through operations. Operations 119 include things such as thermostat set points, light usage and accessory equipment usage, hours of operation of the building, etc. “Weather” is defined in the form of data including weather location, a set of monthly cooling degree days, a set of monthly heating degree days, a cooling design temperature, a heating design temperature and a peak humidity ratio. Changes in operating parameters, such as set points can be instantly included into the calibrated simulation so that savings can be observed in real time.

Buildings 101 receive energy for daily operations from energy provider 106. Energy usage is collected from meters for the buildings, such as meter 103 by energy provider processor 102, which then generates usage and billing data and stores it in historical energy usage mass database 104. Energy is consumed by buildings 101 in the form of electrical energy and heating fuel based energy. The amount of energy provided is monitored onsite by meter 103 in a set of time intervals and sent to energy provider processor 102. Historical energy usage data is available by use of a specialized protocol through the internet and usually provided in set time increments.

Dedicated calculation processor 150 is in data communication with historical energy usage mass database 104, buildings 101, operations 119, and building systems 120. Data such as thermostat set points, lighting times and fan speeds are communicated from controllers in the buildings to the dedicated calculation processor. Low integrity energy usage data and billing data is communicated to the data correction processor for processing, through a network connection, as will be further described. After processing, high integrity data is communicated to the dedicated calculation processor, through a network connection, for use in the calibration model, as will be further described.

Dedicated calculation processor 150 is also operatively connected to administrator device 155 through a network connection. The dedicated calculation processor calculates and displays savings in real time and communicates reports data to the administrator device, as will be further described.

Referring to FIG. 1B, dedicated calculation processor 150 will be further described. Dedicated calculation processor 150 further comprises CPU 162 connected to memory 164, RF transceiver 166, input device 168, display 170 and battery 172. In the preferred embodiment, CPU 162 is provided in the Raspberry Pi 4 available from DigiKey Electronics of Thief River Fallas, Minnesota. Preferably, CPU 162 is the Broadcom BCM2711 SOC including a 1.5 gigahertz 64-bit quad-core ARM Cortex-A72 processor including a one megabyte shared L2 cache. Memory 164 is preferably a high-capacity micro SD card including 32-gigabyte EMMC storage.

RF transceiver 166 is preferably part number SIM7600G-H including a 4 GHz dongle, part number SIM7600G-H 4G Dongle, available from Waveshare Electronics of Zhenzhen, China. The RF transceiver supports up to 150 MBPS downlink rate and a 50 MBPS uplink rate.

Input device 168 is preferably the M5Stack CardKB Mini Keyboard Programmable Unit (MEGA328P), part number U035, available from M5Stack Technology Co., Ltd of Shenzhen, China. Display 170 is preferably the low power 1.3-inch IPS LCD display module available from Waveshare. Battery 172 is preferably a PiSugar2Plus 5000 mAh UPS lithium battery power module, manufactured by Guangzhou AiChongWu Technology Co., Ltd.

The handheld nature of the dedication calculation processor is important so that it may be used on site to quickly input and upload data related to the buildings, operations and system so that pinpoint adjustments may be made and savings observed in real time.

Referring to FIG. 1C, administrator device 155 will be further described. Administrator device 155 includes CPU 174 connected to RF transceiver 178, memory 176, input device 180, and display 182. In the preferred embodiment, display 182 is a low-power liquid crystal display adapted to show the current operational state of the system. Input device 180 is a standard QWERTY keyboard operatively connected to the CPU Memory 176 is preferably onboard memory available to the CPU upon boot-up and thereafter. In the preferred embodiment, RF transceiver 178 is a low-power transmitter-receiver combination which provides WiFi connectivity to CPU 174. In the preferred embodiment, administrator device 155 is a multipurpose computer available from Dell Precision 7920 Tower Workstation, available from Dell, Inc. of Round Rock, Texas.

Referring to FIG. 1D, data correction processor 151 will be further described. Data correction processor 151 includes CPU 191 connected to RF transceiver 193, memory 192, input device 194, and display 195. In the preferred embodiment, display 195 is a low-power liquid crystal display adapted to show the current operational state of the system. Input device 194 is a standard QWERTY keyboard operatively connected to the CPU Memory 192 is preferably onboard memory available to the CPU upon boot-up and thereafter. In the preferred embodiment, RF transceiver 193 is a low-power transmitter-receiver combination which provides WiFi connectivity to CPU 191. In the preferred embodiment, administrator device 155 is a multipurpose computer available from Dell Precision 7920 Tower Workstation, available from Dell, Inc. of Round Rock, Texas.

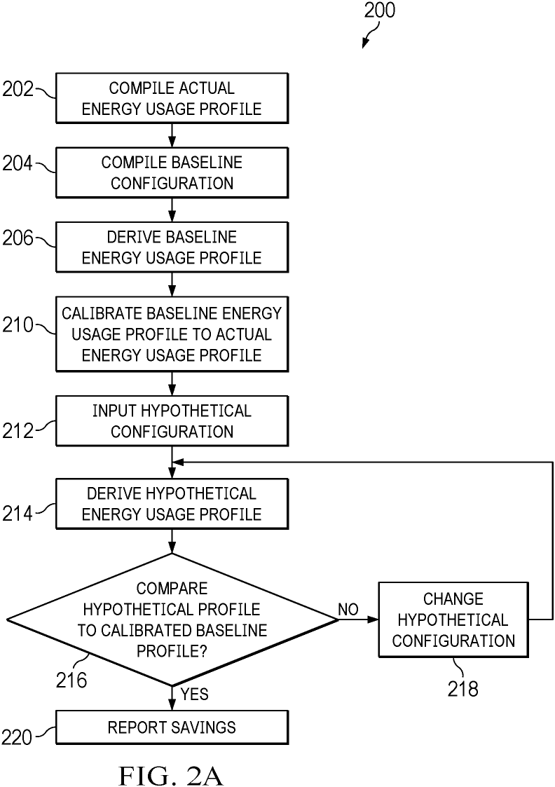

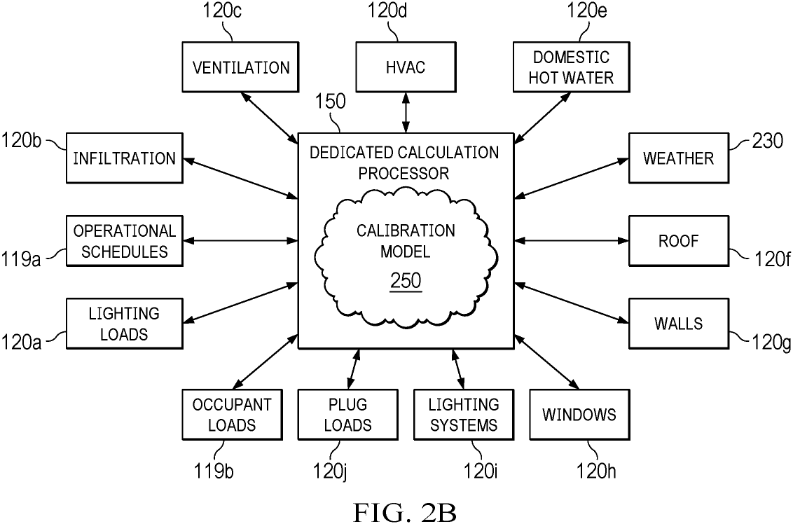

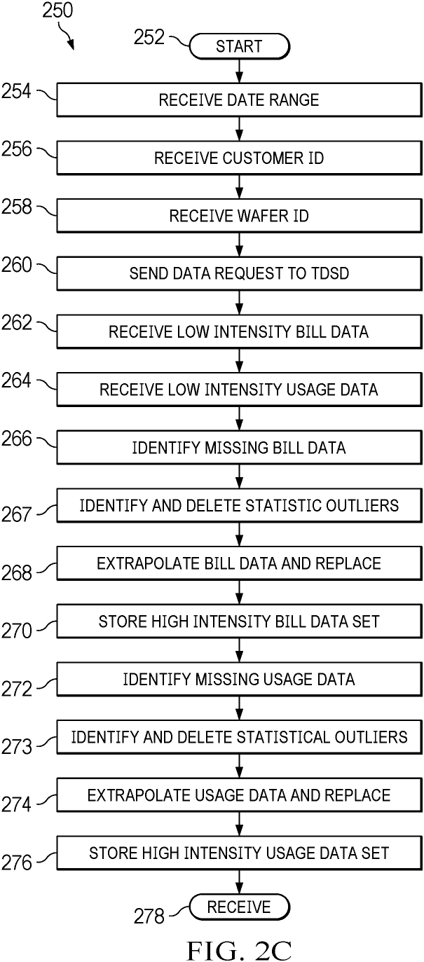

Referring to FIGS. 2A and 2B, adjustment simulator method 200 will be further described. Method 200 is preferably carried out on dedicated calculation processor 150, as will be further described. The method is carried out by the processor available as a Python program stored in memory. At step 202, the historical energy usage is received from the buildings and converted to an actual energy usage profile comprising an actual monthly electricity consumption and an actual monthly heating fuel consumption for a building for a set of months. At step 204, a baseline configuration is compiled from weather data 230, a set of occupancy parameters describing building operations 119a and 119b and a set of building physical parameters 120a, 120b, 120c, 120d, 120e, 120f, 120g, 120h, 120i and 120j describing building systems 120. This data may be input from the RF transceiver, or manually entered in the input device. Weather data 230, set of occupancy parameters describing building operations 119a and 119b and set of building physical parameters form a baseline configuration for the building. At step 206, a baseline energy usage profile is derived by performing an energy consumption simulation using the baseline configuration. At step 210, the baseline configuration is calibrated to the actual energy usage profile. Step 210 results in calibrated baseline configuration and a calibrated baseline energy usage profile known as calibration model 250. At step 212, a hypothetical configuration is input by applying a set of energy improvement measures to the calibrated baseline configuration. The set of energy improvement measures are intended to improve energy efficiency to meet an energy savings goal. The set of energy improvement measures include modifying R-values of insulation, changing out the mechanical systems for more efficient mechanical systems, modifying heating and cooling setpoints, etc. in the calibrated baseline configuration. At step 214, a hypothetical energy usage profile is derived and reported by performing an energy consumption simulation using the hypothetical configuration. At step 216, the hypothetical energy usage profile is evaluated and compared to the calibrated baseline energy usage profile to determine if the energy savings goal is met.

If the energy savings goal is met, then step 220 is performed to report energy savings results. The energy improvement measures can then be instantly observed on the handheld display as potential energy savings. If the energy savings goal is not met, then step 218 is conducted. Step 218, the hypothetical configuration is further modified with additional energy improvement measures. Step 214 is repeated to derive the hypothetical energy usage profile. Step 216 is repeated to evaluate if the energy savings goal is met.

At step 220, the results from steps 202, 210 and 214 including the calibrated baseline energy usage profile, the hypothetical energy usage profile and the energy savings is reported to the administrator device, where it is displayed, in graphical and tabular form on the display.

In one embodiment, billing and usage data are accessed directly from historical energy usage mass database 104 maintained by energy provider processor 102. In this instance, the historical energy usage data such as billing data and usage data is typically low integrity. The data is low integrity because it oftentimes includes completely missing data or data which is inaccurate because it contains statistical outliers which both skew data analysis.

Referring to FIG. 2C, method 250 of creating high integrity billing and usage data from low integrity billing and usage data will be further described. Preferably, method 250 is carried out at data correction processor 151 and takes the form of a Python computer program.

At step 252, the method begins.

At step 254, the processor receives a date range from the input device.

At step 256, the processor receives a customer ID from the input device.

At step 258, the processor receives a meter ID for an electrical meter at the building, from the input device at the data correction processor.

At step 260, data correction processor 151 sends a data request to historical energy usage mass database 104. In Texas, for example, secure data transport is enabled by the North American Standards Board (NAESB) Electronic Delivery Mechanism (EDM), EBXML and digital certificates compliant with NAESB EDM standard V1.6. Of course, other electronic transport standards may be employed.

At step 262, the processor receives low integrity billing data for the date range, the customer and the meter ID. At step 264, the processor receives low integrity usage data for the date range, for the customer ID, at the meter ID.

At step 266, the processor identifies missing bill data and statistical outliers in the low integrity bill data for the date range.

At step 267, the processor identifies and deletes statistical outliers in the low integrity billing data for the date range. In one embodiment, statistical outliers are those data entries that are more than 2 standard deviations above or below the average.

At step 268, the processor creates a substitute for the missing data by extrapolating between the data points immediately before the missing data and immediately after the missing data along a linear path. The extrapolated bill data is substituted into in the low integrity bill data set in place of the deleted data to create a high integrity bill data set.

At step 270, the processor stores the high integrity bill data set.

At step 272, the processor identifies missing usage data and statistical outliers in the low integrity usage data for the data range.

At step 273, the processor identifies and deletes statistical outliers in low integrity usage data.

At step 274, the processor creates a substitute for the missing low integrity usage data by extrapolating between the data points immediately before the missing data and immediately after the missing data along a linear path. The extrapolated usage data is substituted into the low integrity usage data set in place of the deleted data to create a high integrity usage data set.

At step 276, the processor stores high integrity usage data set is stored.

At step 278, the processor returns the high integrity bill data set and the high integrity usage data set.

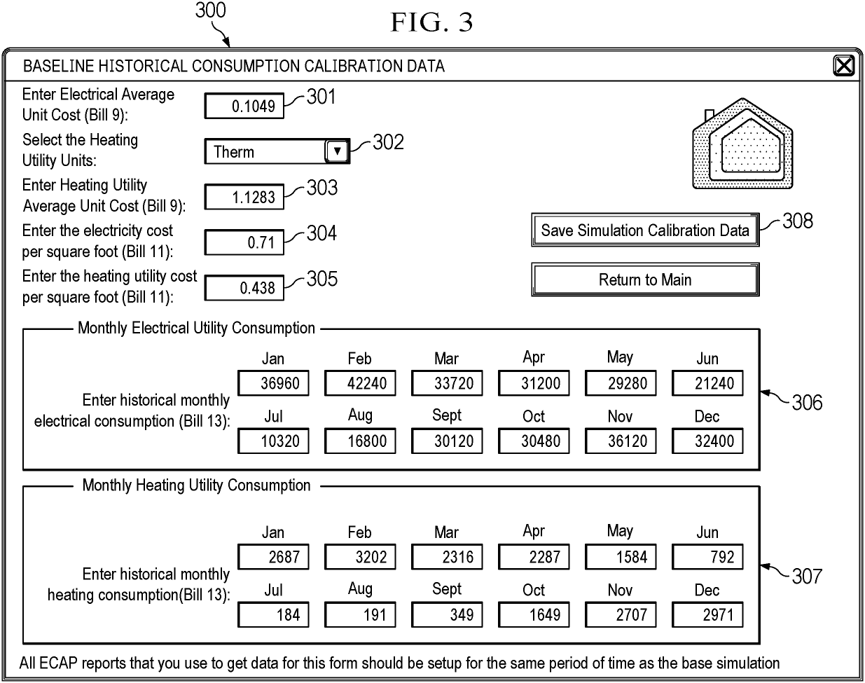

Referring to FIG. 3, electronic form 300 is shown. If the billing and usage data is imported from the data correction processor, then the forms are displayed prepopulated. In one preferred embodiment, certain billing and usage data may, optionally, be manually entered, or manually adjusted onsite at the building, using the input device of the remote dedicated calculation processor. Electronic form 300, as all electronic forms described, is preferably displayed at the dedicated calculation processor. Electronic form 300 comprises a data entry box 301 for entering an electrical average unit cost (e.g. $/kWh) and a data entry box 304 for entering/displaying the electricity cost per sq. ft. for the building. Electronic form 300 further comprises a data entry box 302 for selecting a heating fuel unit, data entry box 303 for receiving a heating fuel average unit cost (e.g. $/MCF for natural gas units of MCF). A data entry box 305 is included for entering/displaying the heating fuel cost per sq. ft. for the building. Electronic form 300 further comprises a first set of data entry boxes 306 for receiving historical monthly electricity consumptions. Information for first set of data entry boxes can be entered manually from a bill or automatically pre-populated from a spreadsheet. Electronic form 300 also comprises a second set of data entry boxes 307 for receiving historical monthly heating fuel consumptions. Information for the second set of data entry boxes can also be entered manually from a bill or automatically pre-populated from a spreadsheet. The information entered as the historical energy usage data is saved in a persistent and computer readable format by selecting “form” button 308.

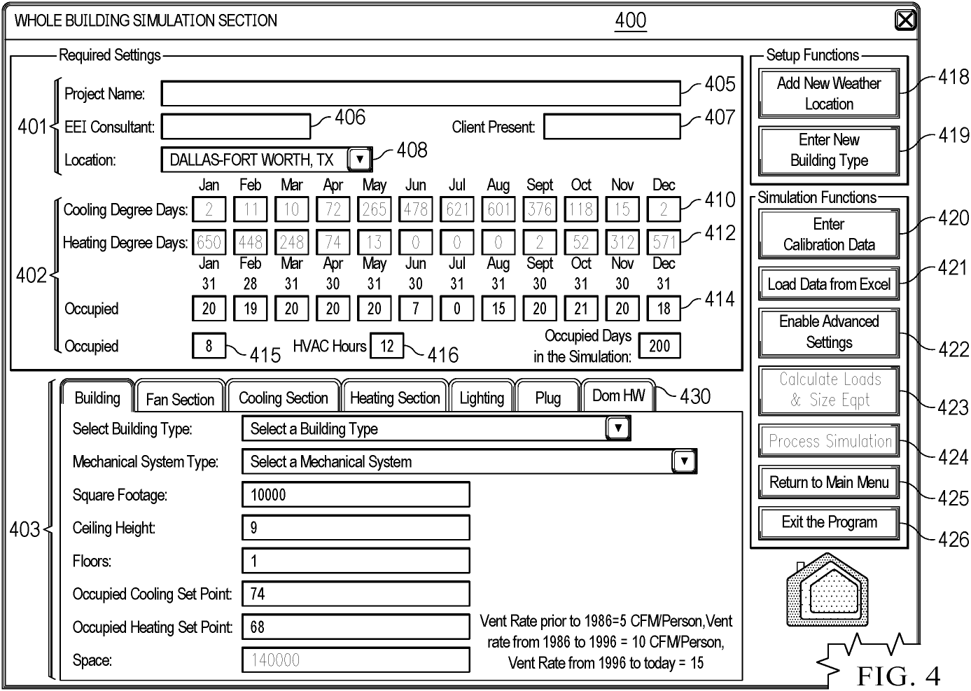

Referring to FIG. 4, electronic form 400 is shown. Basic building data 401 comprises data entry elements for the building name 405, a consultant 406, a client 407 and weather location 408. Upon selection of weather location 408, a set of cooling degree days (CDD) 410 and a set of heating degree days (HDD) 412 for each month of a year time period are populated into electronic form 400.

Set of occupancy data 402 comprises data entry elements for a set of monthly occupied days 414 for each month of the year time period, an average number of occupied hours 415 in an occupied day and an average number of HVAC operation hours 416 in an occupied day.

Set of building physical parameters 403 comprises a set of tabbed entry forms 430 for entering building physical data including a building form, a fan section form, a cooling section form, a heating section form, a lighting selection, plug selection form, a hot water heating form and a peak loads form.

Electronic form 400 also includes data entry boxes for a weather location control 418 a new building type control 419, a calibration data control 420, a load data control 421, an advanced settings control 422, a size equipment control 423, a process simulation control 424 and a main menu control button 425. Weather location control 418, when selected, initiates a form to create a new weather location with a new set of cooling degree days and heating degree days. New building type control 419, when selected, initiates a form to create a new building type along with a default set of building physical data. Calibration data control 420, when selected, initiates the electronic form 300 of FIG. 3. Load data control 421, when selected, loads persistent data into the electronic form 400, for example, the last building project entered including all of the form data included in the last building project. Enable advanced settings control 422, when selected, renders a set of advanced building physical parameters visible and editable for set of occupancy data 402, otherwise only a simplified set of building physical parameters are visible and editable. Size equipment control 423, when selected, calculates heating and cooling loads for the building and sizes a set of HVAC equipment for the building. Process simulation control 424, when selected, performs an energy consumption simulation based on the current electronic data stored in electronic form 400 and stores a resulting energy usage profile. Main menu control button 425, when selected, returns program execution to a simplified set of program instructions implementing a main menu form. Exit program control button 426, when selected, stops further execution of the set of program instructions.

In a preferred embodiment, the baseline configuration, calibrated baseline and hypothetical configuration are entered by loading, entering and modifying data in the set of tabbed entry forms 430 of electronic form 400.

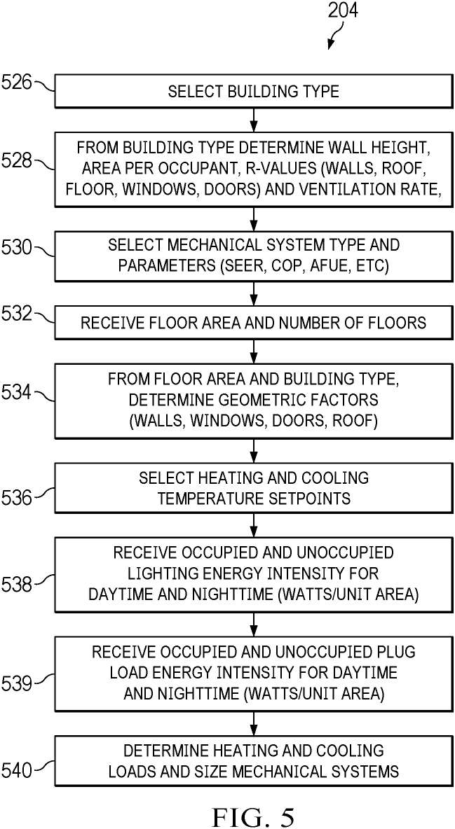

Referring to FIG. 5, detailed method of step 204 for compiling a baseline configuration is described. At step 526, a building type is selected. In a preferred embodiment, the building type is selected from a set of predefined building types wherein selecting a building type automatically loads an associated set of building physical parameters. At step 528, the associated set of building physical parameters is determined from the building type selected and includes, but it is not limited to, a ventilation CFM per person, a window R value, a door R value, a floor R value, a wall R value, a roof R value, a wall height and an occupied area per person. The R-values are converted into U values for calculating heating and cooling loads, where U = 1 / R, resulting in U_{wall}, U_{roof}, U_{floor}, U_{window} and U_{door}.

For example, a “classroom” building type has an associated set of parameters (presented in British units): ventilation CFM = 15, window R value = 1.9, door R value = 5, floor R value = 10, wall R value = 3, roof R value = 19, wall height = 9 ft. and occupied area per person = 110 sq. ft. wherein U_{wall} = 0.33, U_{roof} = 0.052, U_{floor}, = 0.10, U_{window} = 0.52, and U_{door} = 0.20.

In another example, a gymnasium has an associated set of parameters: ventilation CFM = 5, window R value = 1.9, door R value = 5, floor R value = 10, wall R value = 3, roof R value = 19, wall height = 25 ft. and occupied area per person = 90 sq. ft. wherein U_{wall} = 0.33, U_{roof} = 0.052, U_{floor}, = 0.10, U_{window} = 0.52, and U_{door} = 0.20.

At step 530, a mechanical system type is selected from a set of predefined mechanical systems. In a preferred embodiment the set of predefined mechanical systems include heat pump systems, DX cooling systems with a gas furnace or electric strip heating, split DX cooling systems with gas furnace or electric strip heating, water cooled or air cooled chilled water cooling systems with gas furnace, hot water heating or steam heating, unit ventilator systems using water cooled or air cooled chilled water with hot water, steam or electric strip heating, air handling systems with various cooling and heating configurations, and variable air volume systems with various cooling and heating configurations.

In a preferred embodiment, selecting a mechanical type automatically loads an associated set of mechanical system parameters.

At step 532, a number of floors and a total floor area is received for the building configuration. At step 534, a set of building factors are determined from the floor area and the building type. The set of building factors include a projected occupancy, a total occupant required ventilation rate, a total building volume and a set of geometric factors including a wall factor, a roof factor, a floor factor, a window factor and a door factor. The projected occupancy is calculated from the floor area and the occupied area per person. Each geometric factor when multiplied by the total floor area, produces “a characteristic area” in the building configuration for the building type. For example, a wall area is calculated for the building equal to the total floor area multiplied by the wall factor for the building type. The window area is calculated for the building equal to the total floor area multiplied by the window factor. In a preferred embodiment, the wall factor, roof factor, floor factor, window factor and door factor are pre-determined for each building type in the set of predefined building types.

At step 536, a cooling temperature set point and a heating temperature set point is received for the building configuration.

At step 538, a set of lighting energy intensities are received for the building configuration. The set of lighting energy intensities describe the energy used for lighting per unit floor area (e.g. Watts/sq.ft.) for different states of occupancy. In the preferred embodiment the set of lighting energy intensities includes a value for an occupied day, a value for an unoccupied day, a value for an occupied night and a value for an unoccupied night.

At step 539, a set of plug load energy intensities are received for the building configuration. The set of plug load energy intensities describe the energy consumed for accessory electrical and electronic equipment per unit floor area (e.g. Watts/sq. ft.) for different states of occupancy. In the preferred embodiment the set of plug load energy intensities includes a value for an “occupied day”, a value for an “unoccupied day”, a value for an “occupied night” and a value for an “unoccupied night”.

At step 540, a heating load and a cooling load is calculated for the building. A heating system size is calculated from the heating load. A cooling system size is calculated from the cooling load. The set of mechanical systems parameters are updated to reflect the calculated heating system size and the calculated cooling system size.

The result of steps 526, 528, 530, 532, 534, 536, 538, 539, and 540 is a baseline configuration which is sufficiently parameterized to perform energy consumption simulations for the building.

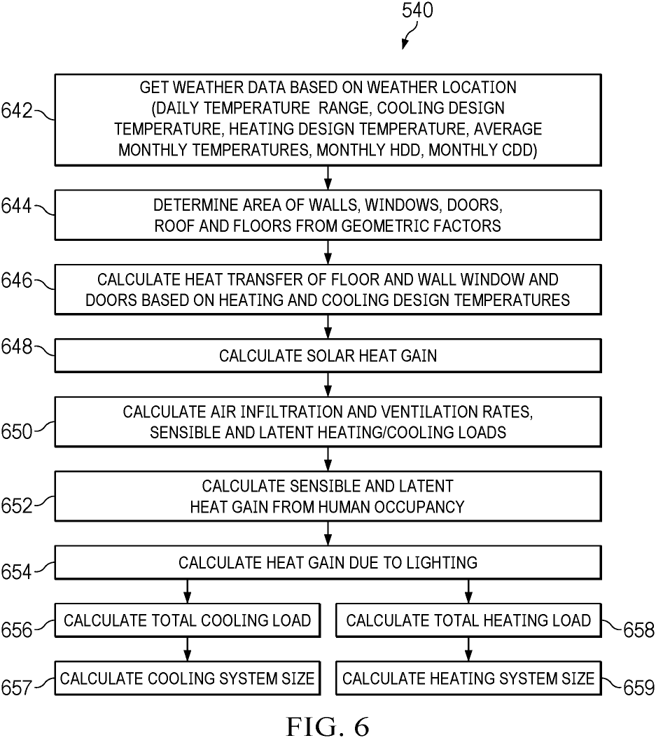

Referring to FIG. 6, details method 540 for determining the heating and cooling loads and sizing mechanical systems is described. At step 642, weather data based on the weather location is loaded. The weather data includes a cooling design temperature, a heating design temperature, a daily temperature range, a peak humidity ratio, a room humidity ratio, a set of average monthly temperatures, a set of monthly cooling degree days and a set of monthly heating degree days, as will be further described.

At step 644, the total areas of the walls, windows, doors, roof and exterior floors, are determined for the baseline configuration from a set of geometric factors.

The set of “geometric factors” includes floor area, wall area, window area, door area and roof area. At step 646, heat transfer is calculated as a cooling load and sensible heating load is calculated for the walls, windows, doors, roof and floors based on the cooling and heating design temperatures, the cooling and heating temperature set points, the cooling degree days and the heating degree days. At step 648, the solar heat gain is calculated for the building.

At step 650, are air infiltration rate and a ventilation rate are determined. A cooling air infiltration load and a heating air infiltration load are calculated from the ventilation rate. A cooling ventilation load and a heating ventilation load are calculated from the ventilation.

At step 652, a sensible ventilation cooling load is calculated from the total occupancy required ventilation rate and cooling temperature set point. A latent ventilation cooling load is calculated from the total occupancy required ventilation rate, the peak humidity ratio and the room humidity ratio. A latent ventilation heating load is calculated from the total occupancy required ventilation rate and the heating temperature set point. A sensible occupant heat gain and a latent occupant heat gain generated by the occupants of the building is calculated from the projected occupancy.

At step 654, a lighting heat gain due to lighting is calculated from the lighting energy intensity and the floor area.

Then, at step 656, a total sensible cooling load is calculated as the sum of the sensible cooling loads for the walls, windows, doors, roof and floors along with the solar heat gain, the lighting heat gain, the sensible occupant heat gain, the sensible infiltration cooling load and the sensible ventilation cooling load. A total latent cooling load is calculated as the sum of the latent occupant heat gain, the latent infiltration cooling load and the latent ventilation cooling load.

At step 657, a cooling system size is determined from the total sensible cooling load, the total latent cooling load and a cooling factor determined from the cooling temperature set point. Further at step 657, a set of fan motor powers are determined based on the cooling system size for supply, return, makeup, condenser and exhaust fans. A set of chiller pump sizes are determined based on the cooling system size including a condenser pump size, a primary pump size and a secondary pump size.

At step 658, a total sensible heating load is calculated as the sum of the sensible heating loads for the walls, windows, doors, roof and floors along with the solar heat gain, the sensible infiltration heating load and the sensible ventilation heating load. A total latent heating load is calculated as the sum of the latent infiltration heating load and the latent ventilation heating load.

At step 659, a heating system size is determined from the total sensible heating load and the total latent heating load, a heating factor determined from the heating temperature set point, and a heating efficiency for the selected heating system. Also, at step 659, a set of hot water pump sizes are determined based on the heating system size including a primary heating pump size and a secondary heating pump size.

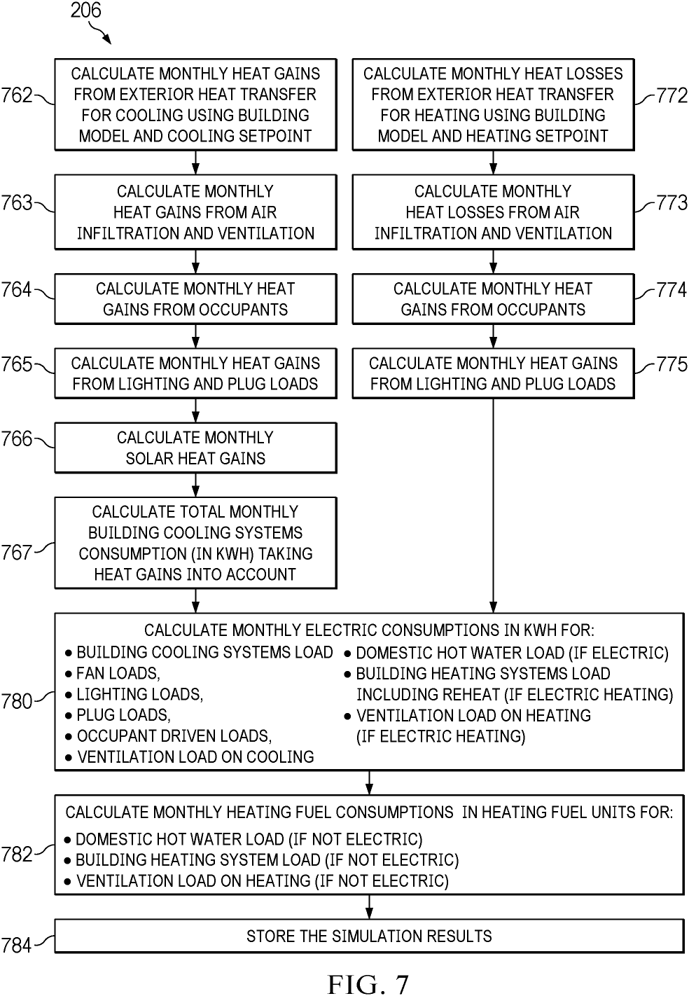

Referring to FIG. 7, a baseline energy usage profile is determined. An energy consumption simulation is performed for the building according to the building configuration, the calculated cooling and heating loads and the calculated cooling and heating system sizes. In a preferred embodiment, the energy consumption simulation is conducted with the CLTD/CLF/SCL method, as known in the art. The energy consumption simulation also uses the set of average monthly temperatures, the daily temperature range, the set of monthly cooling degree days and the set of monthly heating degree days from the weather data.

At step 762, a set of cooling system monthly loads are calculated for each month of the year and summed for the year to arrive at an annual cooling system load. In a preferred embodiment, the monthly cooling load Q_{Cblg}(m) due to heat transfer through the building envelope is calculated for each month m by:

$${Q}_{C b l g} \left(m\right) = S P F C ⋅ U A ⋅ C D D \left(m\right) ⋅ \frac{O c c D a y s \left(m\right)}{A l l D a y s \left(m\right)} ⋅ H$$

Where:
$$\begin{matrix}U A = {U}_{W a l l s} {A}_{W a l l s} + {U}_{R o o f} {A}_{R o o f} + {U}_{F l o o r} {A}_{F l o o r} + {U}_{W i n d o w s} {A}_{W i n d o w s} \\ + {U}_{D o o r s} {A}_{D o o r s} ,\end{matrix}$$
and
Where:
   SPFC is a set point adjustment factor determined from the cooling temperature set point T_{CSP},
   CDD(m) is the cooling degree days for month m;
   OccDays(m) is the monthly number of occupied days in the month m;
   AllDays(m) is the total number of days in the month m; and
   H is the average daily number of HVAC run hours.

In a preferred embodiment:

$$S P F C = 1.0 + \left(74 - {T}_{C S P}\right) ∗ 0.02$$

Where: T_{CSP} is given in degrees Fahrenheit.

At step 763, a set of monthly heat gains from air infiltration and a set of monthly heat gains from air ventilation are calculated. In a preferred embodiment, the set of monthly heat gains from air infiltration Q_{Cinfil}(m) for cooling is determined by calculating a summer air infiltration flow rate from a pre-determined natural air change rate (ACH) for the building and the total building volume. In a preferred embodiment, a sensible heat gain is determined from the summer air infiltration flow rate according to:

$$\begin{matrix}{Q}_{C i n f i l} \left(m\right) = 1.075 ∗ A C H ∗ Δ T \left(m\right) ∗ A l l D a y s \left(m\right) ∗ 24 ∗ 0.71 ∗ \\ C L F \left(m\right)\end{matrix}$$

Where:
ΔT(m) is the difference between the average monthly temperature for month m and the cooling temperature set point; and
CLF(m) is the ratio:
$$C L F \left(m\right) = \frac{C D D \left(m\right)}{C D D \left(m\right) + H D D \left(m\right)}$$
given HDD (m) is the heating degree days for month m.

In a preferred embodiment, the set of monthly heat gains for cooling from air ventilation Q_{Cvent}(m) is determined as:

$$\begin{matrix}{Q}_{C v e n t} \left(m\right) = 1.075 ∗ O A C F M ∗ Δ {T}_{v c} \left(m\right) ∗ A l l D a y s \left(m\right) ∗ H ∗ \\ C L F \left(m\right)\end{matrix}$$

Where:
ΔT_{vc}(m) is the difference between the average monthly temperature for month m; and
55° F. and OACFM is the total occupancy required ventilation rate.

At step 764, a set of monthly heat gains for cooling from occupants is calculated in a according to a preferred embodiment as:

$${Q}_{C p e o p l e} \left(m\right) = {N}_{o c c} ∗ q p ∗ A l l D a y s \left(m\right) ∗ H ∗ C L F \left(m\right)$$

Where:
N_{occ} is the projected occupancy; and
the multiplier qp is an estimated heat gain per occupant in BTU/h and can be adjusted by building type.

For example, qp = 400 is an accepted value for an office building or school building.

At step 765, a set of monthly peak heat gains from lighting systems is calculated according to a preferred embodiment as:

$${Q}_{C l i g h t} \left(m\right) = 3.41 ∗ {L}_{o d} ∗ {F}_{u s e} ∗ {F}_{S A} ∗ A l l D a y s \left(m\right) ∗ H ∗ C L F \left(m\right)$$

where L_{od} is the total lighting wattage (lighting intensity multiplied by floor area) for an occupied day, Fᵤₛₑ is a lighting usage factor and F_{SA} is an average ballast factor. For example, Fᵤₛₑ = 0.9 and F_{SA} = 1.25 is an accepted value for an office building or school building.

Furthermore, at step 765, a set of monthly peak heat gains from plug loads is also calculated according to a preferred embodiment as:

$${Q}_{C p l u g} \left(m\right) = P {L}_{o d} ∗ {F}_{p l u g} ∗ A l l D a y s \left(m\right) ∗ H ∗ C L F \left(m\right) ,$$

where PL_{od} is the total plug load wattage (plug load intensity multiplied by floor area) for an occupied day and the multiplier F_{plug} is an estimated plug load factor including a radiation factor and a usage factor. For sensible heat gain, F_{plug} = 1.4 is an accepted value for an office building or school building. For latent heat gain, F_{plug} = 0.4895 is an accepted value.

At step 766, a set of monthly solar heat gains for cooling is calculated according to a preferred embodiment as:

$${Q}_{C s o l a r} \left(m\right) = S L C ∗ S C ∗ {A}_{W i n d o w s} ∗ A l l D a y s \left(m\right)$$

where SLC and SC are the solar cooling load and the shading coefficient, respectively, determined from the weather location and a glazing type according to standard methods known in the art. See for example, ASHRAE Handbook of Fundamentals 1997, Tables 11, 35B and A28-36, which can be incorporated as a set of lookup tables based on the latitude of the weather location.

At step 767 a set of total cooling system loads Q_{Ctonhr}(m) is determined in units of ton hours as the sum of Q_{Cblg}(m), Q_{Cinfil}(m), Q_{Cvent}(m), Q_{Cpeople}(m), Q_{Clight}(m), Q_{Cplug}(m) and Q_{Csolar}(m).

At step 772, heating system monthly loads are calculated for each month of the year and summed for the year to arrive at an annual heating system load. The monthly heating load Q_{Hblg}(m) due to heat transfer through the building envelope is calculated for each month m by:

$${Q}_{H b l g} \left(m\right) = S P F H ⋅ U A ⋅ H D D \left(m\right) ⋅ \frac{O c c D a y s \left(m\right)}{A l l D a y s \left(m\right)} ⋅ H$$

where

$$\begin{matrix}U A = {U}_{W a l l s} {A}_{W a l l s} + {U}_{R o o f} {A}_{R o o f} + {U}_{F l o o r} {A}_{F l o o r} + {U}_{W i n d o w s} {A}_{W i n d o w s} \\ + {U}_{D o o r s} {A}_{D o o r s} ,\end{matrix}$$

and where SPFH is a set point adjustment factor determined from the heating temperature set point T_{HSP}, HDD(m) is the cooling degree days for month m, OccDays(m) is the number of occupied days in the month m, AllDays(m) is the total number of days in the month m and H is the average daily number of HVAC run hours. In a preferred embodiment:

$$S P F H = 1.0 + \left({T}_{H S P} - 68\right) ∗ 0.02 ,$$

where T_{HSP} is given in degrees Fahrenheit.

At step 773, a set of monthly heat losses from air infiltration and a set of monthly heat losses from air ventilation are calculated. In a preferred embodiment, the set of monthly heat losses from air infiltration QH_{infil}(m) for heating is determined by calculating a winter air infiltration flow rate from a pre-determined natural air change rate (ACH) for the building and the total building volume. In a preferred embodiment, a sensible heat loss is determined from the winter air infiltration flow rate according to:

$$\begin{matrix}{Q}_{H i n f i l} \left(m\right) = 1.075 ∗ A C H ∗ Δ T \left(m\right) ∗ A l l D a y s \left(m\right) ∗ 24 ∗ 0.71 ∗ \\ H L F \left(m\right)\end{matrix}$$

where ΔT(m) is the difference between the average monthly temperature for month m and the heating temperature set point and HLF(m) is the ratio

$$H L F \left(m\right) = \frac{H D D \left(m\right)}{C D D \left(m\right) + H D D \left(m\right)} ,$$

given HDD(m) is the heating degree days for month m.

In a preferred embodiment, the set of monthly heat losses from air ventilation Q_{Hvent}(m) is determined from the total occupancy required ventilation rate OACFM as:

$$\begin{matrix}{Q}_{H v e n t} \left(m\right) = 1.075 ∗ O A C F M ∗ Δ {T}_{v h} \left(m\right) ∗ A l l D a y s \left(m\right) ∗ H ∗ \\ H L F \left(m\right) ,\end{matrix}$$

where ΔTᵥₕ(m) is the difference between 90° F. and the average monthly temperature for month m.

At step 774, a set of monthly heat gains from occupants is calculated in a according to a preferred embodiment as:

$${Q}_{H p e o p l e} \left(m\right) = {N}_{o c c} ∗ q p ∗ A l l D a y s \left(m\right) ∗ H ∗ H L F \left(m\right) ,$$

where N_{occ} is the projected occupancy and the multiplier qp is an estimated heat gain per occupant in BTU/h and can be adjusted by building type. For example, qp = 400 is an accepted value for an office building or school building.

At step 775, a set of monthly heat gains from lighting systems is calculated according to a preferred embodiment as:

$${Q}_{H l i g h t} \left(m\right) = 3.41 ∗ {L}_{o d} ∗ {F}_{u s e} ∗ {F}_{S A} ∗ A l l D a y s \left(m\right) ∗ H ∗ H L F \left(m\right) ,$$

where L_{od} is the total lighting wattage (lighting intensity multiplied by floor area) for an occupied day, Fᵤₛₑ is a lighting usage factor and F_{SA} is an average ballast factor. For example, Fᵤₛₑ = 0.9 and F_{SA} = 1.25 is an accepted value for an office building or school building.

Further at step 775, a set of monthly peak heat gains from plug loads is also calculated according to a preferred embodiment as:

$${Q}_{H p l u g} \left(m\right) = 3.41 ∗ P {L}_{o d} ∗ {F}_{p l u g} ∗ A l l D a y s \left(m\right) ∗ H ∗ H L F \left(m\right) ,$$

where PL_{od} is the total plug load wattage (plug load intensity multiplied by floor area) for an occupied day and the multiplier F_{plug} is an estimated plug load factor including a radiation factor and a usage factor. For sensible heat gain, F_{plug}= 1.4 is an accepted value for an office building or school building. For latent heat gain, F_{plug} = 0.4895 is an accepted value.

At step 780, a set of monthly electrical consumptions is determined including a monthly cooling system electrical consumption, a monthly fan electrical consumption, a monthly lighting electrical consumption, a monthly plug load electrical consumption, a monthly occupant related electrical consumption, a monthly ventilation related electrical consumption, a monthly heating system electrical consumption if the heating fuel is electric and a monthly domestic hot water heating electrical consumption if the hot water is heated electrically. A total monthly electrical consumption is computed as the sum of the set of monthly electrical consumptions for each month in a set of months.

For chilled water cooling systems, ground source and water source heat pumps, a set of cooling pump electrical consumptions in kWh, Q_{Cpump}(m), is computed from the set of cooling pump sizes. For other cooling system types Q_{Cpump}(m) is zero. In a preferred embodiment, the monthly cooling system electrical consumption is determined from:

$$\begin{matrix}{Q}_{C l o a d} \left(m\right) = {Q}_{C p u m p} \left(m\right) + \left[{Q}_{C b l g} \left(m\right) + {Q}_{C i n f i l} \left(m\right)\right) \\ \left(+ {Q}_{C l i g h t} \left(m\right) + {Q}_{C p l u g} \left(m\right) + {Q}_{C s o l a r} \left(m\right)\right] \\ ∗ C E F F ,\end{matrix}$$

where Q_{Cload}(m) is in kWh and CEFF is a conversion factor of kW of electricity per ton taking into account a specified efficiency of the cooling systems.

The monthly fan electrical consumption Q_{fans}(m) in kWh is determined based on a set of fan motor powers for supply, return, makeup, condenser and exhaust fans. A first set of fan electrical consumptions is calculated according to:

$${Q}_{f a n A} \left(m\right) = F a n A ∗ A l l D a y s \left(m\right) ∗ {H}_{o c c} ,$$

where FanA is the sum of all supply, return and makeup fan motor powers in watts and where H_{occ} is the average number of occupied hours per day. A second set of fan electrical consumptions is calculated according to:

$${Q}_{f a n B} \left(m\right) = F a n B ∗ A l l D a y s \left(m\right) ∗ \frac{{Q}_{t o n h r} \left(m\right)}{} C T O N S ,$$

where FanB is the total condenser fan motor power in watts and CTONS is the cooling system size in tons. A third set of fan electrical consumptions is calculated according to:

$${Q}_{f a n C} \left(m\right) = F a n C ∗ A l l D a y s \left(m\right) ∗ {H}_{e x} ,$$

where FanC is the total exhaust fan motor power in watts and where Hₑₓ is equal to 24 hours if running continuously or equal to H_{occ} if not running during unoccupied hours. A fourth set of fan electrical consumptions is calculated according to:

$${Q}_{f a n D} \left(m\right) = F a n D ∗ A l l D a y s \left(m\right) ∗ {H}_{s y s} ,$$

where FanD is the total chiller pump fan power in watts and H_{sys} is equal to H_{occ} for cooling system types that only run during operational hours and equal to 24 hours for cooling system types that require continuous circulation. Q_{fan}(m) is determined as the sum of Q_{FanA}(m), Q_{FanB}(m), Q_{FanC}(m) and Q_{FanD}(m). A fifth set of fan electrical consumptions is calculated according to:

$${Q}_{f a n E} \left(m\right) = F a n E ∗ A l l D a y s \left(m\right) ∗ {H}_{s y s} ,$$

where FanE is the total heating system pump fan power in watts and H_{sys} is equal to H_{HVAC} for heating system types that only run during operational hours and equal to 24 hours for heating system types that require continuous circulation. H_{HVAC} is the average HVAC run time per day. Q_{fans}(m) is determined as the sum of Q_{fanA}(m), Q_{fanB}(m), Q_{fanC}(m), Q_{fanD}(m) and Q_{fanE}(m).

The monthly lighting electric consumption is determined from the set of lighting energy intensities for the different states of occupancy, the monthly number of occupied days OccDays(m) and the average number of occupancy hours per day OccHours according to the formula:

$$\begin{matrix}{Q}_{l i g h t s} \left(m\right) = {L}_{o d} ∗ O c c D a y s \left(m\right) ∗ O c c H o u r s + {L}_{o n} ∗ O c c D a y s \left(m\right) \\ ∗ \left(U n O c c H o u r s\right) + \\ {L}_{u d} ∗ U n O c c D a y s \left(\left(m\right)\right) ∗ 12 + {L}_{u n} ∗ U n O c c D a y s \left(m\right) ∗ 12 ,\end{matrix}$$

where L_{od} is the total lighting wattage (lighting intensity multiplied by floor area) for an occupied day, Lₒₙ is the total lighting wattage for a night on an occupied day, L_{ud} is the total lighting wattage for an unoccupied day, Lᵤₙ is the total lighting wattage for a night on an unoccupied day and the number of unoccupied days UnOccDays(m) = AllDays(m) - OccDays(m).

The monthly plug load electric consumption is determined from the set of plug load energy intensities for the different states of occupancy, the monthly number of occupied days OccDays(m) and the average number of occupancy hours per day OccHours according to the formula:

$$\begin{matrix}{Q}_{p l u g s} \left(m\right) = P {L}_{o d} ∗ O c c D a y s \left(m\right) ∗ O c c H o u r s + P {L}_{o n} ∗ O c c D a y s \left(m\right) \\ ∗ \left(U n O c c H o u r s\right) + \\ P {L}_{u d} ∗ U n O c c D a y s \left(\left(m\right)\right) ∗ 12 + P {L}_{u n} ∗ U n O c c D a y s \left(m\right) ∗ 12 ,\end{matrix}$$

where L_{od} is the total plug load wattage (plug load intensity multiplied by floor area) for an occupied day, Lₒₙ is the total plug load wattage for a night on an occupied day, L_{ud} is the total plug load wattage for an unoccupied day, Lᵤₙ is the total plug load wattage for a night on an unoccupied day and the number of unoccupied days UnOccDays(m) = AllDays(m) -OccDays(m).

The monthly occupant related electrical consumption Q_{occ}(m) is determined as Q_{Cpeople}(m) multiplied by CEFF. The monthly ventilation electrical consumption Qᵥₑₙₜₛ (m) is determined for cooling as Q_{Cvent}(m) multiplied by CEFF.

If the heating fuel is electric, a monthly heating system electrical consumption is determined from the output of steps 772-775. When variable air volume systems are used, energy is also consumed for reheating which is computed as follows.

$${Q}_{r e h e a t 1} \left(m\right) = \left({Q}_{C l o a d} \left(m\right) - {Q}_{C p u m p} \left(m\right)\right) ∗ R H E A T ∗ M F$$

where RHEAT is a predefined constant and MF is an adjustable microclimate factor. In this case, the monthly heating system electrical consumption is determined in kWh as:

$${Q}_{H l o a d} \left(m\right) = \left[\left({Q}_{H b l g} / H e f f\right) / 3413 + {Q}_{r e h e a t 1} \left(m\right)\right] ∗ M F$$

where Q_{Hload}(m) is in kWh and HEFF is the efficiency of the heating systems. For example, for electric resistive heating HEFF is equal to 1.0; for heat pumps HEFF is a specified value typically greater than 1.0. Also if the heating fuel is electric, the monthly ventilation electrical consumption is computed together with the cooling system ventilation consumption as:

$$\begin{matrix}{Q}_{v e n t s} \left(m\right) = \left({Q}_{C v e n t} \left(m\right) ∗ C E F F + \left({Q}_{H v e n t} \left(M\right) / H E F F\right) / 3413\right) \\ ∗ M F .\end{matrix}$$

Domestic hot water energy usage is computed in BTU by:

$$\begin{matrix}{Q}_{D H W} \left(m\right) = {V}_{p e r s o n} \left(d\right) ∗ A l l d a y s \left(m\right) ∗ O c c u p a n c y ∗ 8.33 ∗ \\ \left(D H T E M P - 78\right)\end{matrix}$$

where Vₚₑᵣₛₒₙ is the average daily volume of hot water used by a person, occupancy is the average occupancy of the building an DHTEMP is the hot water supply temperature setting.

If the hot water is heated with electricity then Q_{DWH}(m) is converted to kWh by dividing by 3413 BTU/kWh and reported as the monthly domestic hot water heating electrical consumption in step 780.

At step 782, a set of monthly heating fuel consumptions is determined including a monthly heating system fuel consumption, a monthly ventilation related heating fuel consumption and a monthly domestic hot water heating fuel consumption. A total monthly heating fuel consumptions is computed as the sum of the set of monthly heating fuel consumptions for each month in the set of months.

If the heating fuel is not electric, a monthly heating fuel consumption is determined from the output of steps 772-775. In this case, a monthly heating system load is computed in BTU as:

$${Q}_{H l o a d} \left(m\right) = \left[{Q}_{H b l g} \left(m\right) + {Q}_{H i n f i l} \left(m\right) + {Q}_{r e h e a t 2} \left(m\right)\right] ∗ M F / H E F F$$

where the reheating component is computed for variable air volume systems as:

$${Q}_{r e h e a t 2} \left(m\right) = {Q}_{C b l g} \left(m\right) ∗ R H E A T ,$$

and where RHEAT is a predefined constant which is equal to zero for systems other than variable air volume systems, HEFF is the heating system efficiency and MF is the adjustable microclimate factor. The monthly heating system fuel consumption is reported in heating fuel units by converting the monthly heating system load from BTU to heating fuel units. For example, 1 therm = 100,000 BTU, so in therms, Q_{HLtherms}(m) = Q_{Hload}(m)100000.

A monthly ventilation heating load is computed in BTU as:

$${Q}_{v e n t s} \left(m\right) = \left(\left({Q}_{H v e n t} \left(m\right) / H E F F\right)\right) ∗ M F .$$

The monthly ventilation related heating fuel consumption is reported in heating fuel units by converting the monthly heating system load from BTU to heating fuel units.

If hot water is heated with heating fuel, then the monthly domestic hot water heating fuel consumption is reported in heating fuel units by converting the domestic hot water energy usage Q_{DHW}(m) from BTU to heating fuel units.

At step 784, the set of electrical consumptions and the set of heating fuel consumptions determined in steps 780 and 782 are stored in a persistent memory and reported as the baseline energy usage profile for the building. The baseline energy usage profile includes the total monthly electrical consumption in kWh and the total monthly heating fuel consumption in heating fuel units. In a preferred embodiment, the sets of electrical and heating fuel consumptions are recorded in a spreadsheet which is further saved to a persistent storage device.

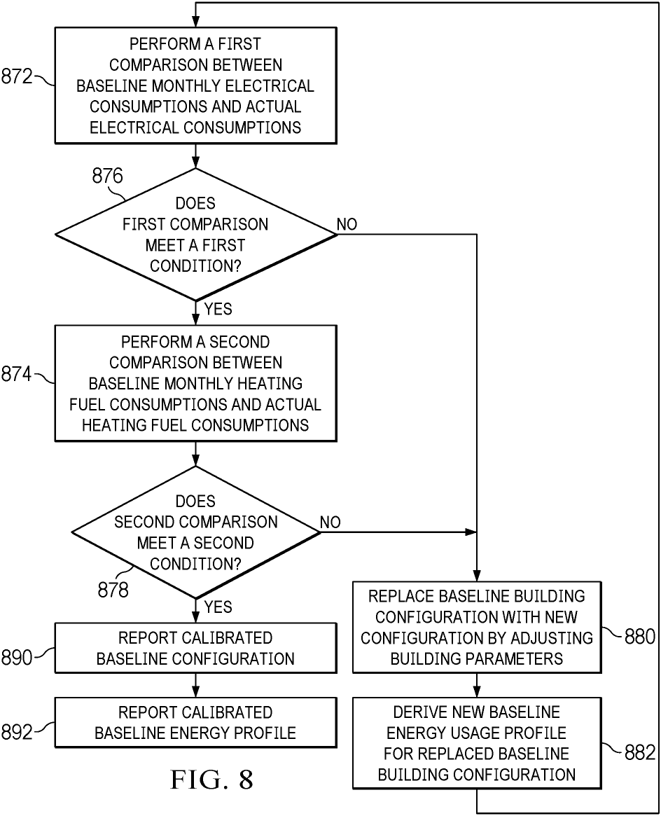

Referring to FIG. 8, calibration process of step 210 is performed on a baseline configuration with a baseline energy usage profile. At step 872, a first comparison is performed between the total monthly electrical consumption in the baseline energy usage profile and the actual monthly electrical consumption in the actual energy usage profile for a set of months.

At step 876, the first comparison is checked for meeting a first condition. If the first condition is not met, the method moves to step 880. At step 880, the baseline building configuration is replaced with a new configuration by adjusting the set of building parameters. In a preferred the adjustments to the baseline building configuration are done in electronic form 400 of FIG. 5. At step 882, the baseline energy usage profile is updated by performing an energy simulation on the new configuration. The method then repeats beginning at step 872. If the first condition is met, the method moves to step 874. At step 874, a second comparison is performed between the total monthly heating fuel consumption in the baseline energy usage profile and the actual monthly heating fuel consumption in the actual energy usage profile for a set of months.

At step 878, the second comparison is checked for meeting a second condition. If the second condition is not met, then the method moves to step 880. If the second condition is met, then at step 890, the baseline building configuration is reported as the calibrated baseline configuration. At step 892, the baseline energy usage profile is reported as the calibrated baseline energy usage profile.

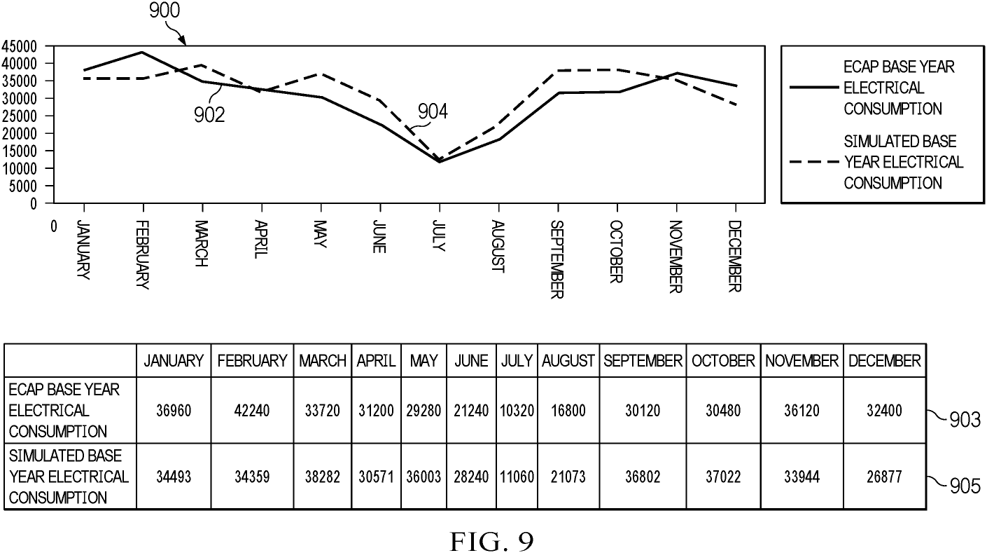

Referring to FIG. 9, in a preferred embodiment, the actual monthly electrical consumption is compared graphically to the baseline monthly electrical consumption to determine the first condition and the actual monthly heating fuel consumption is compared graphically to the baseline monthly heating fuel consumption to determine the second condition.

Graph 900 includes an example of an actual monthly energy consumption for a building comprising curve 902 and data set 903. Graph 900 further includes an example of a baseline monthly energy consumption for the building comprising curve 904 and data set 905.

In another embodiment, an actual annual electrical consumption is compared numerically to a baseline annual electrical consumption to determine the first condition and an actual annual heating fuel consumption is compared numerically to a baseline annual heating fuel consumption to determine the second condition.

For the first condition, the baseline annual electrical consumption is determined as the sum of all baseline monthly electrical consumptions for all months in a year. A first percentage difference between the baseline annual electrical consumption and the actual annual electrical consumption is calculated and if the absolute value of the first percentage difference is less than a predefined limit, then the first condition is met.

For the second condition, the baseline annual heating fuel consumption is determined as the sum of all baseline monthly heating fuel consumptions for all months in the year. A second percentage difference between the baseline annual electrical consumption and the actual annual electrical consumption is calculated. If the absolute value of the second percentage difference is less than a predefined limit, then the second condition is met.

Generally, curve fitting involves matching curve shape and “closeness” between data points. In alternate embodiments, the first and second conditions are computed with a curve fit and compared to a predefined number. For example, a Pearson correlation coefficient can be computed between two sets of monthly consumptions and compared to a first predefined number. In another example, an RMS correlation coefficient can be computed between two sets of monthly consumptions and compared to a second predefined number. In a combination of matching curve shape and closeness of fit, the average of the difference between the Pearson correlation coefficient and the first predefined number and the difference between the RMS correlation coefficient and the second predefined number is determined.

In the alternate embodiments, the method of steps 210 can be automated by identifying a set of adjustable building parameters and automatically adjusting the set of adjustable building parameters until the first and second conditions are met. The process of automatic adjustment can utilize parametric search methods such as a steepest decent method or a Monte Carlo method. In another embodiment, a combination of automation, visual graphical profiles and computed correlation coefficients may be utilized simultaneously. In this case the automation can be manually interrupted to accept the set of adjustable building parameters into the calibrated baseline configuration, to reconfigure the set of adjustable building parameters and to reconfigure a set of automation parameters.

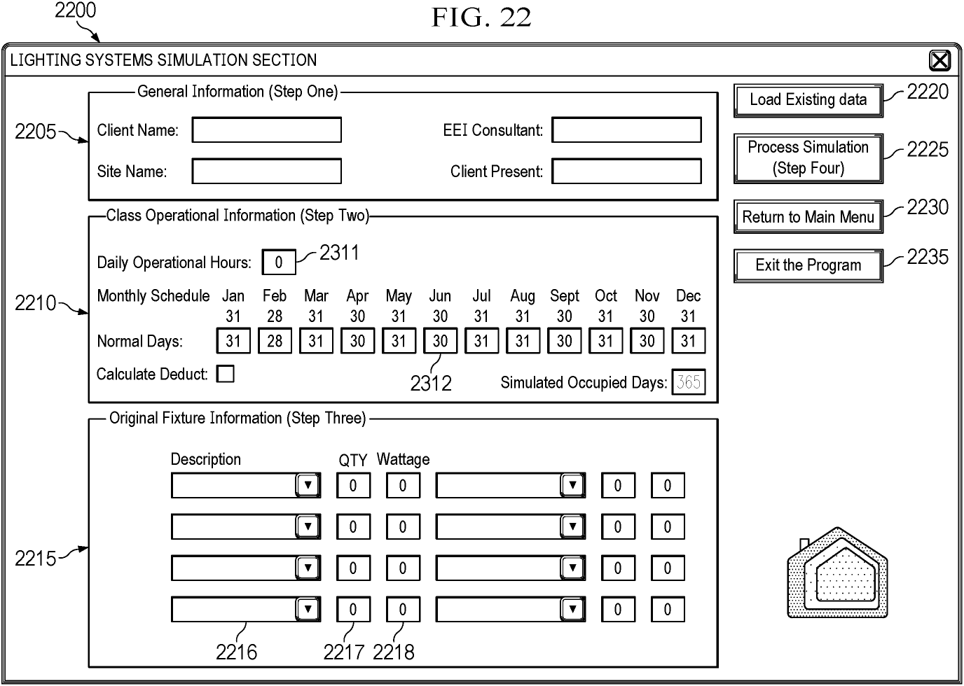

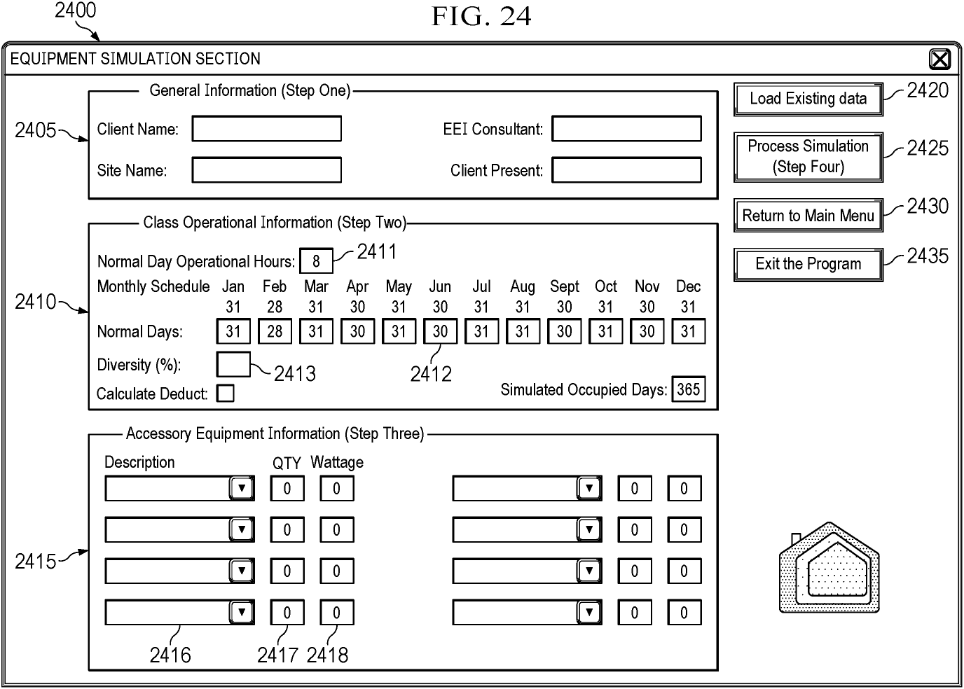

In an alternate embodiment, the lighting systems are separately adjusted and calibrated using electronic form 2200 of FIG. 22 and the plug loads are separately adjusted and calibrated using electronic form 2400 of FIG. 24.

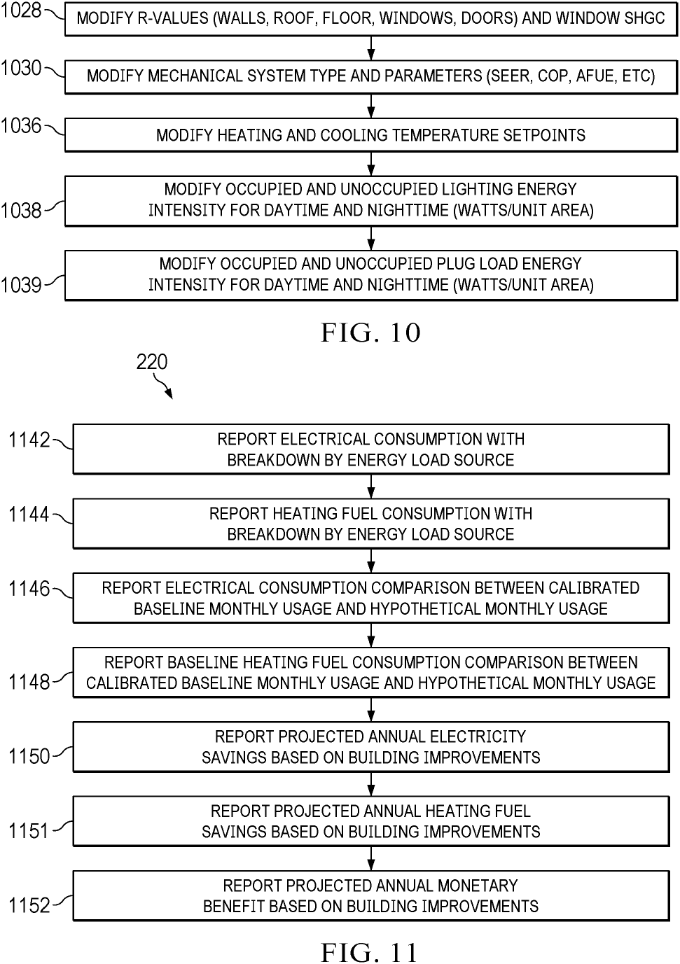

Referring to FIG. 10, a pre-existing building configuration is modified with energy efficiency improvements resulting in a hypothetical building configuration and hypothetical energy usage profile. Step 212 of method 200 uses the steps of FIG. 10 to modify a calibrated building configuration. Step 218 of method 200 uses the steps of FIG. 10 to modify a hypothetical building configuration. At step 1028, modifications to the building envelope are made to the pre-existing building configuration including insulation R-values of walls, ceilings and floors where insulation is to be added, U-values for replacement doors along with U-values and SHGC values for replacement windows. At step 1030, modifications to the mechanical systems are made to the pre-existing building configuration including cooling systems efficiency (SEER, EER) and heating system efficiency (HSPF, COP, AFUE). In modifying the mechanical systems, the HVAC systems are optionally resized. At step 1036, heating and cooling set points are modified from those in the pre-existing building configuration.

At step 1038, lighting energy intensity is modified based on potential lighting upgrades, for example, replacement of older pin fluorescent light fixtures with more efficient light bulbs and ballasts. At step 1039, plug loads for the calibrated building configuration are modified to remove undesired accessory equipment and make replacements with energy efficient accessory equipment.

In a preferred embodiment, steps 1028, 1030, 1036, 1038 and 1039 are accomplished with the aid of electronic form 400. In an alternate embodiment step 1038 is accomplished by with the aid of electronic form 2200 of FIG. 22 and step 1039 is accomplished with the aid of electronic form 2400 of FIG. 24. FIGS. 22 and 24 and associated methods are described below.

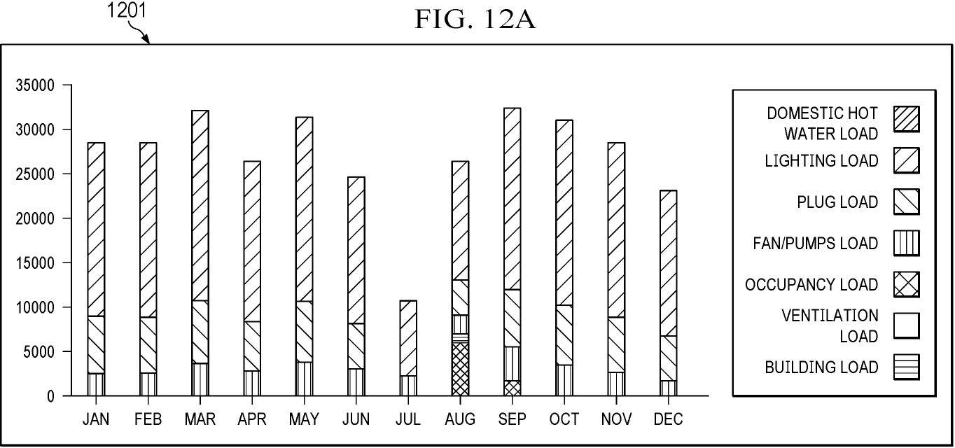

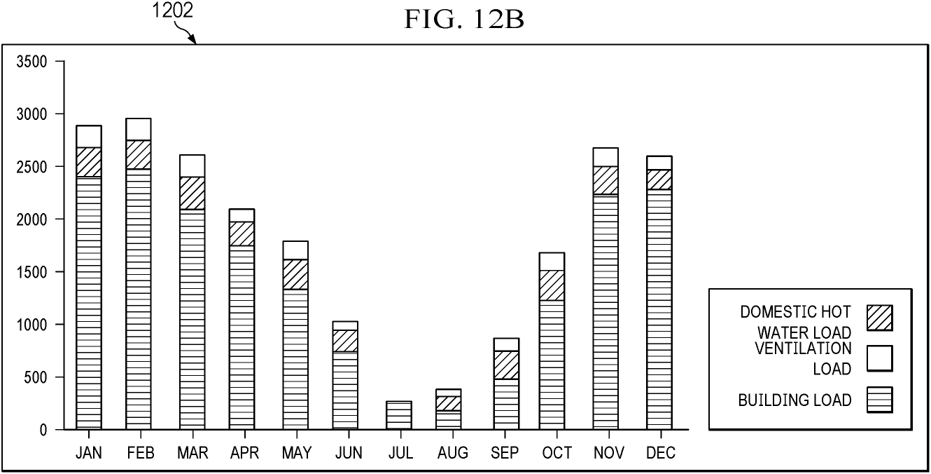

Referring to FIG. 11, a detailed method of step 220 report savings is shown. At step 1142, a monthly electricity consumption is broken down by electrical load source and reported. In a preferred embodiment, the electrical load sources are building load, lighting load, plug load, fan load, occupancy driven load, ventilation related load and domestic water heating load if hot water is heated electrically. The building load is Q_{Cload}(m) if heating systems are not electrical and Q_{Cload}(m)+Q_{Hload}(m) if heating systems are electrical. The lighting load is Q_{lights}(m), plug load is Q_{plugs}(m), fan load is Q_{fans}(m), occupancy driven load is Q_{Cpeople}(m), ventilation related load is Qᵥₑₙₜₛ(m) and domestic water heating load is Q_{DWH}(m). Also, in a preferred embodiment, at step 1142, the monthly electricity consumption is reported in a tabular form in a spreadsheet and in a graphical form. An example of the graphical form of monthly electricity consumption is shown in graph 1201 of FIG. 12A.

At step 1144, a monthly heating fuel consumption is broken down by heating load source and reported. In a preferred embodiment, the heating load sources are building load, ventilation related load and domestic water heating load if not heated electrically. The building load is Q_{Hload}(m) if heating system is not electrical. If heating is electrical Q_{Hload}(m) is reported in the monthly electrical consumption. The ventilation related load is Q_{Hvent}(m) and domestic water heating load is Q_{DWH}(m). Also, in a preferred embodiment, at step 1144, the monthly heating fuel consumption is reported in a tabular form in a spreadsheet and in a graphical form. An example of the graphical form of monthly heating fuel consumption is shown in graph 1202 of FIG. 12B.

At step 1146, a selective comparison between two sets of monthly electrical consumptions is performed and reported wherein a first set of monthly electrical consumptions is selected from the baseline energy usage profile, the calibrated baseline energy usage profile and the hypothetical energy usage profile. The second set of monthly electrical consumptions is selected from the actual energy usage profile, the calibrated baseline energy usage profile and the hypothetical energy usage profile. In a preferred embodiment, the selective comparison is performed in a spreadsheet format.

At step 1148, a selective comparison between two sets of monthly heating fuel consumptions is performed and reported wherein a first set of monthly heating fuel consumptions is selected from the baseline energy usage profile, the calibrated baseline energy usage profile and the hypothetical energy usage profile. The second set of monthly heating fuel consumptions is selected from the actual energy usage profile, the calibrated baseline energy usage profile and the hypothetical energy usage profile. In a preferred embodiment, the selective comparison is performed in the spreadsheet format.

At step 1150, a projected annual electricity savings is determined and reported based on a comparison between the calibrated baseline energy usage profile and the hypothetical energy usage profile. At step 1151, a projected annual heating fuel savings is determined and reported based on a comparison between the calibrated baseline energy usage profile and the hypothetical energy usage profile. At step 1152, a projected annual monetary savings is determined and reported based on the comparison between the calibrated baseline energy usage profile and the hypothetical energy usage profile.

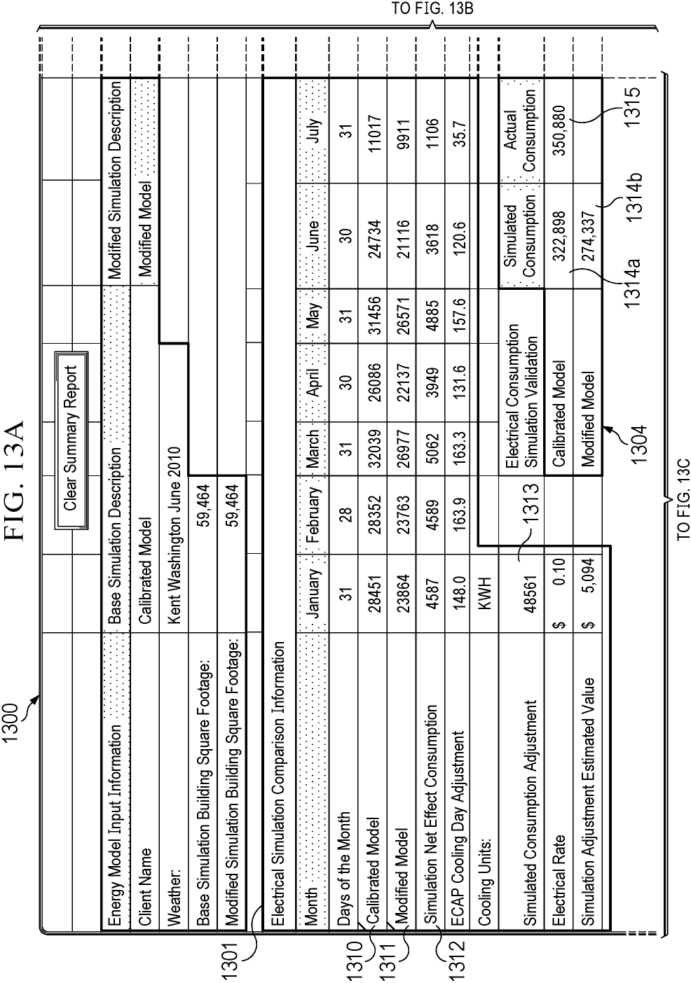

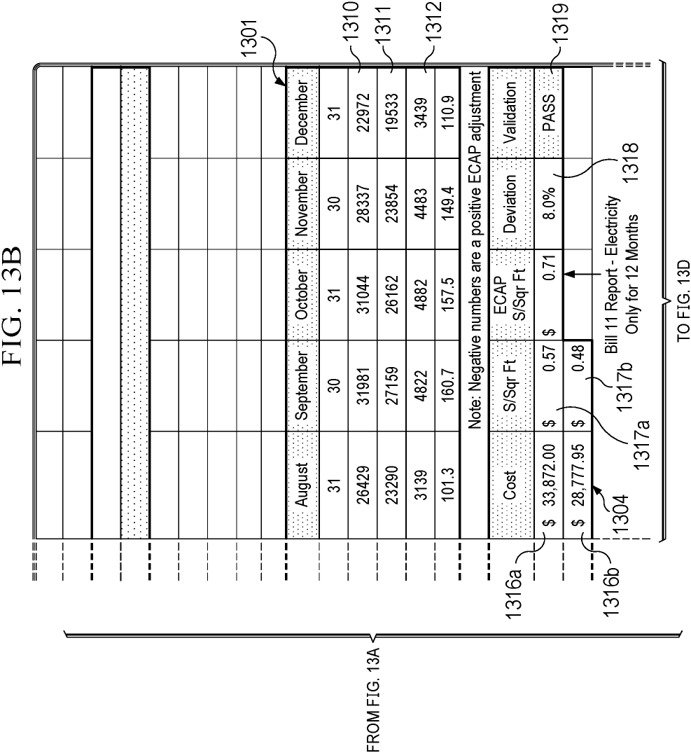

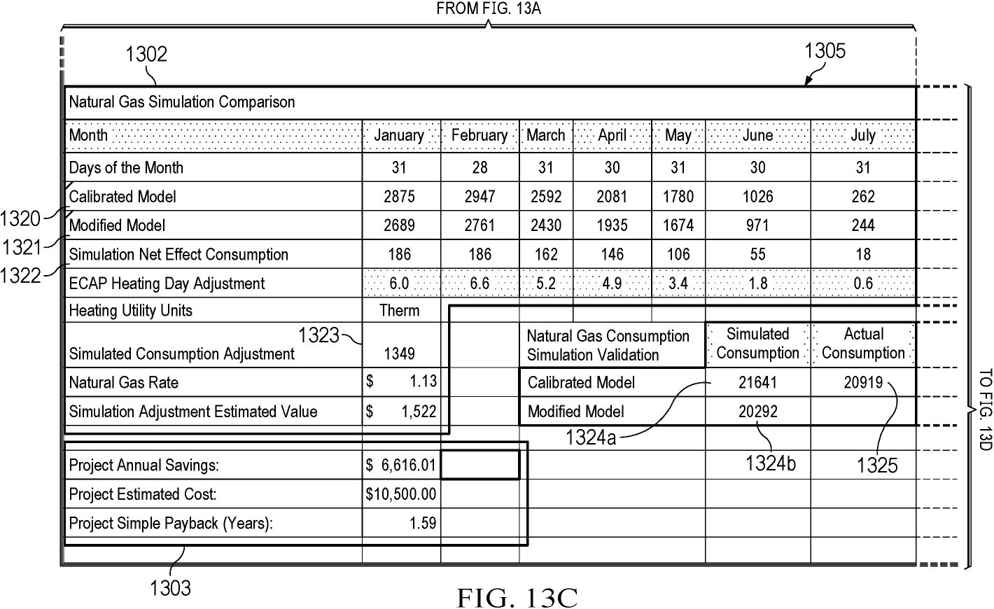

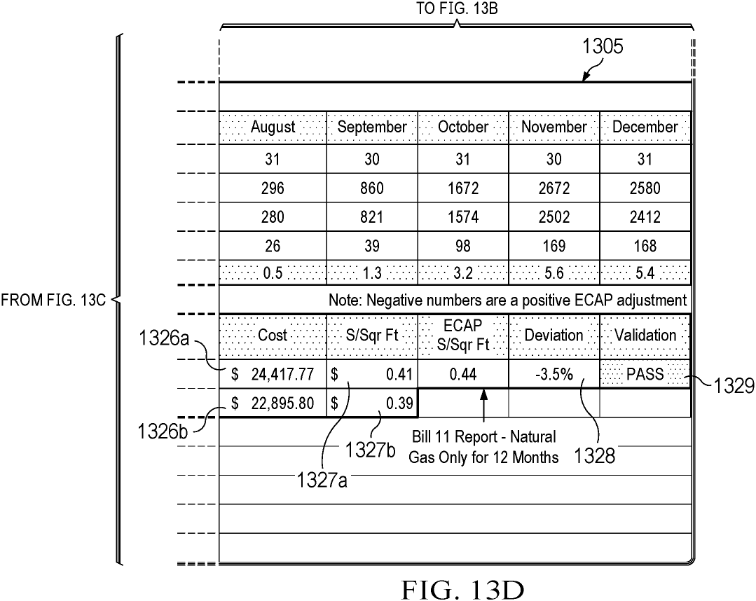

Referring to FIGS. 13A, 13B, 13C, and 13D, an example is provided of a preferred embodiment of the spreadsheet format for reporting. The spreadsheet format includes worksheet 1300 comprising table 1301, table 1302, table 1303, table 1304 and table 1305. Table 1301 further comprises a comparison between two sets of monthly electrical consumptions, the first set of monthly electrical consumptions populating row 1310 and the second set of monthly electrical consumptions populating row 1311. Row 1312 contains a calculated difference between row 1311 and row 1310 and represents a set of monthly electrical energy savings which is totaled to an annual electrical energy savings at cell 1313.

Table 1302 further comprises a comparison between two sets of monthly heating fuel consumptions, the first set of monthly heating fuel consumptions populating row 1320 and the second set of monthly electrical consumptions populating row 1321. Row 1322 contains a calculated difference between row 1321 and row 1320 and represents a set of monthly electrical energy savings which is totaled to an annual electrical energy savings at cell 1323.

Table 1303 further comprises a summary of monetary benefits including an annual monetary savings, a project cost and a project payback time. The annual monetary savings is computed from the annual electrical energy savings, the annual heating fuel savings and the costs of electricity and heating fuel.

Table 1304 further comprises a validation of electrical consumption calibration if the first set of monthly electrical consumptions represents the calibrated baseline energy usage profile for the calibrated baseline configuration. The calibrated annual electrical consumption, reported in cell 1314a, is compared to the actual annual electrical consumption, reported in cell 1315 as derived from the historical energy usage. A percentage difference between the calibrated baseline annual electrical consumption and the actual annual electrical consumption is calculated and reported in cell 1318. If the absolute value of the percentage difference is less than a predefined amount, then a ‘PASS’ is reported in cell 1319, otherwise a ‘FAIL’ is reported in cell 1319. Cells 1318 and 1319 implement the first condition of step 876 in FIG. 8. A second annual consumption is reported in cell 1314b for the second set of monthly electrical consumptions. Annual costs for the first and second set of monthly electrical consumptions are given in cells 1316a and 1316b, respectively. Annual costs per unit area for the first and second set of monthly electrical consumptions are given in cells 1317a and 1317b.

Table 1305 further comprises a validation of heating fuel consumption calibration if the first set of monthly heating fuel consumptions represents the calibrated baseline energy usage profile for the calibrated baseline configuration. The calibrated baseline annual heating fuel consumption, reported in cell 1324a, is compared to the actual annual heating fuel consumption, reported in cell 1325 as derived from the historical energy usage. A percentage difference between the calibrated baseline annual heating fuel consumption and the actual annual heating fuel consumption is calculated and reported in cell 1328. If the absolute value of the percentage difference is less than a predefined amount, then a ‘PASS’ is reported in cell 1329, otherwise a ‘FAIL’ is reported in cell 1329. Cells 1328 and 1329 implement the second condition of step 878 in FIG. 8. A second annual consumption is reported in cell 1324b for the second set of monthly heating fuel consumptions. Annual costs for the first and second set of monthly heating fuel consumptions are given in cells 1326a and 1326b, respectively. Annual costs per unit area for the first and second set of monthly heating fuel consumptions are given in cells 1327a and 1327b.

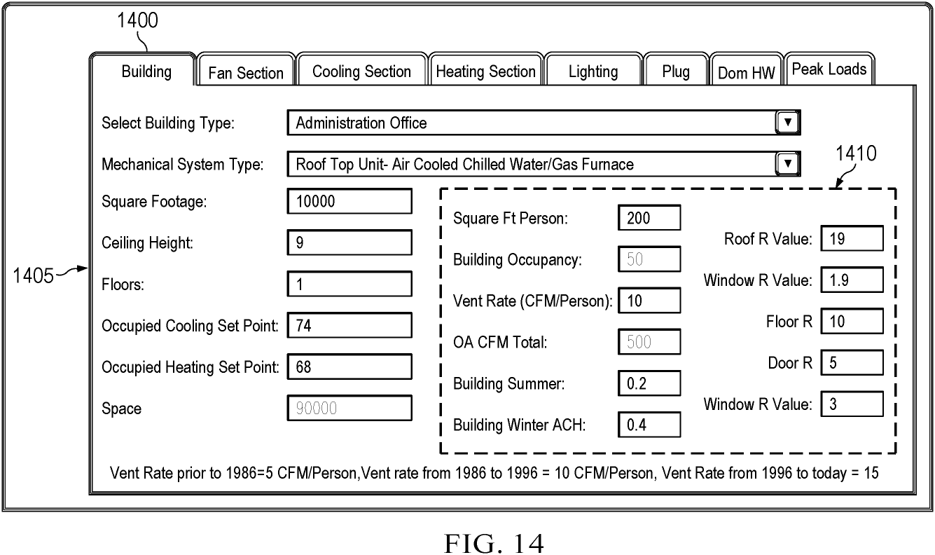

Referring to FIG. 14, building section form 1400 is shown comprising a simplified form area 1405 and an advanced form area 1410. Advanced form area 1410 is selectively hidden. Simplified form area 1405 includes selection controls for building type, mechanical system type, floor area (square footage), ceiling height, number of floors, occupied cooling set point and occupied heating set point. Advanced form area 1410 includes active selection controls for area per person (“Sq. Ft/Person”), vent rate (“CFM/Person”), building summer air changes per hour, building winter air changes per hour, roof R-value, window R-value, floor R-value, door R-value and wall R-value. Advanced form area 1410 also includes reporting areas for calculated and default settings including space volume, building occupancy and outside air ventilation required in CFM.

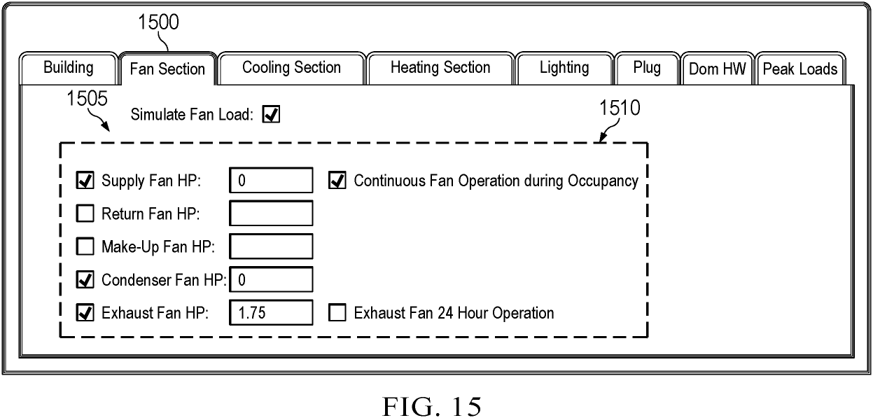

Referring to FIG. 15, fan section form 1500 is shown comprising a simplified form area 1505 and an advanced form area 1510. Advanced form area 1510 is selectively hidden. Simplified form area 1505 includes a selection control for including fan load in the energy simulation. Advanced form area 1510 includes active selection controls supply fan inclusion and horsepower rating, return fan inclusion and horsepower rating, make-up fan inclusion and horsepower rating, condenser fan inclusion and horsepower rating, exhaust fan inclusion and horsepower rating, an inclusion of continuous fan operation during occupancy in the energy simulation and an inclusion of 24 hour exhaust fan operation in the energy simulation.

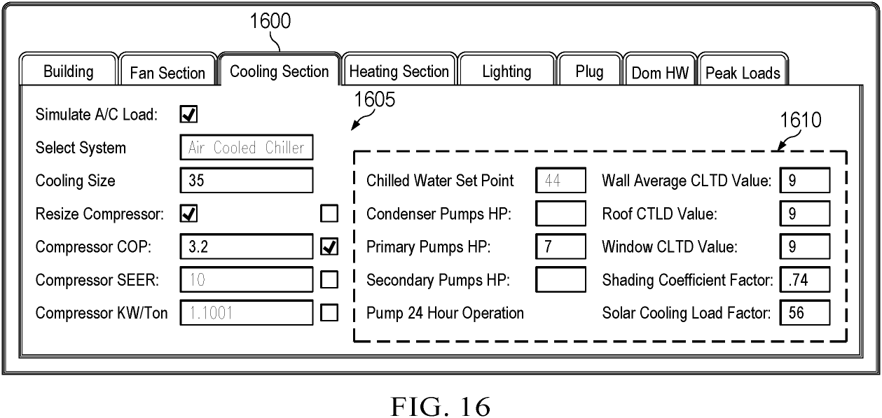

Referring to FIG. 16, cooling section form 1600 is shown comprising a simplified form area 1605 and an advanced form area 1610. Advanced form area 1610 is selectively hidden. Simplified form area 1605 includes selection controls for enabling the simulation of cooling system loads, cooling system size, enabling the resizing of the cooling system compressor, compressor COP rating and compressor SEER rating. Simplified form area 1605 also includes reporting areas for calculated and default settings including cooling system selection and kW/ton rating. Advanced form area 1610 includes selection controls for condenser pump inclusion and horsepower rating, primary pump inclusion and horsepower rating, secondary pump inclusion and horsepower rating, enabling 24 hour pump operation, wall average CLTD value, roof CLRD value, window CLTD value, shading coefficient factor and solar cooling load factor. Advanced form area 1610 also includes reporting areas for calculated and default settings including chilled water set point if the cooling system utilizes chilled water.

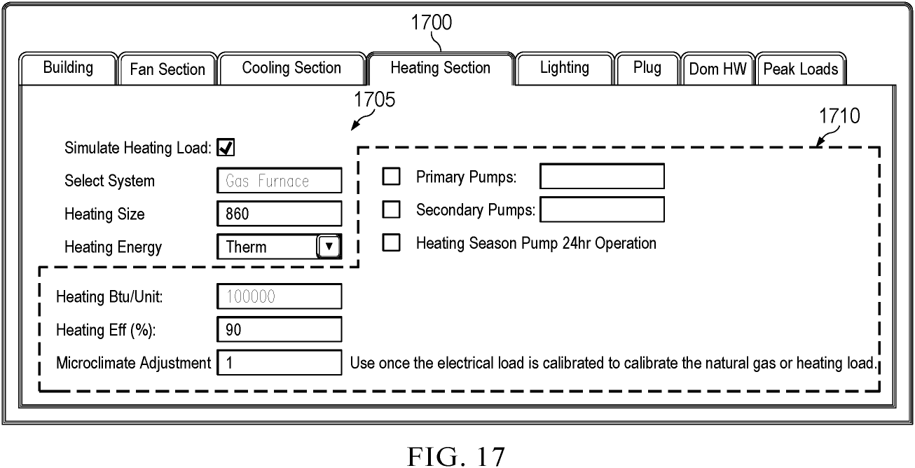

Referring to FIG. 17, heating section form 1700 is shown comprising a simplified form area 1705 and an advanced form area 1710. Advanced form area 1710 is selectively hidden. Simplified form area 1705 includes selection controls for enabling the simulation of heating system loads, heating system size, and heating fuel units. Simplified form area 1605 also includes reporting areas for calculated and default settings including heating system selection. Advanced form area 1710 includes selection controls for heating system efficiency, a microclimate adjustment factor, primary pump inclusion and horsepower rating, secondary pump inclusion and horsepower rating and enabling heating system 24 hour operation. Advanced form area 1710 also includes reporting areas for calculated and default settings including heating BTU/heating fuel unit.

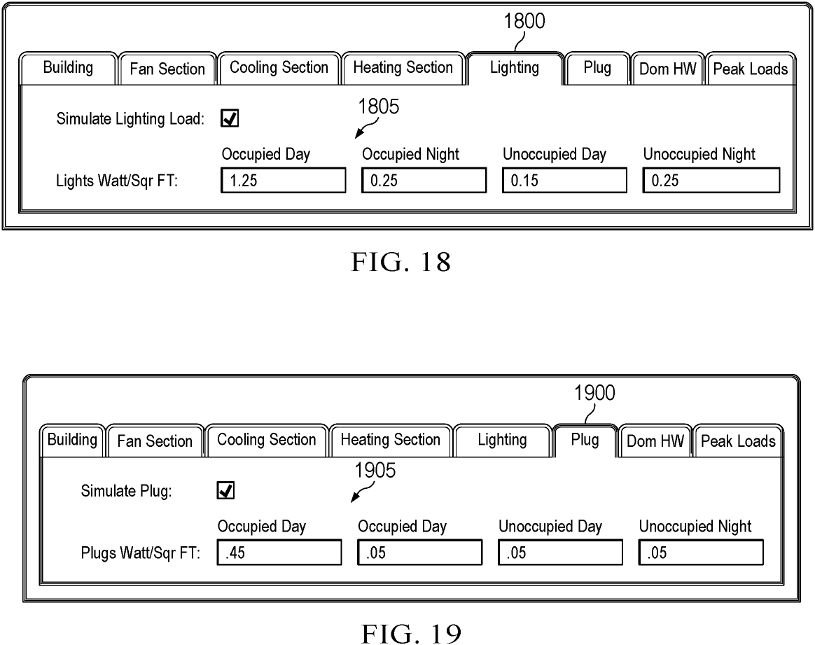

Referring to FIG. 18, lighting section form 1800 is shown comprising a form area 1805 which includes selection controls for enabling the simulation of lighting loads, lighting energy intensity (W/sq. ft.) for occupied daytime, lighting energy intensity for occupied nighttime, lighting energy intensity for unoccupied daytime and lighting energy intensity for unoccupied nighttime.

Referring to FIG. 19, plug section form 1900 is shown comprising a form area 1905 which includes selection controls for enabling the simulation of electrical plug loads, energy intensity (W/sq. ft.) for occupied daytime, energy intensity for occupied nighttime, energy intensity for unoccupied daytime and energy intensity for unoccupied nighttime.

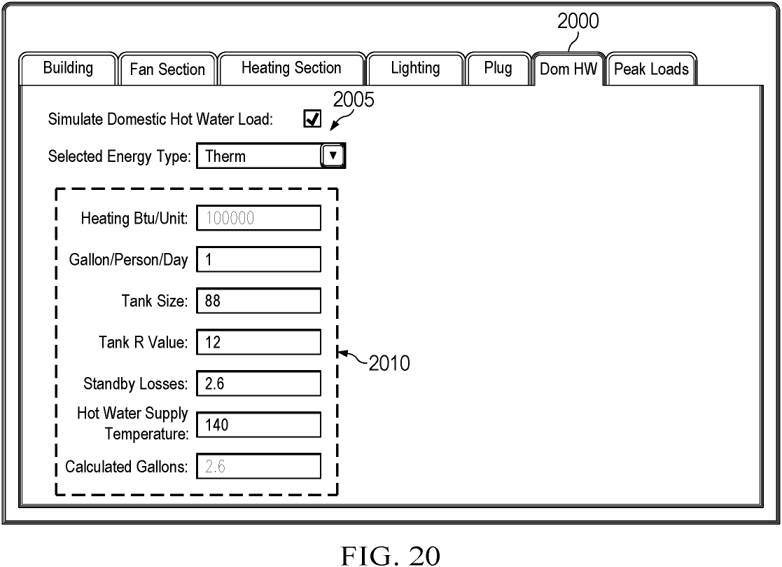

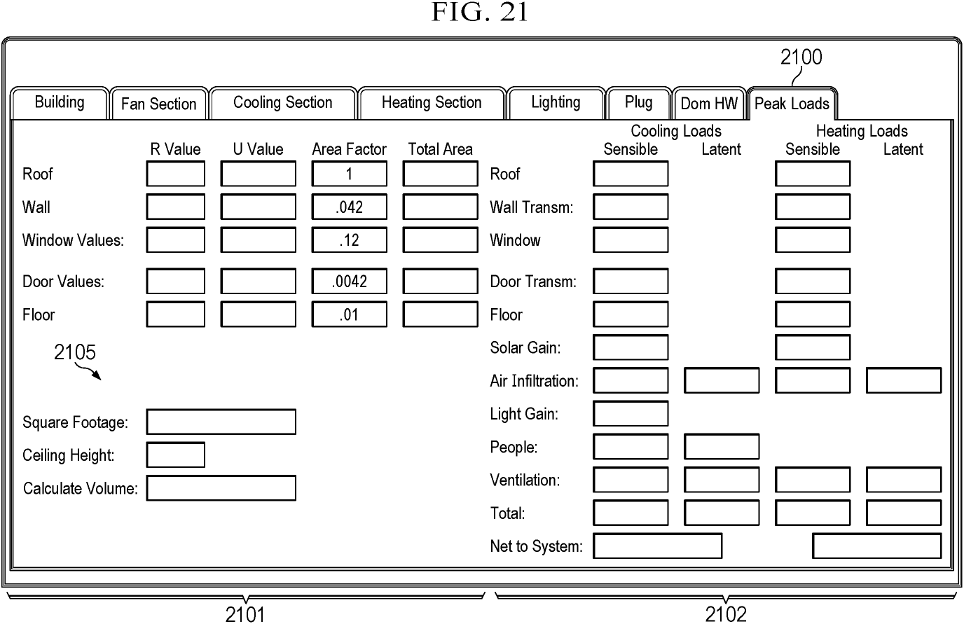

Referring to FIG. 20, domestic water heating section form 2000 is shown comprising a simplified form area 2005 and an advanced form area 2010. Advanced form area 2010 is selectively hidden. Simplified form area 2005 includes selection controls for enabling the simulation of domestic water heating loads and heating fuel units. Simplified form area 2005 also includes reporting areas for calculated and default settings including BTU /heating fuel unit. Advanced form area 2010 includes selection controls for gallons/person/day usage, tank size, tank insulation R-value, standby losses and hot water supply temperature set point. Advanced form area 2010 also includes reporting areas for calculated and default settings including calculated gallons of hot water.

Referring to FIG. 21, peak loads section form 2100 is shown comprising an advanced form area 2105. Peak loads section form and advanced form area 2105 are selectively hidden. Advanced form area 2105 includes selection controls area 2101 displaying conversion factors including a roof area factor, a wall area factor, a window area factor, a door area factor and a floor area factor. Advanced form area 2105 also includes reporting areas for calculated and copied values including floor area (‘Sq. Footage’), ceiling height and calculated volume, various building envelope R-values, U-values and building envelope areas. Advanced form area 2105 also has mechanical loads area 2102 including a set of sensible cooling loads, a set of latent cooling loads, a set of sensible heating loads and a set of latent heat loads for the building. In a preferred embodiment, advanced form area 2105 is populated upon execution of step 204 of method 200 and is primarily used as a reporting tool for the load calculations and system sizing.

Referring to FIG. 22, electronic form 2200 for lighting systems simulation is shown. In a preferred embodiment, lighting systems simulation can be performed as a standalone energy simulation which creates lighting energy models for a building. Electronic form 2200 comprises general information area 2205 for receiving building and client information, operational information area 2210 for receiving lighting operational data, fixture information area 2215 for receiving lighting fixture data, selector 2220 for retrieving existing lighting data from a previous lighting energy model and selector 2225 for processing the operational data and the fixture data which stores a lighting energy model based on the lighting operational data and lighting fixture data. Electronic form 2200 further comprises selector 2230 which closes the electronic form and displays the resulting data and selector 2235 which ends the program.

Lighting operational data includes a daily number of operational hours 2311 and a monthly schedule of occupied days 2312. Lighting fixture data includes a set of lighting fixture types 2216 with a description of each lighting fixture type, a quantity of lighting fixtures 2217 for each lighting fixture type and an energy consumption 2218 (wattage) for each lighting fixture type.

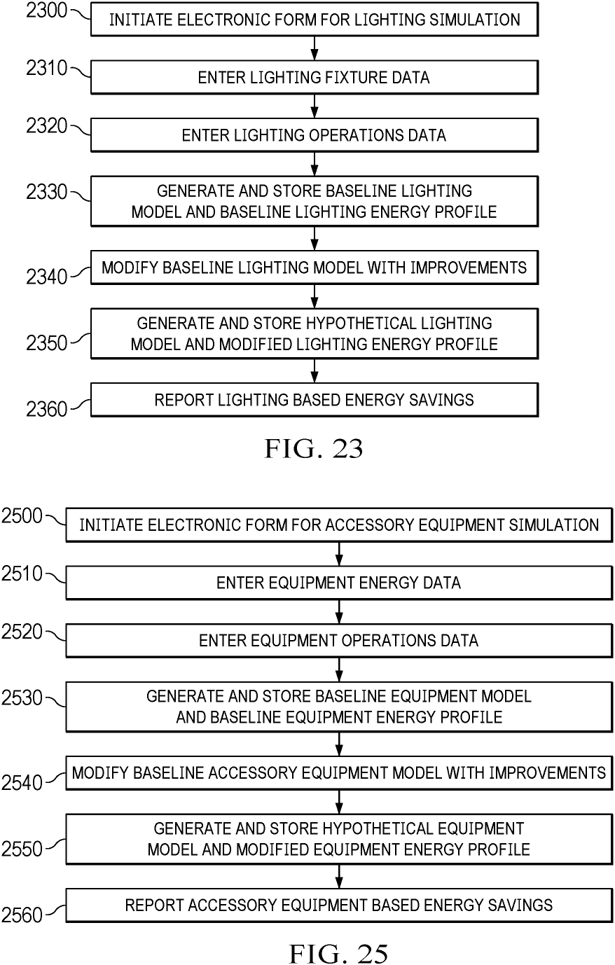

Referring to FIG. 23, a method for lighting systems simulation is described. At step 2300 electronic form 2200 is displayed. At step 2310, the lighting fixture data for a building is entered. At step 2320, the lighting operations data for a building is entered. At step 2330, a baseline lighting energy model is generated and stored resulting in a baseline set of monthly lighting energy consumptions, a baseline operational data and a baseline fixture data. At step 2340, the baseline operational data and baseline fixture data are modified with energy efficiency improvements to arrive at a hypothetical operational data and a hypothetical fixture data. For example, step 2340 can include removing all T12 pin fluorescent light fixture types from the baseline fixture data and adding more efficient T8 pin fluorescent light fixture types in their place to create a modified fixture data.

At step 2350, a hypothetical lighting model is generated and stored resulting in a hypothetical set of monthly lighting energy consumptions based on the hypothetical operational data and the hypothetical fixture data. At step 2360, a set of differences between the set of hypothetical monthly lighting energy consumptions and the set of baseline monthly lighting energy consumptions is calculated and reported along with a total lighting based energy savings. In a preferred embodiment, the set of differences is reported as two energy consumption graphs.

Referring to FIG. 24, electronic form 2400 for accessory equipment simulation is shown. In a preferred embodiment, accessory equipment simulation can be performed as a standalone energy simulation which creates accessory equipment energy models for a building. Electronic form 2400 comprises general information area 2405 for receiving building and client information, operational information area 2410 for receiving equipment operational data, equipment information area 2415 for receiving equipment energy data, selector 2420 for retrieving existing accessory equipment data from a previous accessory equipment energy model and selector 2425 for processing the equipment operational data and the equipment energy data which stores an accessory equipment energy model based on the equipment operational data and equipment energy data. Electronic form 2400 further comprises selector 2430 which closes the electronic form and displays the resulting data and selector 2435 which ends the program.

Equipment operational data includes a daily number of operational hours 2411, a monthly schedule of operational days 2412 and an operational diversity factor 2413. Equipment energy data includes a set of equipment types 2416 with a description of each equipment type, a quantity of equipment 2417 for each equipment type and an energy consumption 2418 (wattage) for each equipment type.

Referring to FIG. 25, a method for accessory equipment simulation is described. At step 2500 electronic form 2400 is displayed. At step 2510, a baseline equipment energy data for a building is entered. At step 2520, a baseline equipment operations data for a building is entered. At step 2530, a baseline equipment energy model is generated and stored based on the baseline operational data and the baseline equipment energy data. The baseline energy model includes a baseline set of monthly equipment energy consumptions. At step 2540, the baseline operational data and baseline equipment energy data are modified with energy efficiency improvements to arrive at a hypothetical operational data and a hypothetical equipment energy data. For example, step 2540 can include replacing all exhaust fan motors with more energy efficient exhaust fan motors to create a modified equipment energy data.

At step 2550, a hypothetical equipment energy model is generated and stored resulting in a hypothetical set of monthly equipment energy consumptions, based on the hypothetical operational data and the hypothetical equipment energy data. At step 2560, a set of differences between the set of hypothetical monthly equipment energy consumptions and the set of baseline monthly equipment energy consumptions is calculated and reported along with a total accessory equipment energy savings. In a preferred embodiment, the set of differences is reported as two energy consumption graphs, similar to those of FIG. 9.

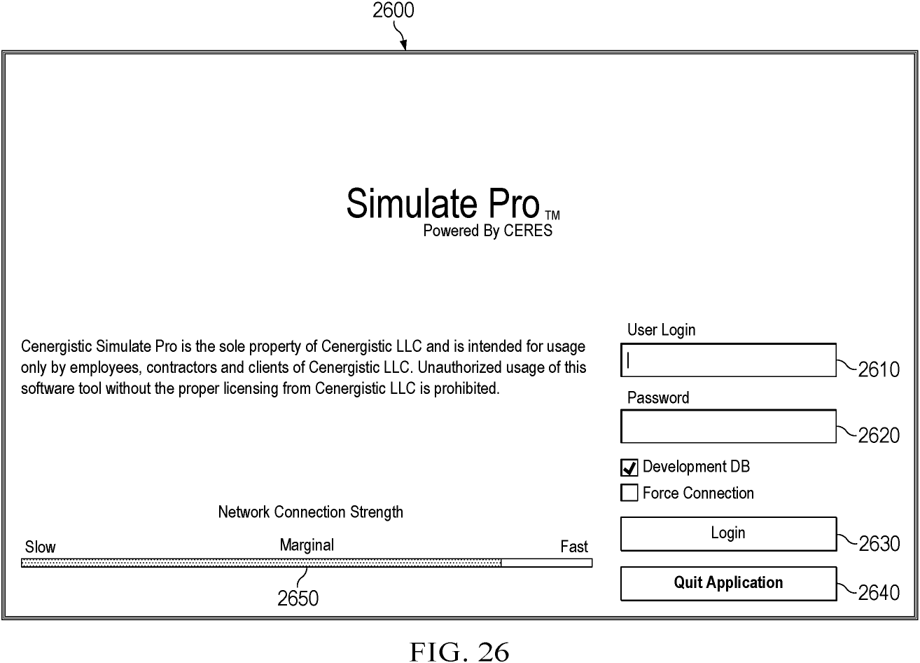

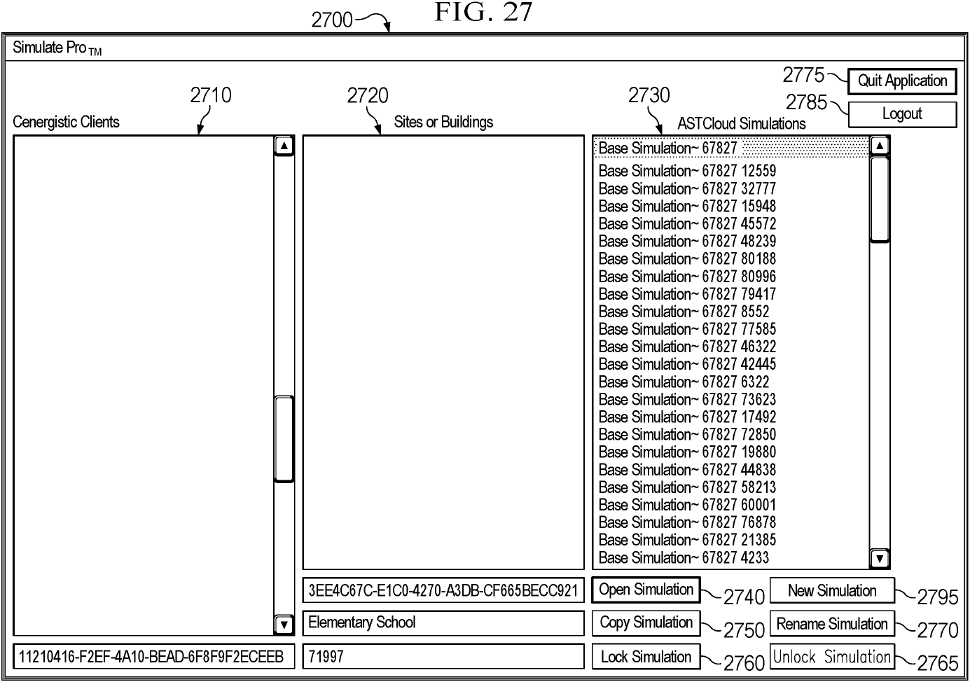

Referring to FIG. 26, electronic form 2600 is shown. Electronic form 2600 is a login screen. Electronic form 2600 comprises a display and edit box 2610 for receiving a user ID and a display and edit box 2620 for receiving a user password. After entering their user login and password, the user can click login button 2630. If the user does not want to login, they can click quit application button 2640. Bar gauge 2650 graphically shows network connection strength.

A “baseline year” is intended to mean a 12-calendar month period modeled by a baseline simulation and/or a calibrated simulation.

A “current year” (“adjustment year”) is intended to mean a 12-calendar month period subsequent to the end of a baseline year.

A “model” is intended to mean a parameter set that when simulated by a simulation engine results in a simulation.

A “metered consumption” is intended to mean actual measured energy usage.

A “baseline simulation” is intended to mean a simulation of energy consumption resulting from an application of a parameter set to a simulation engine for the baseline year.

A “calibrated simulation” is intended to mean a simulation of energy consumption that is accurate and/or precise to within a chosen tolerance relative to metered consumption.

A “modified simulation” is intended to mean a simulation of energy consumption that results from a model that has been changed to reflect a hypothetical set of parameters.

An “adjusted simulation” is intended to mean a calibrated simulation that has been changed to account for an aberration or unexpected change in energy usage.

An embodiment of the invention can have multiple user access levels. In a preferred embodiment, the levels range from 1 = view only to 5 = super user. The different levels are associated with different user capabilities. For example, a level 2 user could change set point variables of the simulation, a level 3 user could change equipment variables of the simulation, and a level 4 user could change the equations of the simulation. The user level can be determined based on the user ID and/or user password. Of course, the invention is not limited to 5 user levels or to particular capabilities associated with those levels; and the invention can have any number of access levels that are associated with different user capabilities.

Referring to FIG. 27, electronic form 2700 is shown. Electronic form 2700 comprises list of clients 2710, list of sites or buildings 2720, and list of simulations 2730. Electronic form 2700 is a main selection screen where the user can select a client from list of clients 2710, select a site or building from list of sites or buildings 2720, and/or select a simulation from list of simulations 2730. From electronic form 2700, the user can select open simulation button 2740, copy simulation button 2750, lock simulation button 2760, unlock simulation button 2765, rename simulation button 2770, or new simulation button 2795. The lock feature, when engaged prevents all changes to the simulation. From electronic form 2700, the user can select quit application button 2775 or logout button 2785.

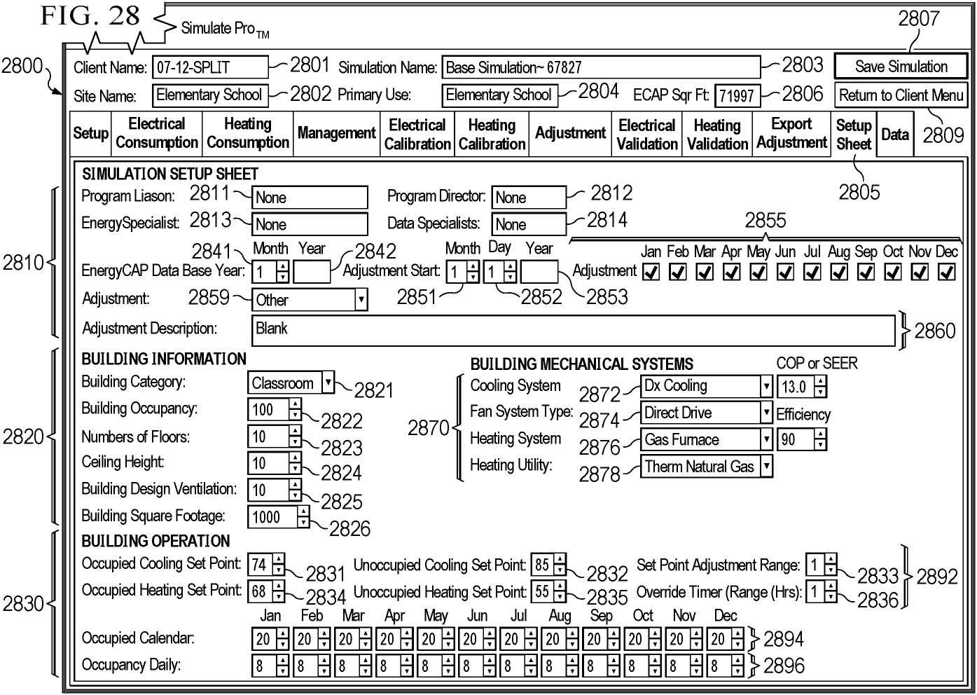

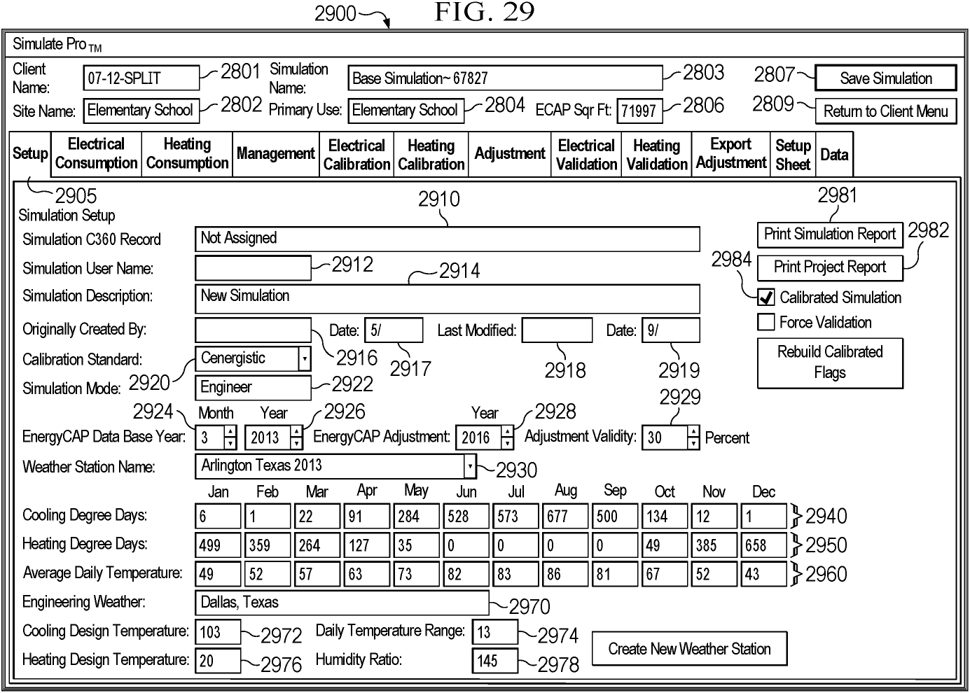

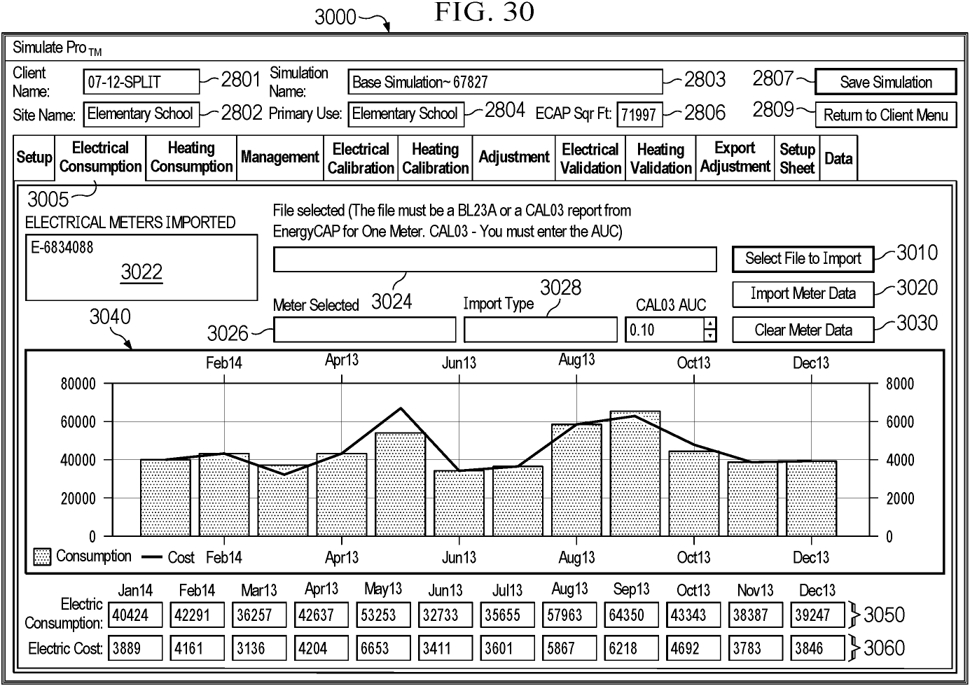

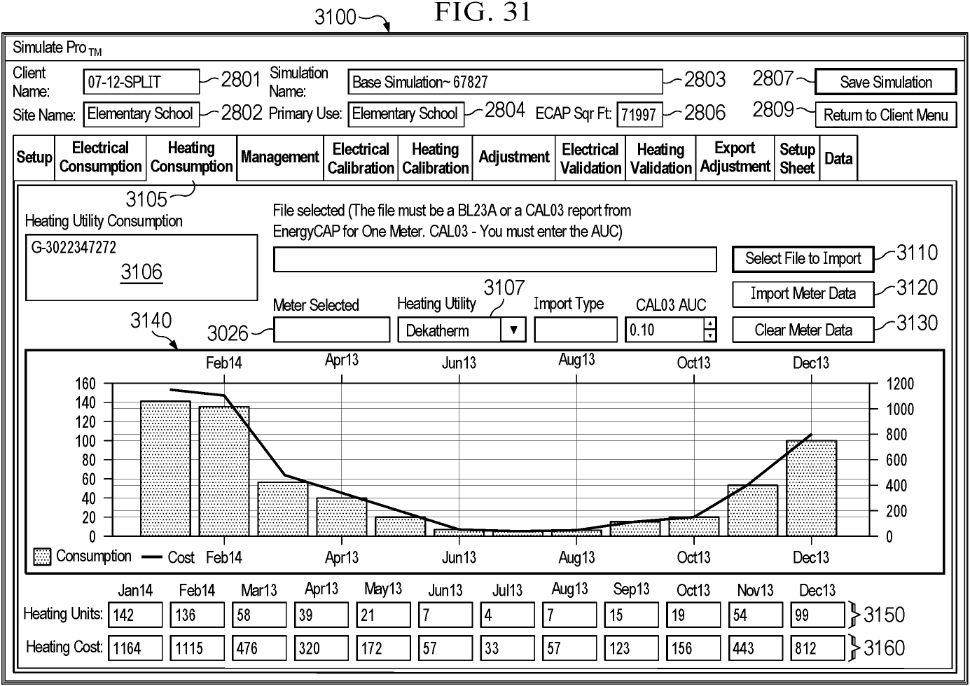

Referring to FIG. 28, electronic form 2800 is shown. Electronic form 2800 is a new simulation setup screen. Electronic form 2800 is displayed when the user selects setup sheet tab 2805. Electronic form 2800 comprises display box 2801 for client name, display box 2802 for site name, display box 2803 for simulation name, display box 2804 for primary use, and display box 2806 for square footage. Electronic form 2800 comprises display and edit boxes for simulation setup sheet 2810, display and edit boxes for building information 2820, and display and edit boxes for building operation 2830. From electronic form 2800, the user can move to another tab, select save simulation button 2807 to save simulation or select return to client menu button 2809 to return to client menu. These control buttons are repeated on all screens to allow navigation.

Display and edit boxes for simulation setup sheet 2810 comprise program liaison box 2811, program director box 2812, energy specialist box 2813, and data specialists box 2814. The data entered in these boxes identifies individuals responsible for various tasks during use of the simulation. Electronic form 2800 can import more than one year’s historical electrical and heating utility data. In this embodiment, a base year for the base simulation can be selected to begin and end a one year date range selected from within the time span of the imported historical data. Month box 2841 and year box 2842 are for selecting the start month and year of the base year. The phrase base year is intended to mean a one year period for use in the base simulation. This embodiment enables the user to slide the base year of the graphical user interface across the available imported historical data.

Electronic form 2800 allows the user to set the adjustment year for the adjustment simulation. Month box 2851, day box 2852, and year box 2853 are for selecting the start month, day, and year of the adjustment year for an adjustment (modified) simulation. The phrase adjustment year is intended to mean a one year period of time after an event, for example, end of a month, repair/maintenance of equipment, renovation of building, change in utilization patterns, etc. This embodiment provides flexibility in choosing both the date range of the base year and the date range of the adjustment year. Tick boxes 2855 allow the user to determine what months of the year will be included in an adjustment simulation.

Electronic form 2800 comprises adjustment box 2859, and adjustment description box 2860. This allows personnel to provide and archive data such as comments and remarks about a simulation within the simulation itself. Explanatory remarks can be particularly useful for other personnel who need to use, and potentially adjust, the simulation at a later point in time. By storing this data within the simulation, the need to find and maintain separate files or notes containing this information is eliminated.

Display and edit boxes for building information 2820 comprise building category box 2821, building occupancy box 2822, and number of floors box 2823. Display and edit boxes for building information 2820 comprise ceiling height box 2824, building design ventilation box 2825, and building square footage box 2826.

Display and edit boxes for building operation 2830 comprise display and edit boxes for set points 2892, display and edit boxes for occupied calendar 2894, and display and edit boxes for occupancy daily 2896. Display and edit boxes for set points 2892 comprise occupied cooling set point box 2831, unoccupied cooling set point box 2832, set point adjustment range box 2833, occupied heating set point box 2834, unoccupied heating set point box 2835, and override timer range (hours) box 2836. The override timer range signifies the length of time that any thermostat can be manually set to an arbitrary temperature before returning to a preprogrammed set point.

Electronic form 2800 comprises display and edit boxes for the building mechanical systems 2870. Display and edit boxes for the building mechanical systems 2870 comprise cooling system box 2872, fan system type box 2874, heating system box 2876, and heating utility box 2878.

Referring to FIG. 29, electronic form 2900 is shown. Electronic form 2900 is a main simulation screen. Electronic form 2900 is displayed when the user selects setup tab 2905.

Electronic form 2900 comprises simulation C360 record 2910, simulation user name box 2912, simulation description box 2914, and originally created by box 2916. Electronic form 2900 comprises date box 2917, last modified box 2918, and date box 2919. Entry of data in each of these boxes allows later positive identification of the simulation. Electronic form 2900 comprises calibration standard box 2920, and simulation mode box 2922. The data entered in the calibration standard box indicates which standard is to be applied to validate a simulation. In a preferred embodiment, two standards options are provided. First, the ASHRAE 14.1 standard which provides for 10% annually and 10% monthly, and second, a more lenient standard of 10% annually. The data entered in the simulation mode box is a tracking feature that denotes either “engineer” or “consultant”.

Electronic form 2900 comprises base month box 2924, base year box 2926, EnergyCAP adjustment box 2928, and adjustment validity box 2929 to specify percentage threshold for validity. The base month and base year box indicate the year that forms the baseline for the simulation. The data entered in the EnergyCAP adjustment box is data indicating the energy usage for the year being simulated, that is, the year that requires an adjustment. The data entered in the adjustment validity box is the maximum permitted difference between the base curve and the simulation curve. If the difference is above the chosen percentage, e.g. 30%, then the simulation is considered flawed and no data may be exported.

Electronic form 2900 comprises weather station name box 2930 to select the optimum local weather station for the simulation. Electronic form 2900 comprises cooling degree days boxes 2940 for each month based on the selected weather station. Electronic form 2900 comprises heating degree days boxes 2950 for each month based on the selected weather station. Electronic form 2900 comprises average daily temperature boxes 2960 for each month based on the selected weather station. Electronic form 2900 comprises engineering weather box 2970, cooling design temperature box 2972, daily temperature range box 2974, heating design temperature box 2976, and humidity ratio box 2978. The data entered in the cooling design temperature box indicates the highest yearly temperature expected in the simulation. In a preferred embodiment this temperature is published by ASHRAE for each geographic region. The data entered in the heating design temperature box indicates the lowest yearly temperature expected for the simulation. In a preferred embodiment, this temperature is published by ASHRAE for each geographic region. Electronic form 2900 comprises print simulation report button 2981, print project report button 2982, and calibrated simulation tick box 2984.

Referring to FIGS. 30 and 31, the invention can directly import historical energy consumption data from EnergyCAP. EnergyCAP is energy auditing software for utility bill accounting, energy management, and building operations that is readily commercially available from EnergyCAP, Inc. of State College, Pennsylvania. This use of a third-party source to import consumption data is useful to obviate the need for manual entry of historical energy consumption data. By eliminating the need for manual entry of data, a source of potential error is removed and the accuracy and precision of the simulation can be improved. EnergyCAP can provide an efficient interface between embodiments of the invention and electric power data from regional electric power management entities such as Electric Reliability Council of Texas (ERCOT) or other entities on a meter-by-meter basis.

Referring to FIG. 30, electronic form 3000 is shown. Electronic form 3000 is an electric metered data screen that is displayed when the user selects electrical consumption tab 3005. Electronic form 3000 comprises display box 2801 for client name, display box 2802 for site name, display box 2803 for simulation name, display box 2804 for primary use, and display box 2806 for square footage. Electronic form 3000 allows the user to import metered electrical consumption data from energy auditing software, for example, EnergyCAP. Electronic form 3000 comprises select file to import button 3010, import meter data button 3020, and clear meter data button 3030. Display box 3022 displays the names of the meters imported. Display box 3024 displays the imported meter data file name. Display box 3026 displays the names of the meters selected. Display box 3028 shows the type of file imported. Electronic form 3000 comprises graphical representation of monthly electric consumption 3040, monthly electric consumption display boxes 3050, and monthly electric cost display boxes 3060. From electronic form 3000, the user can move to another tab, save changes by selecting save simulation button 2807, or exit by selecting return to client menu button 2809.

Referring to FIG. 31, electronic form 3100 is shown. Electronic form 3100 is a heating utility metered data screen that is presented when the user selects heating consumption tab 3105. Electronic form 3100 allows the user to import metered heating utility consumption data from energy auditing software, for example, EnergyCAP. Electronic form 3100 comprises select file to import button 3110, import meter data button 3120, and clear meter data button 3130. Heating utility consumption is shown in display box 3106. The heating unit utility name is shown in display box 3107. Electronic form 3100 comprises graphical representation of monthly heating utility consumption 3140, monthly heating utility consumption display boxes 3150, and monthly heating utility cost display boxes 3160.

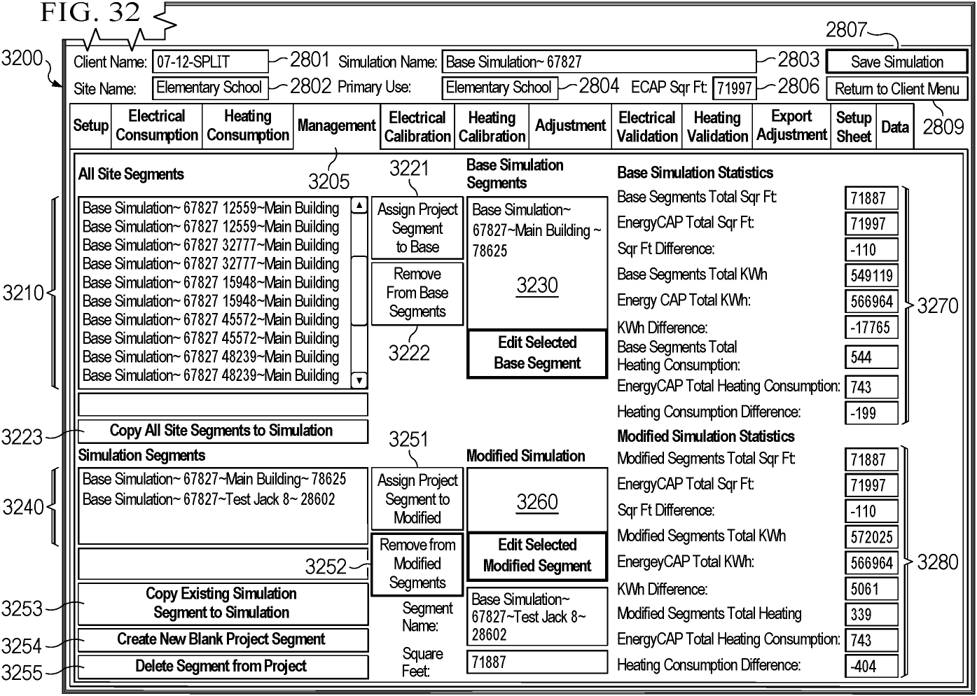

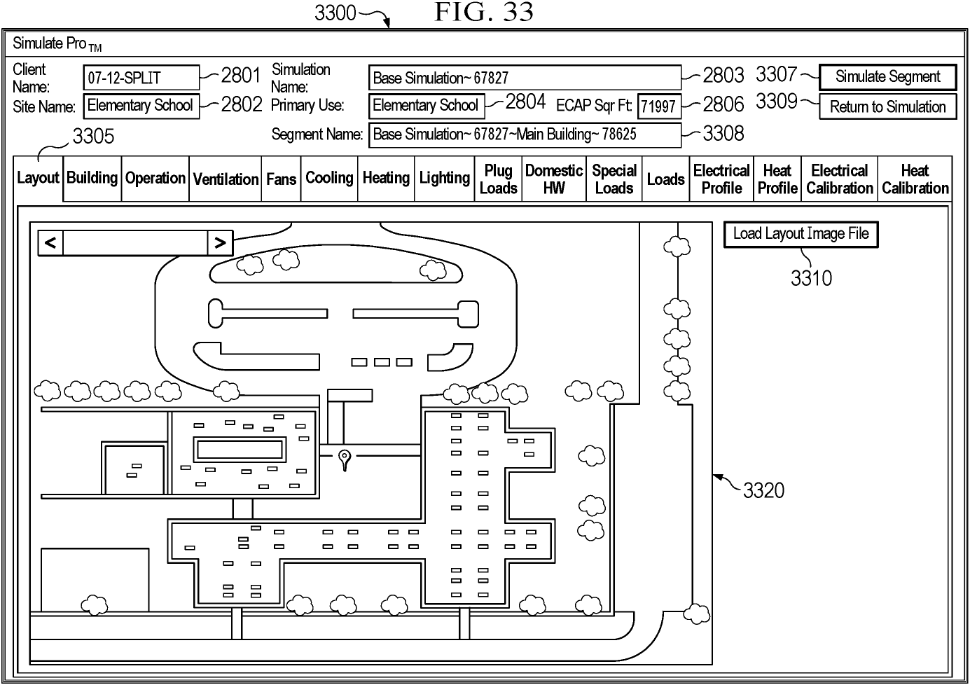

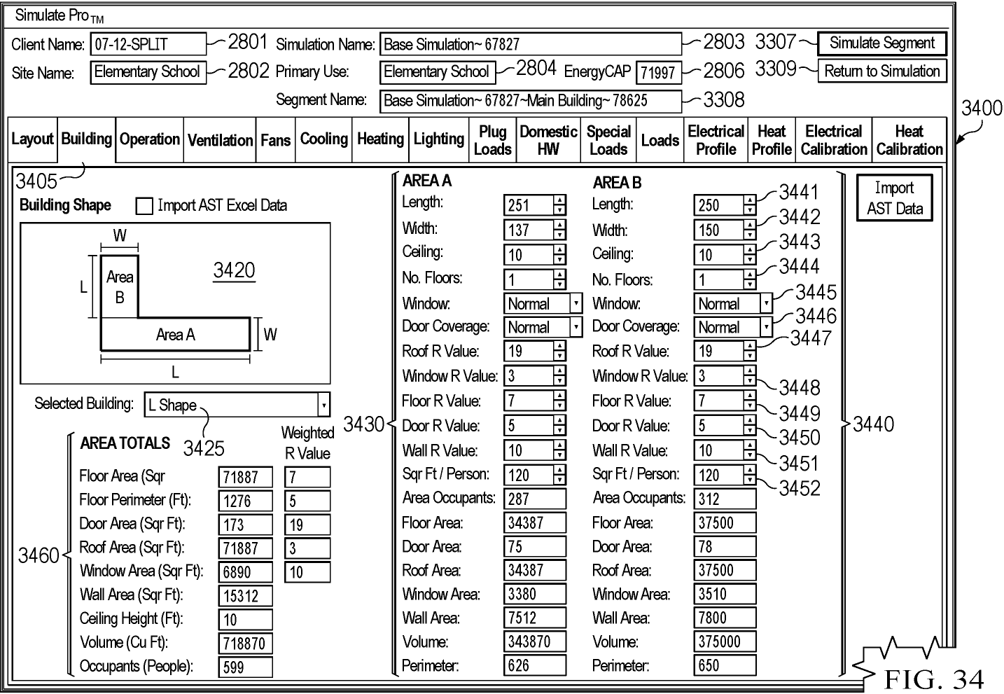

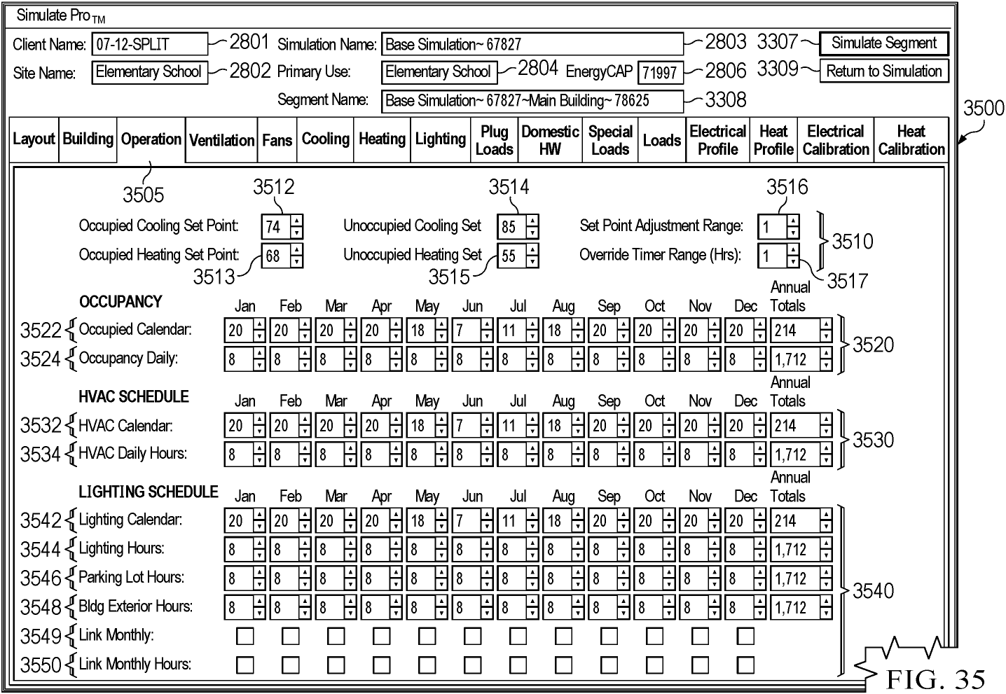

Referring to FIG. 32, electronic form 3200 is shown. The simulation includes a plurality of site segments, each of which is a component of the larger simulation. The site segments typically represent separate buildings or physical structures. For example, a simulation can include any number of buildings or sites that comprise 1, 2, 3, 4, 5 or any integer number of segments. This feature of the invention is useful to simulate a complex building or a complex site. Electronic form 3200 is a screen that allows the user to assign, remove and create segments as parts of an overall simulation. The invention’s use of segments facilitates simulating a building or site, by dividing the overall simulation into parts or segments that are more easily managed and modified by the user. The results from the segments can be combined to obtain results for the overall building or the overall site. This feature of the invention is especially useful for a user to create alternative segments to test different approaches to optimizing energy savings measures. For instance, combining the segments can include the user selecting which of a plurality of alternative segments to include in the overall simulation of the building or site.

Electronic form 3200 is displayed when the user selects management tab 3205. Electronic form 3200 comprises all site segments list 3210. Electronic form 3200 comprises assign project segment to base button 3221, remove from base segments button 3222, and copy all site segments to simulation button 3223. These buttons allow the user to determine which segments appear in base simulation segments list 3230. Electronic form 3200 comprises simulation segments list 3240. Electronic form 3200 comprises assign project segment to modified button 3251, remove from modified segments button 3252, copy existing simulation segment to simulation button 3253, create new blank project segment button 3254, and delete segment from project button 3255. These buttons allow the user to determine which segments appear in modified segments list 3260.

Electronic form 3200 comprises set of display boxes 3270 showing base simulation statistics and set of display boxes 3280 showing modified simulation statistics. The base simulation statistics includes base segments total square foot, EnergyCAP total square foot, square foot difference, base segments total kilowatt per hour, EnergyCAP total kilowatt per hour, kilowatt per hour difference, base segments total heating consumption, EnergyCAP total heating consumption and heating consumption difference. The modified simulation statistics includes modified segments total square foot, EnergyCAP total square foot, square foot difference, modified segments total kilowatt per hour, EnergyCAP total kilowatt per hour, kilowatt per hour difference, modified segments total heating, EnergyCAP total heating consumption, and heating consumption difference. In this example, the simulation that is going to be used to calibrate the base simulation has one segment called “Base Simulation~67827-Main Building - 78625” as shown in base simulation segments list 3230.

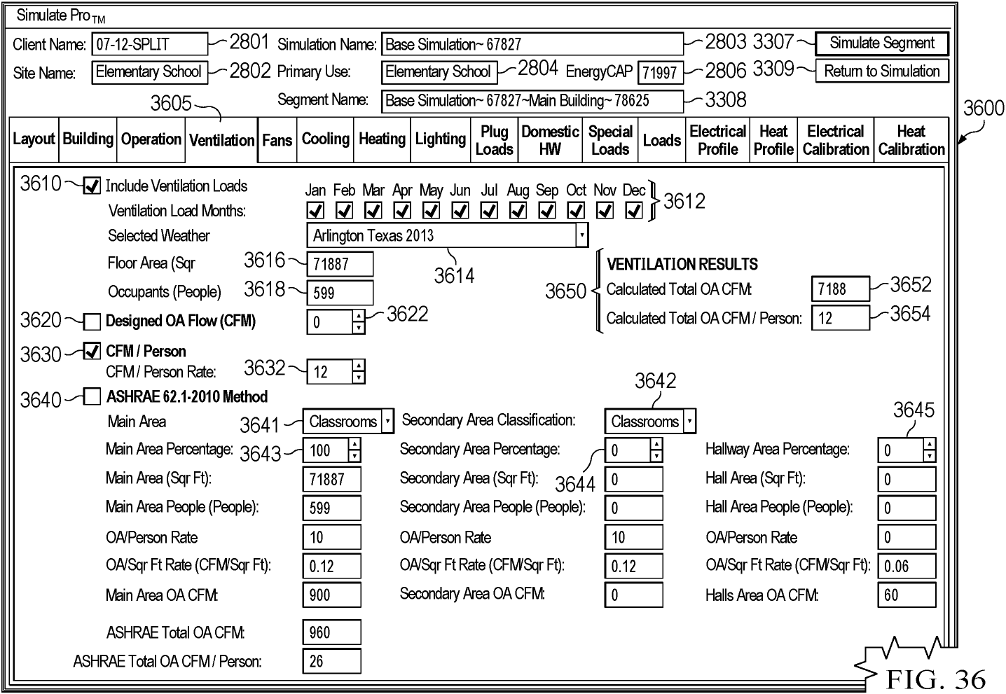

Referring to FIG. 33, electronic form 3300 is shown. Electronic form 3300 is a layout screen of a simulation engine for a segment. Electronic form 3300 is displayed when the user selects layout tab 3305. From electronic form 3300, the user can move to another tab, select button 3307 to simulate segment or select button 3309 to return to simulation. Electronic form 3300 comprises display box 3308 for segment name.

The invention can store one or more aerial photographs of a building or site that is being simulated. Electronic form 3300 comprises load layout image file button 3310 and display 3320 of the loaded layout image file. The images can be stored in the structured query language (SQL) of the simulation. In this embodiment, one or more aerial photographs can be used as the source of simulation data and/or to confirm or revise simulation data. For instance, the shape and dimensions of roof surfaces that are visible in an aerial image can be compared to the shapes and dimensions of simulated structures, for example segments of a building. In this way, independent variables in the segments that represent parts of a building or other structure can be verified against data from an objective third-party source, namely the aerial images. If the differences are small, then the independent variables in the segment are confirmed. If the differences are above a threshold, for example 5%, then the independent variables in the segment can be corrected or at least flagged as needing further evaluation.

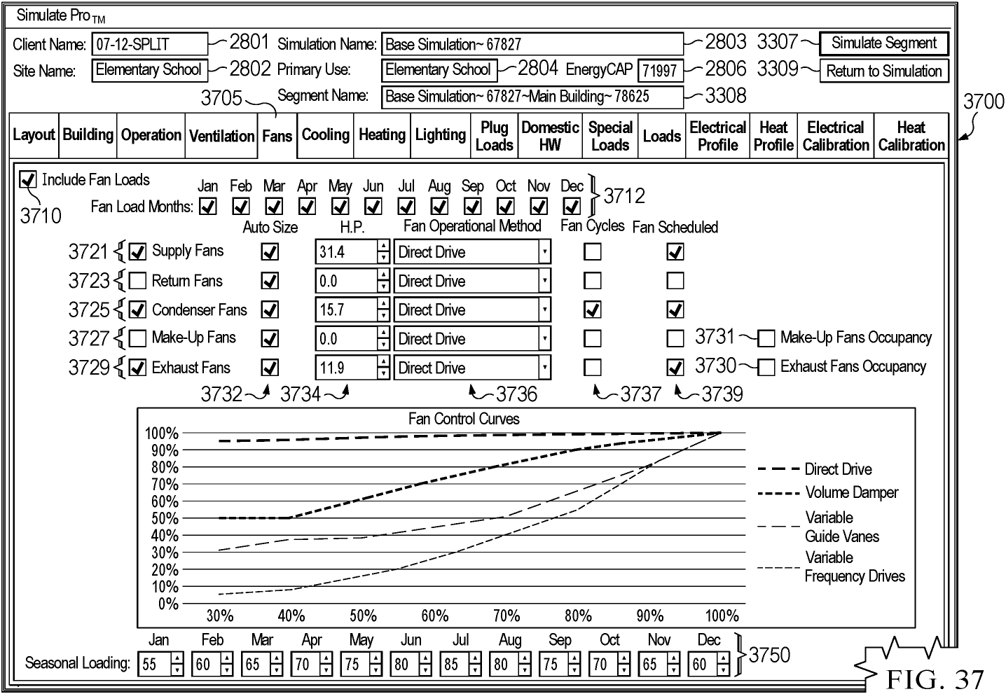

Referring to FIG. 34, electronic form 3400 is shown. Electronic form 3400 is the building screen of the segment simulation engine. Electronic form 3400 is displayed when the user selects building tab 3405. Electronic form 3400 comprises a display 3420 of a building shape, display and edit boxes 3430 for area A, display and edit boxes 3440 for area B, and display and edit boxes 3460 for area totals. From this screen, the user can create a plan view of a building or segment by choosing, positioning and joining various shapes, and then adjusting the size of the plan to match the building shape. Once joined, the separate shapes are joined into a larger complex shape without many walls in-between.

Electronic form 3400 comprises display and edit box 3425 for a selected building shape that determines the number of areas for user input to scale the shape into the right size. For instance, display and edit boxes 3440 for area B comprise length box 3441, width box 3442, ceiling box 3443, number of floors box 3444, window coverage box 3445, door coverage box 3446, roof R value box 3447, window R value box 3448, floor R value box 3449, door R value box 3450, wall R value box 3451, and square footage per person box 3452. This feature of the invention generates accurate and precise wall segments because of the comprehensive parameters. A similar feature is provided for segment “A”.

A segment simulation can comprise multiple areas. Multiple segments can be combined in the overall simulation to represent a plan view of the building. For example, a rectangular wing of a building can be represented by a rectangular shape that is positioned adjacent another shape that represents another portion of the building. Each of these shapes can be simulated in a separate segment simulation. The overall simulation that is a summation of the individual segment simulations. When joined, the individual shapes are recognized by the simulation as being one integrated polygon. The number of segments (and their areas) is not limited enabling the user to define shapes of a building in great detail. An excerpt of software code that accomplishes the functions of this screen is included in the Computer Program Listing Appendix 1.

Referring to FIG. 35, electronic form 3500 is shown. Electronic form 3500 is an operation screen associated with the segment simulation. Electronic form 3500 is displayed when the user selects operation tab 3505.

Electronic form 3500 comprises temperature set points display and edit boxes 3510, occupancy schedule display and edit boxes 3520, HVAC schedule display and edit boxes 3530, and lighting schedule display and edit boxes 3540. Temperature set points display and edit boxes 3510 comprise occupied cooling set point box 3512, occupied heating set point box 3513, unoccupied cooling set point box 3514, unoccupied heating set point box 3515, set point adjustment range box 3516, and override timer range (hours) box 3517. Occupancy schedule display and edit boxes 3520 comprise monthly occupied calendar days boxes 3522 and monthly occupancy daily hours boxes 3524. HVAC schedule display and edit boxes 3530 comprise monthly HVAC calendar days boxes 3532 and monthly HVAC daily hours boxes 3534. Lighting schedule display and edit boxes 3540 comprise monthly lighting calendar days boxes 3542, monthly lighting hours per day boxes 3544, monthly parking lot hours per day boxes 3546, and monthly building exterior hours per day boxes 3548.

The feature of monthly parking lot hours per day can improve both the baseline and the adjustment simulations because parking lot light installations are typically wired on separate circuits that can be separately switched on a timer automatically. The feature of monthly building exterior hours per day can improve the simulations because exterior lighting installations are often on separate circuits that can be separately switched on a timer automatically. An excerpt of software code that accomplishes the functions of this screen is included in the Computer Program Listing Appendix 2.

Lighting schedule display and edit boxes 3540 comprise link monthly tick boxes 3549. Lighting schedule display and edit boxes 3540 comprise link monthly hours tick boxes 3550. When ticked, the link monthly boxes add the corresponding month to the simulation. When ticked, the link monthly hours boxes add the hours for lighting, parking lot and building exterior to the simulation. An excerpt of software code that accomplishes the functions of this screen is included in the Computer Program Listing Appendix 3 and Appendix 4.

Referring to FIG. 36, electronic form 3600 is shown. Electronic form 3600 is a ventilation screen associated with the simulation for the segment. Electronic form 3600 is displayed when the user selects ventilation tab 3605.

Electronic form 3600 comprises tick box 3610 to lockout the ventilation load and tick boxes 3612 to control lockout of individual months. This feature can improve the calibration simulation. Locking out the ventilation energy loads isolates the relatively unpredictable ventilation energy loads from the remainder of the base load so that calibration of the remainder of the base can focus on those factors that are relatively predictable compared to the ventilation energy loads. An excerpt of software code that accomplishes the functions of this screen is included in the Computer Program Listing Appendix 5.

Electronic form 3600 comprises selected weather display and edit box 3614, floor area display box 3616, and number of occupants display box 3618. Electronic form 3600 allows the user to calculate the ventilation loads using the designed CFM, CFM/person, or an ASHRAE 62.1 calculation. Electronic form 3600 comprises designed OA flow tick box 3620, CFM/person tick box 3630, and ASHRAE 62.1-2010 method tick box 3640. If the user selects designed OA flow tick box 3620, then the user needs to provide a CFM input at display and edit box 3622. If the user selects CFM/person tick box 3630, then the user needs to provide a CFM/person input at display and edit box 3632. If the user selects ASHRAE 62.1-2010 method tick box 3640, then the user needs to provide inputs at main area display and edit box 3641, secondary area classification display and edit box 3642, main area percentage display and edit box 3643, secondary area percentage display and edit box 3644, and hallway area percentage display and edit box 3645. In any event, ventilation results 3650 comprise display box 3652 for calculated total OA CFM, and display box 3654 for calculated total OA CFM/person. This choice of three approaches is an advantageous enhancement beyond simply specifying a CFM/person parameter. An excerpt of software code that accomplishes the functions of this screen is included in the Computer Program Listing Appendix 7.

Referring to FIG. 37, electronic form 3700 is shown. Electronic form 3700 is a fans screen associated with a simulation engine for a segment. Electronic form 3700 is displayed when the user selects fans tab 3705.

Electronic form 3700 comprises a tick box 3710 to lockout fan loads. Electronic form 3700 comprises tick boxes 3712 to lockout individual months. This feature can improve the calibration simulation. Locking out the fan energy loads isolates the relatively unpredictable fan energy loads from the remainder of the base load so that calibration of the remainder of the base can focus on those factors that are relatively predictable compared to the fan energy loads. An excerpt of software code that accomplishes the functions of this screen is included in the Computer Program Listing Appendix 9.

Electronic form 3700 comprises different categories of fans which can be selected by ticking supply fans tick box 3721, return fans tick box 3723, condenser fans tick box 3725, make-up fans tick box 3727, and exhaust fans tick box 3729. These types are characterized via auto size tick boxes 3732 horsepower display and edit boxes 3734, fan operational method display and edit boxes 3736, fan cycles tick boxes 3737, fan scheduled tick boxes 3739, make-up fans occupancy tick box 3731 and exhaust fans occupancy tick box 3730. Listing (scheduling) fans by fan category increases the level of detail and can enhance accuracy and precision of the simulations. An excerpt of software code that accomplishes the functions of this screen is included in the Computer Program Listing Appendix 8 and Appendix 10.

An embodiment of the invention can comprise the ability to adjust performance curves of fans monthly. Electronic form 3700 comprises monthly seasonal loading display and edit boxes 3750. This feature increases the level of detail of the fans and can enhance accuracy and precision of the simulations.

An embodiment of the invention can simulate demand ventilation. This feature can represent transient changes in occupant controlled ventilation loads and can enhance accuracy and precision of the simulations. In a preferred embodiment, demand ventilation is simulated by increasing or decreasing existing ventilation by a per occupant percentage or by a preset scaling factor.

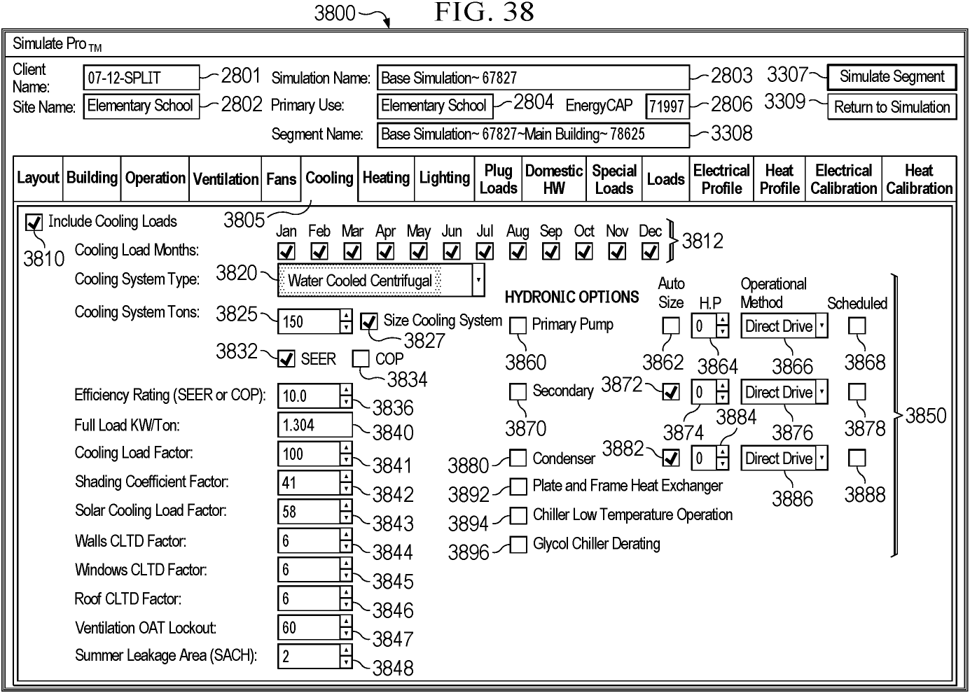

Referring to FIG. 38, electronic form 3800 is shown. Electronic form 3800 is a cooling screen associated with the simulation engine for the segment. Electronic form 3800 is displayed when the user selects cooling tab 3805.

Electronic form 3800 comprises tick box 3810 to lockout cooling and monthly tick boxes 3812 to lockout individual months cooling. Electronic form 3800 comprises cooling system type display and edit box 3820, cooling system tons display and edit box 3825, and size cooling system tick box 3827.

Electronic form 3800 comprises SEER tick box 3832, COP tick box 3834 and efficiency rating display and edit box 3836. Electronic form 3800 comprises full load KW/Ton display and edit box 3840, cooling load factor display and edit box 3841, shading coefficient factor display and edit box 3842, solar cooling load factor display and edit box 3843, walls CLTD factor display and edit box 3844, windows CLTD factor display and edit box 3845, roof CLTD factor display and edit box 3846, ventilation OAT lockout display and edit box 3847, and summer leakage area (SACH) display and edit box 3848.

Electronic form 3800 comprises hydronic options data 3850 to specify additional details of the system. Hydronic options data 3850 comprise tick box 3860 for a primary pump, tick box 3862 to auto size the primary pump, display and edit box 3864 to set horse power of the primary pump, display and edit box 3866 to set operational method of the primary pump, and tick box 3868 to denote that the primary pump is scheduled. An excerpt of software code that accomplishes the functions of this screen is included in the Computer Program Listing Appendix 17.

Hydronic options data 3850 comprise tick box 3870 for a secondary pump, tick box 3872 to auto size the secondary pump, display and edit box 3874 to set horse power of the secondary pump, display and edit box 3876 to set operational method of the secondary pump, and tick box 3878 to denote that the secondary pump is scheduled. Hydronic options data 3850 comprises tick box 3880 for a condenser pump, tick box 3882 to auto size the condenser pump, display and edit box 3884 to set horse power of the condenser pump, display and edit box 3886 to set operational method of the condenser pump, and tick box 3888 to denote that the condenser pump is scheduled. Choosing tick box 3882 to auto size the condenser pump option causes the simulation to approximate condenser pump size based on loads. An excerpt of software code that accomplishes the functions of this screen is included in the Computer Program Listing Appendix 11.

Electronic form 3800 comprises tick box 3892 to denote a plate and frame heat exchanger. This feature enables the inclusion of higher performance heat exchange equipment and can enhance accuracy and precision of the simulations. An excerpt of software code that accomplishes the functions of this screen is included in the Computer Program Listing Appendix 12.

Electronic form 3800 comprises tick box 3894 to denote chiller low temperature operation. Chiller low temperature operation de-rates the performance of the chiller to account for low temperature operation and enhances accuracy and precision of the simulation. An excerpt of software code that accomplishes the functions of this screen is included in the Computer Program Listing Appendix 14.

Electronic form 3800 comprises a tick box 3896 to denote a glycol chiller derating. This feature enables consideration of the derating effect of glycol used as an antifreeze additive. The higher the percent of glycol by weight or volume, the higher the derating of cooling equipment. An excerpt of software code that accomplishes the functions of this screen is included in the Computer Program Listing Appendix 13.

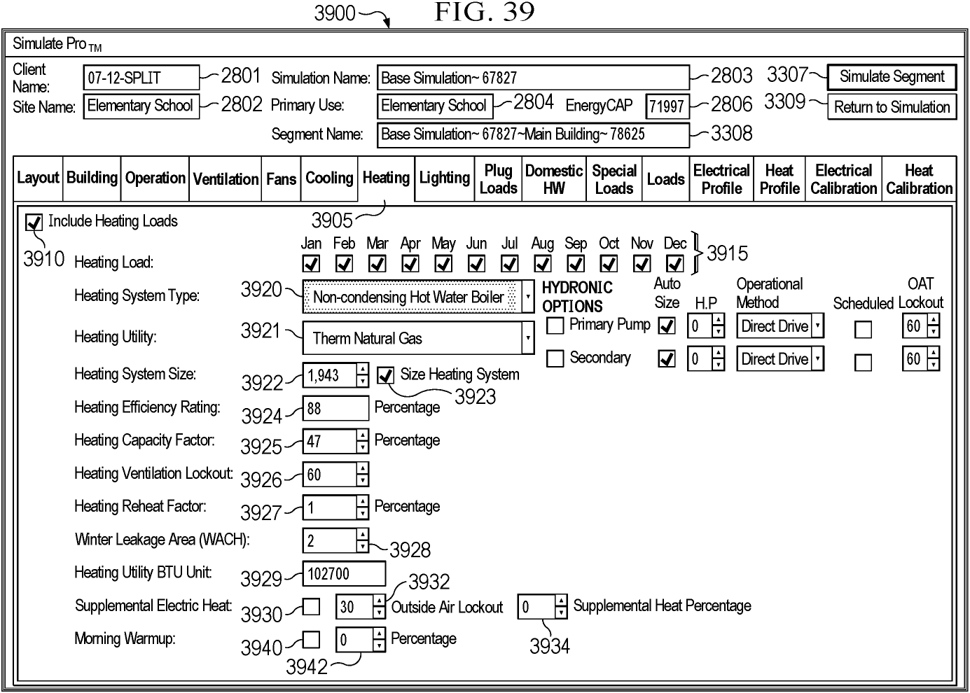

Referring to FIG. 39, electronic form 3900 is shown. Electronic form 3900 is a heating screen associated with the simulation engine for the segment. Electronic form 3900 is displayed when the user selects heating tab 3905.

Electronic form 3900 comprises tick box 3910 to lockout the heating system and monthly heating system lockout tick boxes 3915 to control the lockout monthly. This feature can improve the calibration simulation. Locking out the outside air temperature heating system isolates the relatively unpredictable outside air temperature heating system from the remainder so that calibration of the remainder can focus on those factors that are relatively predictable compared to the outside air temperature heating system.

Electronic form 3900 comprises heating system type display and edit box 3920. Electronic form 3900 comprises heating utility display and edit box 3921. Electronic form 3900 comprises heating system size display and edit box 3922 and tick box 3923 to size heating system. Electronic form 3900 comprises heating efficiency rating display and edit box 3924. Electronic form 3900 comprises heating capacity factor display and edit box 3925. Electronic form 3900 comprises heating ventilation lockout display and edit box 3926. Heating ventilation lockout display and edit box 3926, when clicked simulates a situation where ventilation has been entirely eliminated, for example, by incorrectly blocking heating ducts during winter months. An excerpt of software code that accomplishes the functions of this screen is included in the Computer Program Listing Appendix 15.

Electronic form 3900 comprises heating reheat factor display and edit box 3927. A heating reheat factor allows modeling of electric strip heaters in buildings.

Electronic form 3900 comprises winter leakage area display and edit box 3928. When clicked, the winter leakage area allows adjustment for the amount of heating lost through leakage to account for situations such as older single pane windows or worn weather stripping. Electronic form 3900 comprises heating utility BTU unit display box 3929. The box displays the units to standardize between the base year and the simulation year, such as between natural gas and MCF.

An embodiment of the invention can comprise adding supplemental electric strip heaters to some system types. Electronic form 3900 comprises tick box 3930 for supplemental electric heat. An excerpt of software code that accomplishes the functions of this screen is included in the Computer Program Listing Appendix 16. Electronic form 3900 comprises display and edit box 3932 for outside air lockout. Electronic form 3900 comprises display and edit box 3934 for supplemental heat percentage. This supplemental electric strip heaters feature increases the level of detail that can be specified in the segment. Electronic form 3900 comprises tick box 3940 for morning warmup. Electronic form 3900 comprises display and edit box 3942 for percentage of morning warmup.

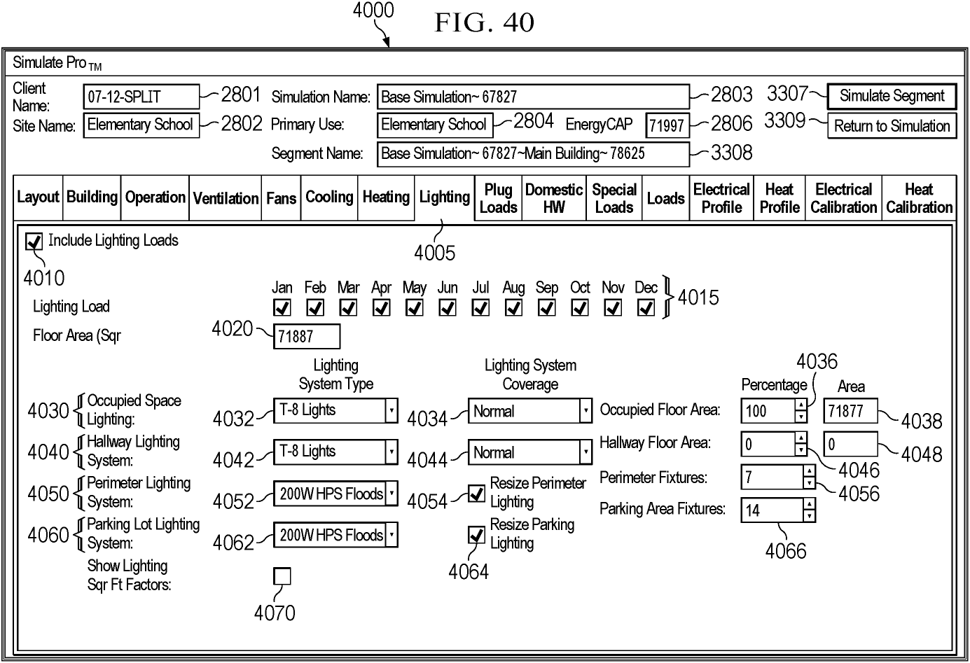

Referring to FIG. 40, electronic form 4000 is shown. Electronic form 4000 is a lighting screen associated with the simulation engine for the segment. Electronic form 4000 is displayed when the user selects lighting tab 4005.

Electronic form 4000 comprises tick box 4010 to lockout the lighting and set of tick boxes 4015 to control the lockout monthly. This lighting lockout feature can improve the calibration simulation. Locking out the lighting isolates the relatively predictable lighting from the remainder so that calibration of the remainder can focus on those factors that are relatively unpredictable compared to the lighting. An excerpt of software code that accomplishes the functions of this screen is included in the Computer Program Listing Appendix 6 and Appendix 18.

Electronic form 4000 comprises display box 4020 reporting floor area of the segment. Electronic form 4000 comprises occupied space lighting data 4030 comprising lighting system type display and edit box 4032, lighting system coverage display and edit box 4034, occupied floor area percentage display and edit box 4036, and occupied floor area display box 4038. Electronic form 4000 comprises hallway lighting system data 4040 comprising lighting system type display and edit box 4042, lighting system coverage display and edit box 4044, hallway floor area percentage display and edit box 4046, and hallway floor area display box 4048. An embodiment of the invention can comprise reducing the lighting square footage by category of lighting systems. This feature increases the level of detail of the lighting and can enhance accuracy and precision of the simulations. An excerpt of software code that accomplishes the functions of this screen is included in the Computer Program Listing Appendix 20.

An embodiment of the invention can enable the user to specify the number of parking lot lights and exterior building lights. This feature increases level of detail of the parking lot light and exterior building lights, and can enhance accuracy and precision of the simulations. Electronic form 4000 comprises perimeter lighting system data 4050 comprising lighting system type display and edit box 4052, resize perimeter lighting tick box 4054, and perimeter fixtures display and edit box 4056. Perimeter lighting systems comprise exterior lighting other than parking lights, such as landscape lights and safety lights. Resizing perimeter lighting tick box 4054 allows the user to set the amount of perimeter lighting. If not chosen, the simulation assumes a reasonable number for perimeter lighting for the building size specified. Electronic form 4000 comprises parking lot lighting system data 4060 comprising lighting system type display and edit box 4062, resize parking lighting tick box 4064, and parking area fixtures display and edit box 4066. Electronic form 4000 includes a tick box 4070 to show light square foot factors. These factors allow further detail in the model to be specified thereby refining the accuracy of the result when the simulation is run.

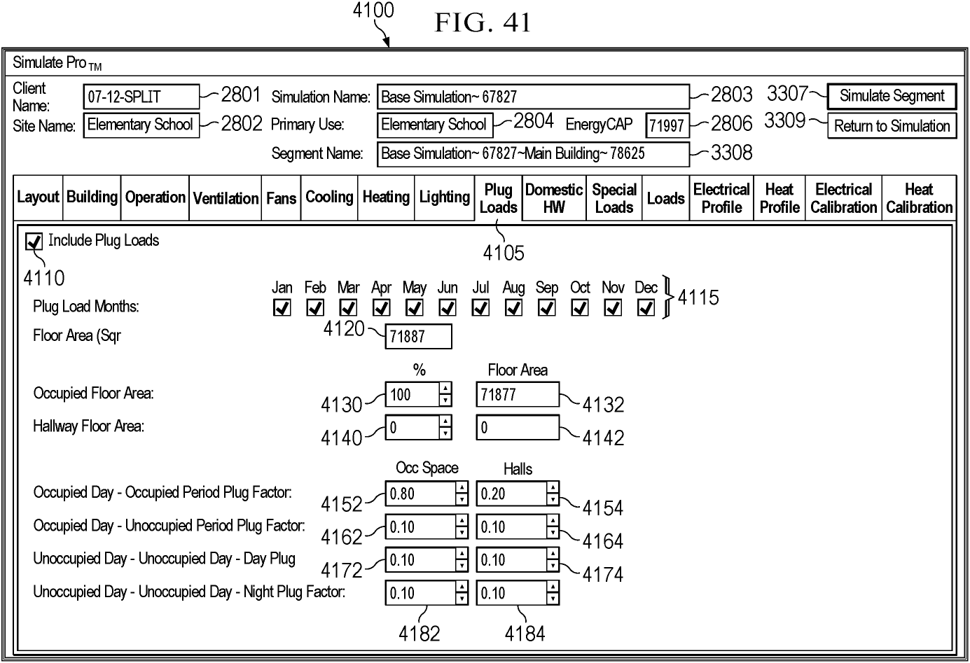

Referring to FIG. 41, electronic form 4100 is shown. Electronic form 4100 is a plug loads screen associated with the simulation engine for the segment. Electronic form 4100 is displayed when the user selects plug loads tab 4105.

Electronic form 4100 comprises tick box 4110 to lockout the plug load and set of tick boxes 4115 to control the lockout monthly. This feature can improve the calibration simulation. Locking out the plug loads isolates the relatively unpredictable plug loads from the remainder of the base load so that calibration of the remainder of the base can focus on those factors that are relatively predictable compared to the plug loads. An excerpt of software code that accomplishes the functions of this screen is included in the Computer Program Listing Appendix 19.

An embodiment of the invention can enable the user to scale the plug load square footage. Electronic form 4100 comprises display box 4120 for floor area. Electronic form 4100 comprises display and edit box 4130 for occupied floor area percent and display box 4132 for floor area square footage. This feature increases level of detail of the plug load by specifying the square footage of space to be serviced by plugs and can enhance accuracy and precision of the simulations.

An embodiment of the invention can calculate a hallway plug load energy separate from the rest of the building. Electronic form 4100 comprises display and edit box 4140 for hallway floor area percent and display box 4142 for hallway floor area square footage. This feature increases level of detail of the plug load by specifying a hallway area and can enhance accuracy and precision of the simulations.

An embodiment of the invention can comprise display and edit box 4152 for occupied day, occupied period plug factor for occupied space, and display and edit box 4154 for occupied day, occupied period plug factor for halls. An embodiment of the invention can comprise display and edit box 4162 for occupied day, unoccupied period plug factor for occupied space, and display and edit box 4164 for occupied day, unoccupied period plug factor for halls. An embodiment of the invention can comprise display and edit box 4172 for unoccupied day, unoccupied day, day plug for occupied space, and display and edit box 4174 for unoccupied day, unoccupied day, day plug for halls. An embodiment of the invention can comprise display and edit box 4182 for unoccupied day, unoccupied day, night plug factor for occupied space, and display and edit box 4184 for unoccupied day, unoccupied day, night plug factor for halls.

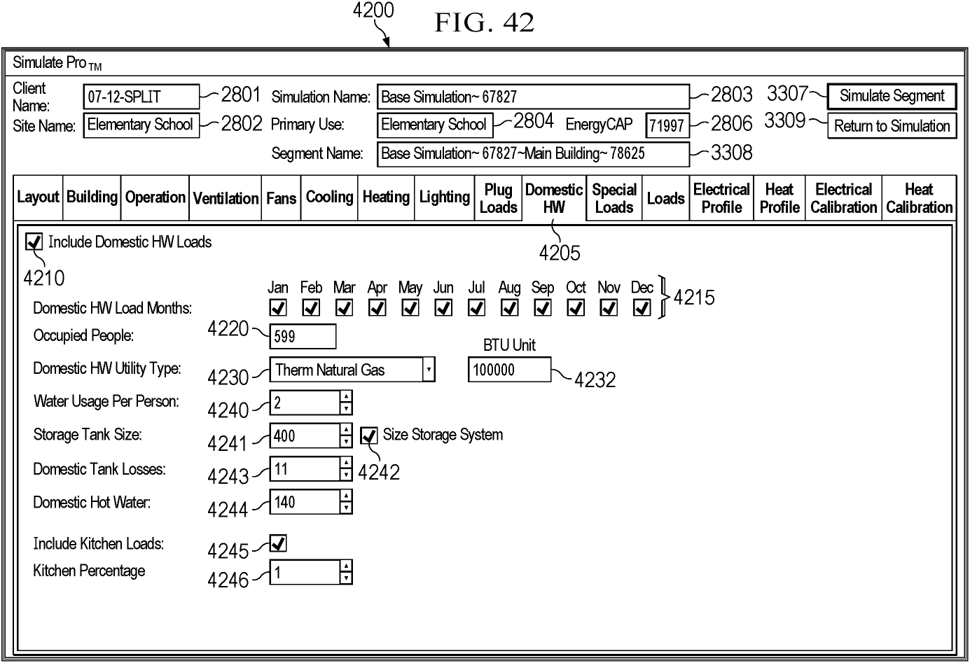

Referring to FIG. 42, electronic form 4200 is shown. Electronic form 4200 is a domestic hot water screen associated with the simulation engine for the segment. Electronic form 4200 is displayed when the user selects domestic hot water tab 4205.

Electronic form 4200 comprises tick box 4210 to lockout the domestic hot water and set of tick boxes 4215 to control this lockout monthly. This feature can improve the calibration simulation. Locking out the domestic hot water energy loads isolates the relatively unpredictable domestic hot water energy loads from the remainder of the base load so that calibration of the remainder of the base can focus on those factors that are relatively predictable compared to the domestic hot water energy loads. An excerpt of software code that accomplishes the functions of this screen is included in the Computer Program Listing Appendix 21.

Electronic form 4200 comprises display and edit box 4220 for number of occupied people. Electronic form 4200 comprises display and edit box 4230 for domestic hot water utility type and display and edit box 4232 for BTU units. Electronic form 4200 comprises display and edit box 4240 for water usage per person, display and edit box 4241 for storage tank size, tick box 4242 to size storage system, display and edit box 4243 for domestic tank losses, and display and edit box 4244 for domestic hot water.

Electronic form 4200 comprises tick box 4245 to include kitchen loads, and display and edit box 4246 for kitchen percentage. This feature can improve the simulations because adjusting the kitchen loads provides more level of detail enabling a more accurate and precise model. For instance, specialized equipment in the kitchen can present loads that are difficult to predict such as sensible and latent heat from a commercial dishwasher.

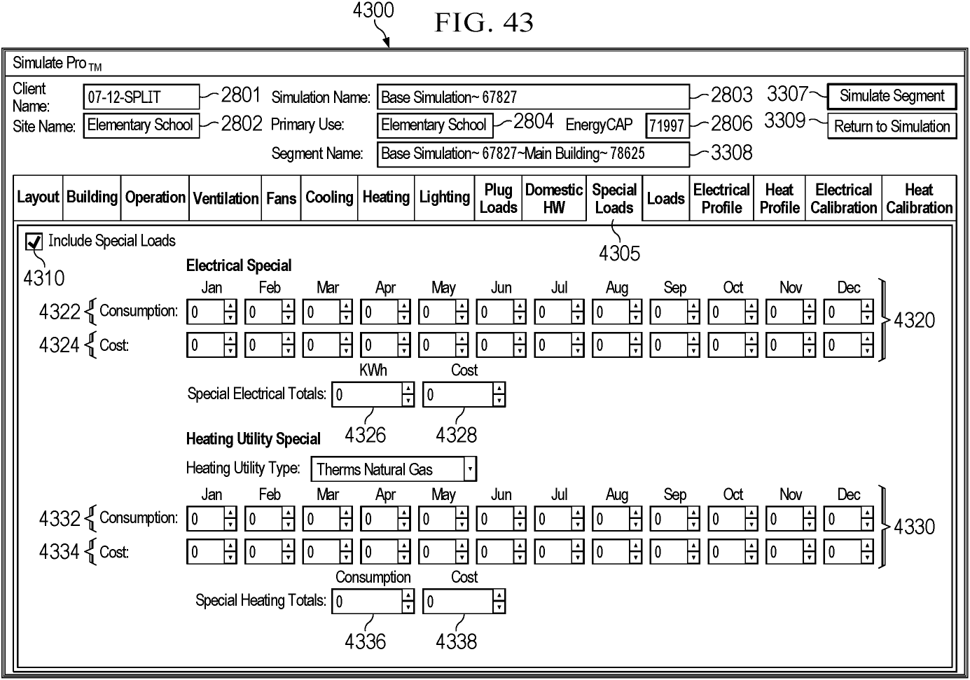

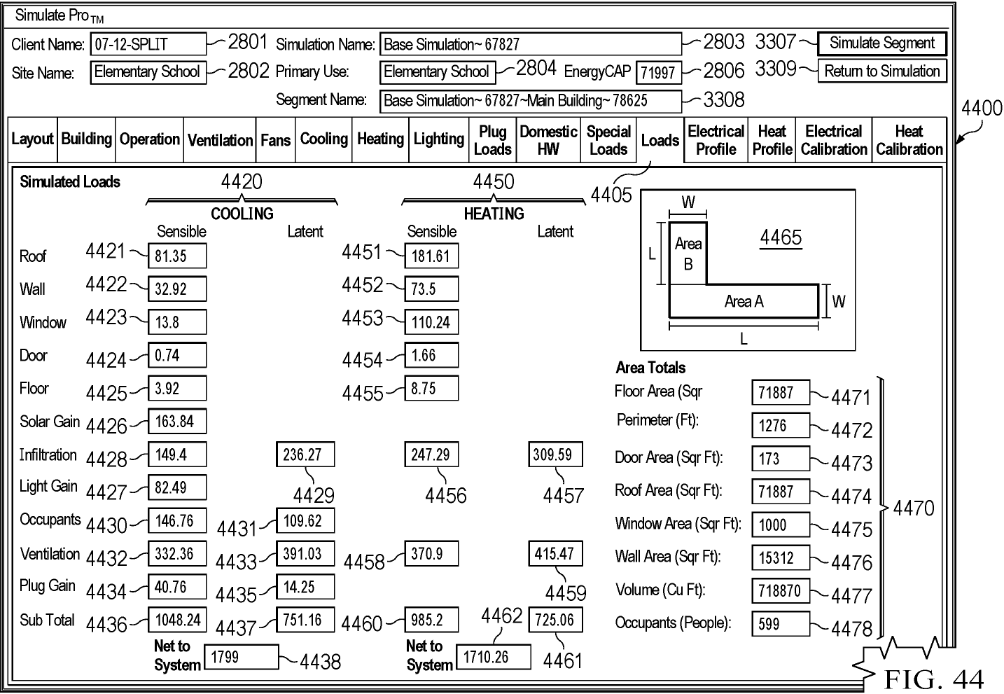

Referring to FIG. 43, electronic form 4300 is shown. Electronic form 4300 is a layout screen associated with the simulation engine for the segment. Electronic form 4300 is displayed when the user selects special loads tab 4305.

Electronic form 4300 comprises tick box 4310 to lockout the special loads. The special loads feature can improve the calibration simulation. Special loads are loads that are not present in every simulation and so sometimes are excluded.

Electronic form 4300 comprises set of display and edit boxes 4320 for electrical special loads, and set of display and edit boxes 4330 for heating utility special loads. Display and edit boxes 4320 comprise set of display and edit boxes 4322 for electrical special load consumption by month, and set of display and edit boxes 4324 for electrical special load cost by month. Display and edit boxes 4320 comprise display and edit box 4326 for special electrical load total KWh, and display and edit box 4328 for special electrical load total cost. Display and edit boxes 4330 comprise display and edit boxes 4332 for heating utility special load consumption by month, and display and edit boxes 4334 for heating utility special load cost by month. Display and edit boxes 4330 comprise display and edit box 4336 for special heating utility load total consumption, and display and edit box 4338 for special heating utility load total cost.

Referring to FIG. 44, electronic form 4400 is shown. Electronic form 4400 is a loads and sizing screen associated with the simulation engine for the segment. Electronic form 4400 is displayed when the user selects loads tab 4405.

Electronic form 4400 comprises set of display and edit boxes 4420 showing simulated loads for cooling both sensible and latent components, and set of display and edit boxes 4450 showing simulated loads for heating both sensible and latent components. These loads are calculated and displayed by electronic form 4400.

Electronic form 4400 comprises display box 4421 for the sensible cooling load of the roof, display box 4422 for the sensible cooling load of the walls, display box 4423 for the sensible cooling load of the windows, display box 4424 for the sensible cooling load of the doors, display box 4425 for the sensible cooling load of the floor, display box 4426 for the sensible cooling load for solar gain, and display box 4427 for the sensible cooling load for light gain (lighting). Electronic form 4400 comprises display box 4428 for the sensible cooling load of infiltration, and display box 4429 for the latent cooling load of infiltration. Electronic form 4400 comprises display box 4430 for the sensible cooling load of the occupants, and display box 4431 for the latent cooling load of the occupants. Electronic form 4400 comprises display box 4432 for the sensible cooling load of the ventilation, and display box 4433 for the latent cooling load of the ventilation. Electronic form 4400 comprises display box 4434 for the sensible cooling load of the plug gain and a display, and display box 4435 for the latent cooling load of the plug gain. Electronic form 4400 comprises display box 4436 for the sensible cooling load of the total, and display box 4437 for the latent cooling load of the total. Electronic form 4400 comprises display box 4438 for the net to system cooling load.

Electronic form 4400 comprises display box 4451 for the sensible heating load of the roof, display box 4452 for the sensible heating load of the walls, display box 4453 for the sensible heating load of the windows, display box 4454 for the sensible heating load of the doors, and display box 4455 for the sensible heating load of the floor. Electronic form 4400 comprises display box 4456 for the sensible heating load of infiltration, and display box 4457 for the latent heating load of infiltration. Electronic form 4400 comprises display box 4458 for the sensible heating load of ventilation, and display box 4459 for the latent heating load of ventilation. Electronic form 4400 comprises display box 4460 for the sensible subtotal heating load, and display box 4461 for the latent subtotal heating load. Electronic form 4400 comprises display box 4462 for the net to system heating load.

Electronic form 4400 comprises schematic display 4465 of a building shape associated with the segment. Electronic form 4400 comprises set of display boxes 4470 for area totals. Set of display boxes 4470 comprises display box 4471 for floor area, display box 4472 for perimeter, display box 4473 for door area, display box 4474 for roof area, display box 4475 for window area, display box 4476 for wall area, display box 4477 for volume, and display box 4478 for occupants.

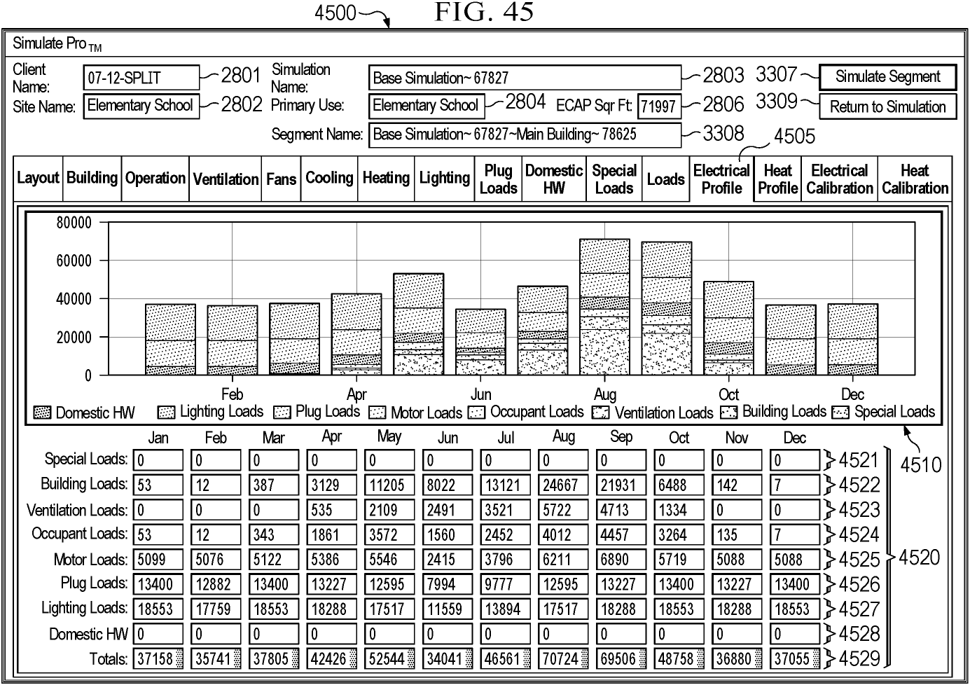

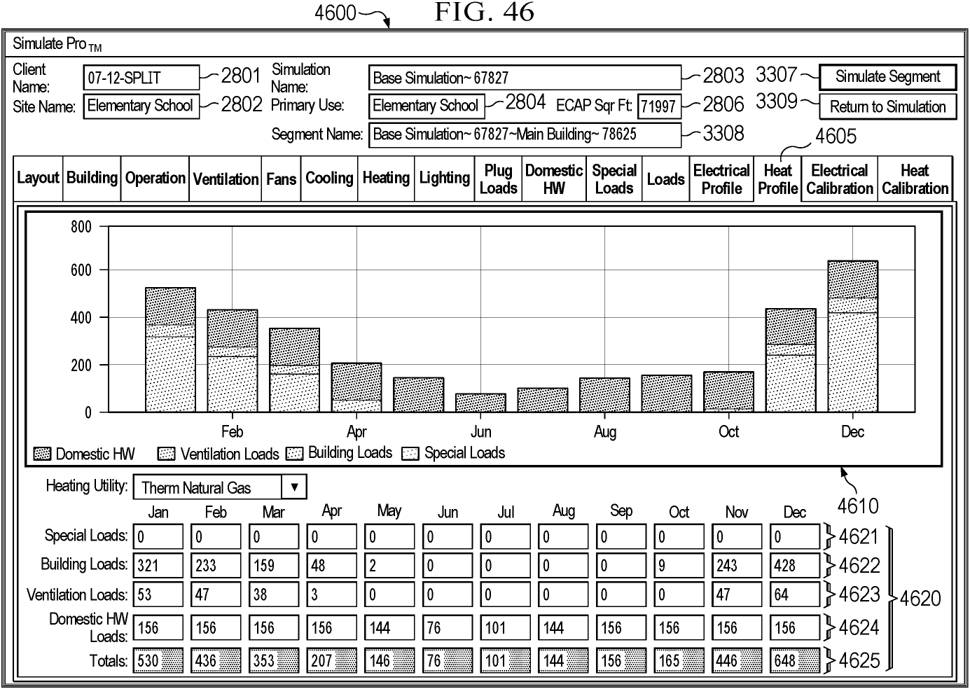

Referring to FIG. 45, electronic form 4500 is shown. Electronic form 4500 is a simulated electrical consumption profile screen associated with the simulation engine for the segment. Electronic form 4500 is displayed when the user selects electrical profile tab 4505. Electronic form 4500 comprises bar chart 4510 illustrating simulated electrical consumption by month with color coded segments where each segment corresponds to a particular load type.

Electronic form 4500 comprises numerical data arranged in set of display boxes 4520 corresponding to the bar chart segments. Set of display boxes 4520 comprises set of display boxes 4521 for special loads, set of display boxes 4522 for building loads, set of display boxes 4523 for ventilation loads, set of display boxes 4524 for occupant loads, set of display boxes 4526 for motor loads, set of display boxes 4526 for plug loads, set of display boxes 4527 for lighting loads, set of display boxes 4528 for domestic hot water load, and set of display boxes 4529 for monthly totals.

Referring to FIG. 46, electronic form 4600 is shown. Electronic form 4600 is a simulated heating utility consumption profile screen associated with the simulation engine for the segment. Electronic form 4600 is displayed when the user selects heat profile tab 4605. Electronic form 4600 comprises bar chart 4610 illustrating simulated heating utility consumption by month with color coded segments where each segment corresponds to a particular load type.

Electronic form 4600 comprises numerical data presented in set of display boxes 4620 corresponding to the bar graph segments. Set of display boxes 4620 comprises set of display boxes 4621 for special loads, set of display boxes 4622 for building loads, set of display boxes 4623 for ventilation loads, set of display boxes 4624 for domestic hot water load, and set of display boxes 4625 for monthly totals.

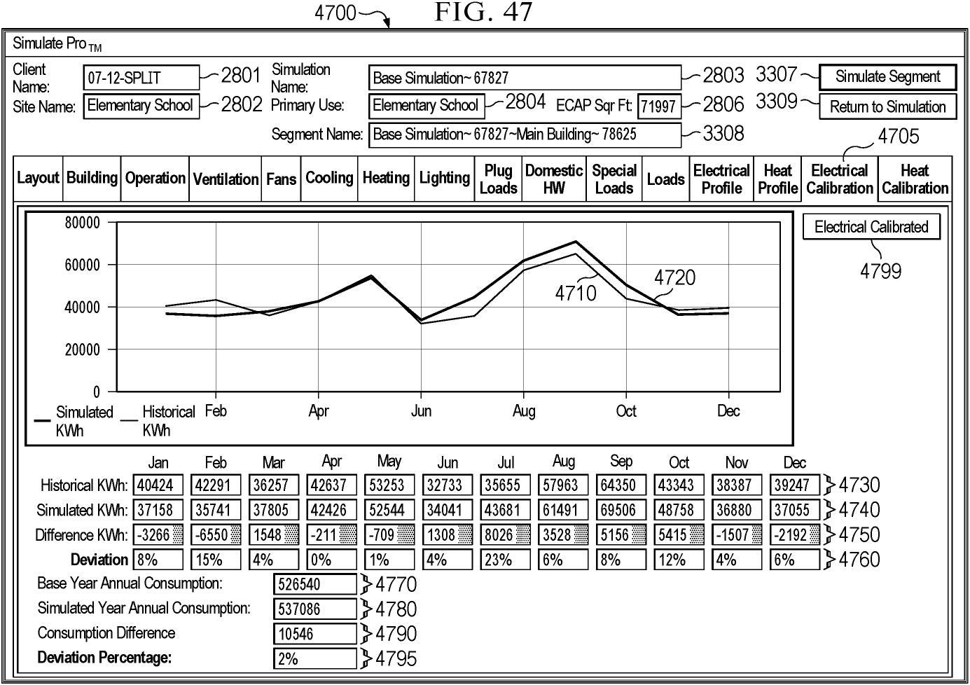

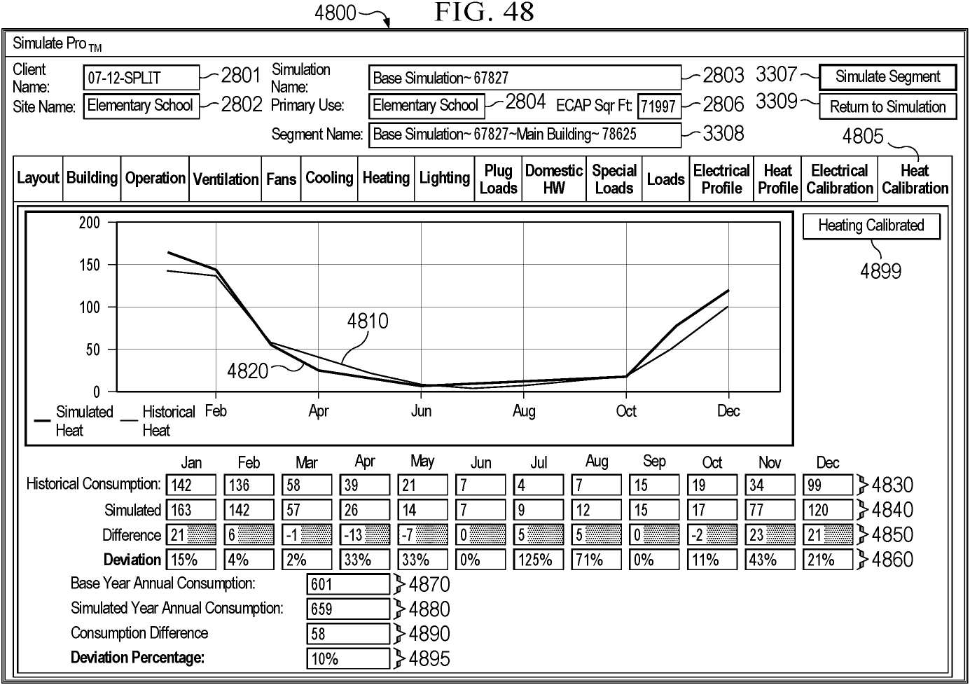

Referring to FIGS. 47 and 48, the invention can grant authority to an administrator level user to force a simulations calibration. In this embodiment, the administrator level’s ability to force a simulation calibration is in contrast to all other, lower levels. For example, if the administrator level is rank level 5, then other users up to and comprising level 4 would be required to calibrate the base simulation to the selected standard before they can create an adjustment export file.

Referring to FIG. 47, electronic form 4700 is shown. Electronic form 4700 is an electrical calibration screen associated with the simulation engine for the segment. Electronic form 4700 is displayed with the user selects electrical calibration tab 4705.

Electronic form 4700 comprises monthly electrical historical consumption trace 4710, and monthly electrical baseline simulated trace 4720. Electronic form 4700 comprises set of display boxes 4730 for monthly electrical historical consumption, and set of display boxes 4740 for monthly electrical baseline simulation. Electronic form 4700 comprises set of display boxes 4750 for calculated monthly differences, and set of display boxes 4760 for monthly percent deviation. Electronic form 4700 comprises display box 4770 for base year annual consumption, and display box 4780 for simulated year annual consumption. Electronic form 4700 comprises display box 4790 for calculated difference, and display box 4795 for percent deviation. In an embodiment based on annual analysis, when the percent deviation is less than a threshold, then the electrical baseline simulation is determined to be calibrated as displayed by electrical calibrated indicator 4799.

Referring to FIG. 48, electronic form 4800 is shown. Electronic form 4800 is a heating utility calibration screen associated with the simulation engine for the segment. Electronic form 4800 is displayed with the user selects heat calibration tab 4805.

Electronic form 4800 comprises monthly heating utility historical consumption trace 4810, and monthly heating utility baseline simulated trace 4820. Electronic form 4800 comprises set of display boxes 4830 for monthly heating utility historical consumption, and set of display boxes 4840 for monthly heating utility baseline simulation. Electronic form 4800 comprises set of display boxes 4850 for calculated monthly differences, and set of display boxes 4860 for monthly percent deviation. Electronic form 4800 comprises display box 4870 for base year annual consumption, and display box 4880 for simulated year annual consumption. Electronic form 4800 comprises display box 4890 for calculated consumption difference, and display box 4895 for percent deviation. In an embodiment based on annual analysis, when the percent deviation is less than a threshold, then the heating utility baseline simulation is determined to be calibrated as displayed by heating utility calibrated indicator 4899.

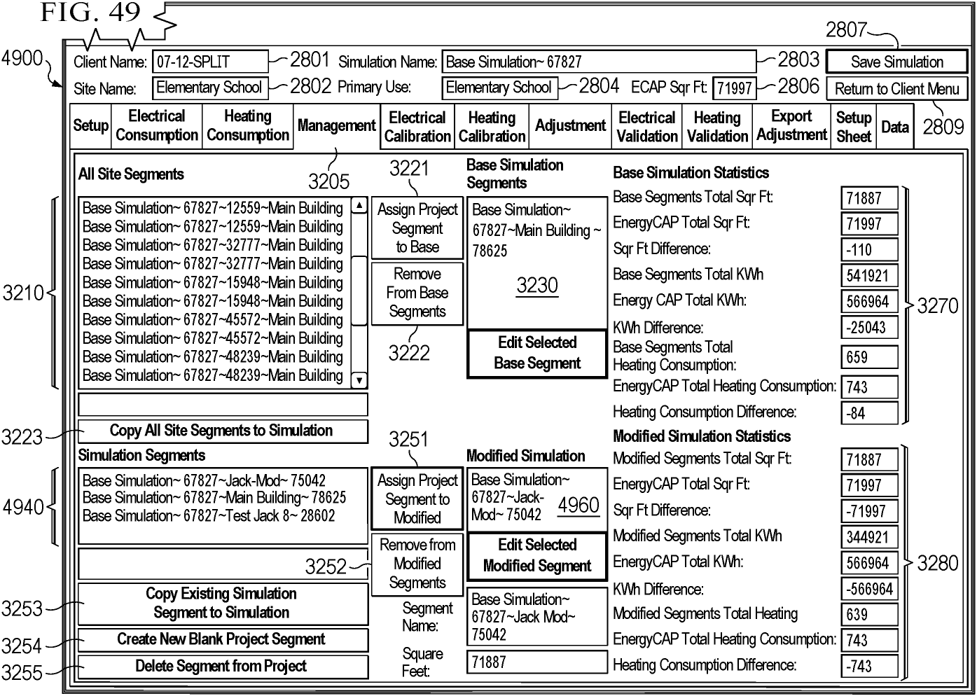

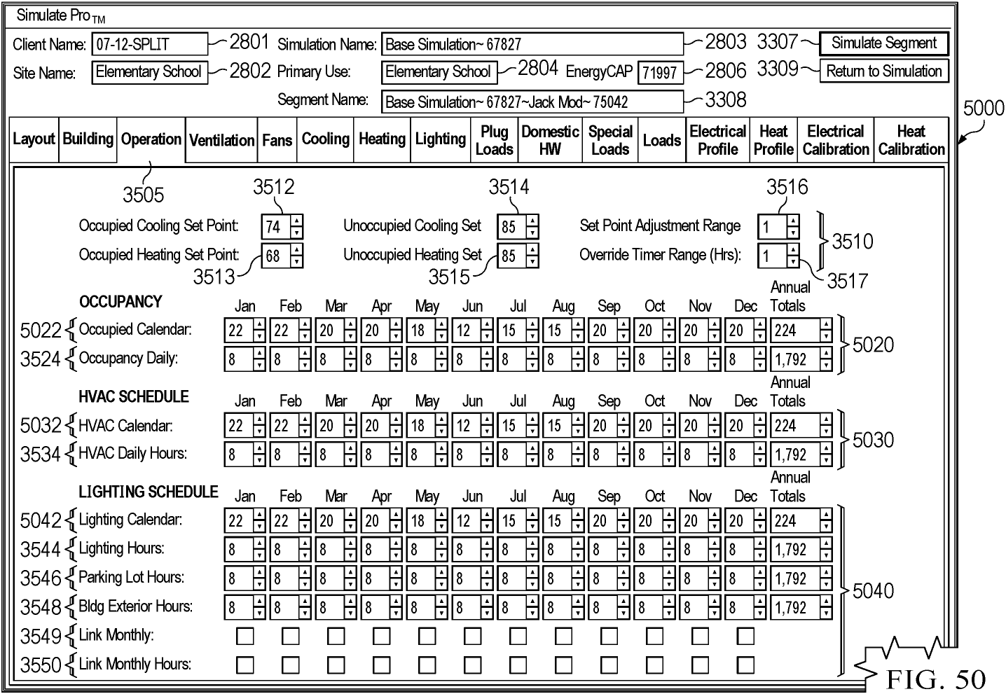

Referring to FIG. 49, electronic form 4900 is shown. Electronic form 4900 is an assign, remove and create segments screen. Electronic form 4900 is displayed when the user selects management tab 3205 in context.

Electronic form 4900 comprises all site segments list 3210. Electronic form 4900 comprises assign project segment to base button 3221, remove from base segments button 3222, and copy all site segments to simulation button 3223. These buttons enable the user to determine which segments appear in base simulation segments list 3230. Electronic form 4900 comprises simulation segments list 4940. Electronic form 4900 comprises assign project segment to modified button 3251, remove from modified segments button 3252, copy existing simulation segment to simulation button 3253, create new blank project segment button 3254, and delete segment from project button 3255. These buttons enable the user to determine which segments appear in modified segments list 4960. Electronic form 4900 comprises set of display boxes 3270 showing simulation statistics and set of display boxes 3280 showing modified simulation statistics. The simulation statistics refer to hypothetical uses of energy as calculated by the simulation. The modified simulation statistics show the hypothetical uses of energy as calculated by the modified simulation. The two sets of statistics are presented side-by-side for easy visual comparison. Importantly, the statistics presented result only from the listed segments shown in boxes base simulation segments list 3230 and modified segments list 4960.

Electronic form 4900 indicates that “Base Simulation~ 67828~Main Building ~ 78625” in base simulation segments list 3230 has been copied as “BaseSimulation~ 67827~Jack Mod~ 75042” and saved to simulation segments list 4940 and then assigned modified segments list 4960. This copied and assigned segment will be modified as described below.

Referring to FIG. 50, electronic form 5000 is shown. Electronic form 5000 is a schedule and internal temperatures screen associated with the simulation engine for the segment. Electronic form 5000 is displayed when the user selects operation tab 3505 in context.

Electronic form 5000 comprises temperature set points display and edit boxes 3510, occupancy schedule display and edit boxes 5020, HVAC schedule display and edit boxes 5030, and lighting schedule display and edit boxes 5040. Temperature set points display and edit boxes 3510 comprise occupied cooling set point box 3512, occupied heating set point box 3513, unoccupied cooling set point box 3514, unoccupied heating set point box 3515, set point adjustment range box 3516, and override timer range (hours) box 3517. Occupancy schedule display and edit boxes 5020 comprise monthly occupied calendar days boxes 5022 and monthly occupancy daily hours boxes 3524. HVAC schedule display and edit boxes 5030 comprise monthly HVAC calendar days boxes 5032 and monthly HVAC daily hours boxes 3534. Lighting schedule display and edit boxes 5040 comprise monthly lighting calendar days boxes 5042, monthly lighting hours per day boxes 3544, monthly parking lot hours per day boxes 3546, and monthly building exterior hours per day boxes 3548.

Lighting schedule display and edit boxes 5040 comprise link monthly tick boxes 3549. Lighting schedule display and edit boxes 5040 comprise link monthly hours tick boxes 3550.

Electronic form 5000 is similar to electronic form 3500. The difference between electronic form 5000 and electronic form 3500 is that monthly occupied calendar days boxes 5022, monthly HVAC schedule calendar days boxes 5032, and monthly lighting calendar days boxes 5042 all have more active, scheduled days because of the modification (adjustment) to the segment.

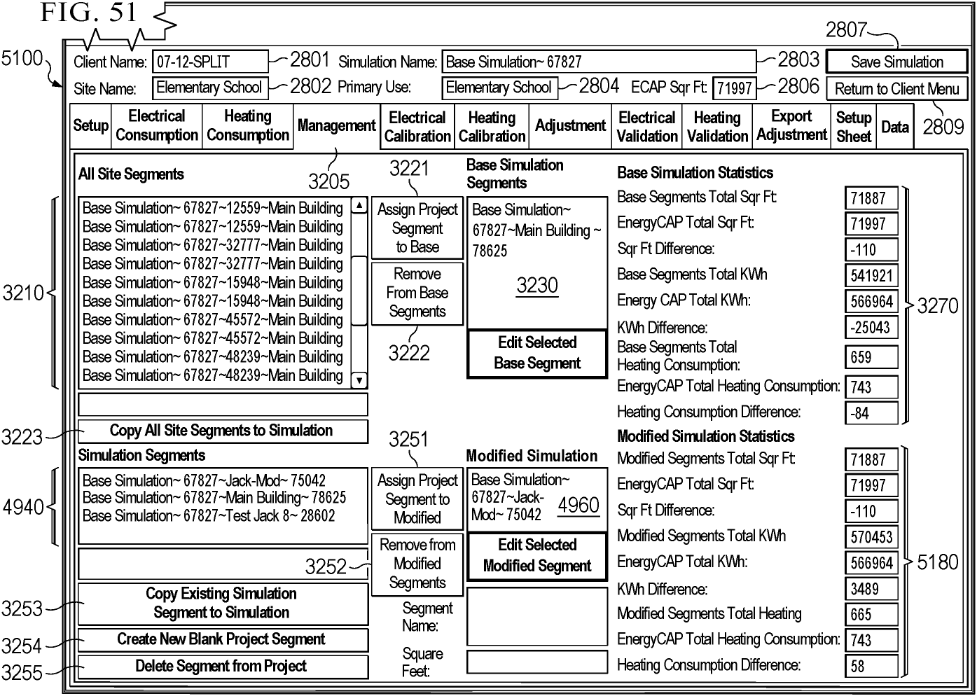

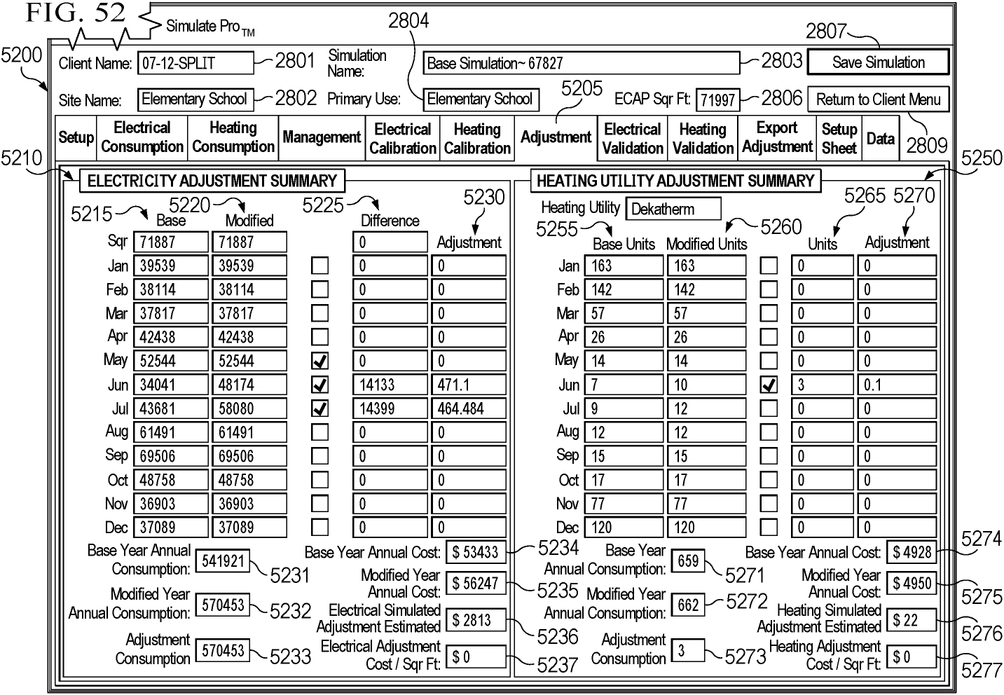

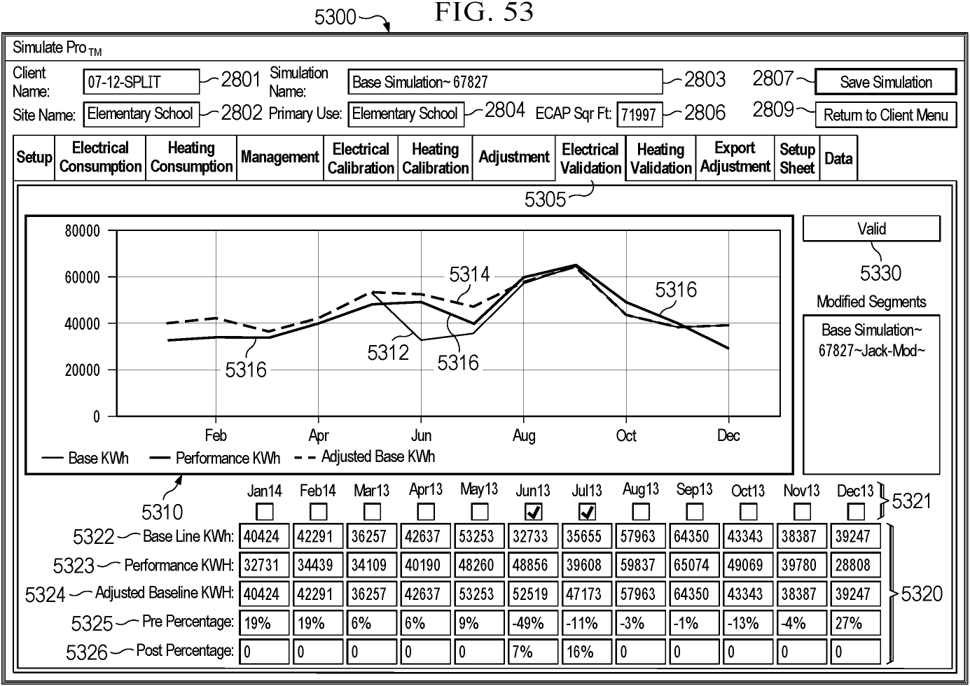

Referring to FIG. 51, electronic form 5100 is shown. Electronic form 5100 is an assign, remove and set-up segments screen associated with a simulation. Electronic form 5100 is displayed when the user selects management tab 3205 in context.

Electronic form 5100 comprises all site segments list 3210. Electronic form 5100 comprises assign project segment to base button 3221, remove from base segments button 3222, and copy all site segments to simulation button 3223. These buttons allow the user to determine which segments appear in base simulation segments list 3230. Electronic form 5100 comprises simulation segments list 4940. Electronic form 5100 comprises assign project segment to modified button 3251, remove from modified segments button 3252, copy existing simulation segment to simulation button 3253, create new blank project segment button 3254, and delete segment from project button 3255 that allow the user to determine which segments appear in simulation segments list 4940 and modified segments list 4960. Electronic form 5100 comprises display boxes 3270 showing base simulation statistics and display boxes 5180 showing modified simulation statistics.

Electronic form 5100 is similar to electronic form 4900. The difference between electronic form 5100 and electronic form 4900 is that the display boxes 5180 for the modified simulation statistics are different because of additional scheduled days in the modified (adjusted) segment.

Referring to FIG. 52, electronic form 5200 is shown. Electronic form 5200 is an adjustment summary screen associated with an adjusted baseline simulation. Electronic form 5200 is displayed when the user selects adjustment tab 5205. Electronic form 5200 comprises electricity adjustment summary 5210 and heating utility adjustment summary 5250.

Electricity adjustment summary 5210 comprises display boxes 5215 for monthly base electricity consumption, display boxes 5220 for monthly modified electricity consumption, display boxes 5225 for monthly difference in electricity consumption, and display boxes 5230 for monthly adjustment in costs. Electricity adjustment summary 5210 comprises display box 5231 for base year annual consumption, display box 5232 for modified year annual consumption, display box 5233 for adjustment consumption, display box 5234 for base year annual cost, display box 5235 for modified year annual cost, display box 5236 for electrical simulated adjustment estimated, and display box 5237 for electrical adjustment cost/square foot.

Heating utility adjustment summary 5250 comprises display boxes 5255 for monthly base units, display boxes 5260 for monthly modified units, display boxes 5265 for monthly difference in units, and display boxes 5270 for monthly adjustment in costs. Heating utility adjustment summary 5250 comprises display box 5271 for base year annual consumption, display box 5272 for modified year annual consumption, display box 5273 for adjustment consumption, display box 5274 for base year annual cost, display box 5275 for modified year annual cost, display box 5276 for heating simulated adjustment estimated, and display box 5277 for heating adjustment cost/square foot. Electronic form 5200 allows the user to validate that the difference between the calibrated base simulation and the adjusted base simulation is reasonable by looking at the financial impact of the difference. Display boxes 5225 and 5265 show changes in kWh and BTUs consumed according to the simulations, respectively. Display boxes 5230 and 5270 show changes in costs according to the simulations.

Referring to FIG. 53, electronic form 5300 is shown. Electronic form 5300 is an adjustment analysis screen associated with an adjusted simulation. Electronic form 5300 is displayed when the user selects electrical validation tab 5305.

Electronic form 5300 comprises graphical representation 5310 of actual consumption, a calibrated simulation and an adjusted simulation. Electronic form 5300 comprises set of display boxes 5320 for monthly data corresponding to the metered consumption for the current year, a calibrated simulation for the base year and an adjusted simulation for the base year, together with pre and post percentages. Electronic form 5300 comprises validity indicator 5330 to summarize analysis of the difference between the adjusted simulation for the current year and the modified simulation for the base year.

Graphical representation 5310 includes 3 traces. Trace 5312 represents the calibrated simulation for the base year. Trace 5316 represents the metered consumption for the current year. Trace 5314 represents the adjusted simulation of the base year which has been modified to account for an aberration period. An aberration period is any period in which an unexpected energy usage event occurs during the current year, but that did not occur in the base year. In this case, the aberration period is June and July.

An unexpected energy usage event can include any event, over any period of time, that occurred in the current year, but did not occur in the base year. Non-exhaustive examples include the addition, deletion and modification of equipment, the addition, deletion or modification of buildings and building segments, the addition, deletion and modification of occupancy.

As a practical example, operation of a summer school session in the current year during the months of June - July, when such a session was not held during the base year, comprises an energy usage event that occurs in an aberration period. In order to report an accurate savings in the current year, the baseline simulation for the base year must be adjusted to account for the added energy usage during the summer. Once adjusted, the metered consumption for the current year can be compared to the adjusted simulation of the base year to report an accurate energy usage difference.

Referring again to FIG. 53, at the June demarcation, trace 5312 represents calibrated simulation for the base year. Trace 5314 represents that same calibrated simulation but which has been adjusted to account for the summer school session, thereby indicating greater energy usage. To arrive at trace 5314, the parameters used in the simulation model are changed to reflect the aberration. For example, “unoccupied days” during the months of June and July are change to “occupied days”. Since the adjusted simulation trace accounts for the additional energy usage during the summer, it now can be seen to be above the baseline simulation trace between approximately May and August.

The adjusted baseline simulation for the base year is then compared to the metered consumption on a month-by-month basis for the current year to determine whether or not the adjusted baseline simulation is within a predetermined tolerance as indicated by validity indicator 5330. If so, then the adjusted baseline simulation is deemed valid.

Tick boxes 5321 to indicate months in which modifications occur. Display boxes 5322 indicate baseline kWh. Display boxes 5323 indicate metered performance kWh. Display boxes 5324 indicate adjusted baseline kWh. Display boxes 5325 indicate pre-percentage difference. A pre-percentage difference is the actual metered consumption for the base year as compared to the actual metered consumption for the current year. Display boxes 5326 indicate post percentage differences. A post percentage difference is the actual metered consumption for the base year, plus the adjusted consumption, as compared to the actual metered consumption for the current year. The pre-percentage differences in display boxes 5325 are the monthly differences between trace 5316 for metered consumption and trace 5312 for the calibrated simulation for the base year. Display boxes 5326 post percentage difference are the monthly differences between trace 5316 and trace 5314, but only during those months where there is a difference between trace 5312 and trace 5314.

Validity indicator 5330 is showing a result of valid based on analysis of the percentage differences between the adjusted simulation and metered consumption. The threshold is set in adjustment validity box 2929. The analysis can be implemented on a monthly basis or an annual basis. For example, if in each month the greater of the pre and post percentages is less than a threshold tolerance, then the modified simulation is deemed valid.

An embodiment of the invention can set an adjustment validation percentage. This sets a threshold of deviation between the data from the event that is being adjusted and the adjusted baseline that has the adjustment applied. For example, the variable validate percentage can be annual. In this example, if the absolute annual difference is less than the annual adjustment validation percentage, then the adjustment simulation is deemed valid. If the absolute annual difference is greater than the annual adjustment validation percentage, then the adjustment simulation is deemed not valid. In another example, the variable validate percentage can be monthly. In this example, if all of the absolute monthly differences are less than the adjustment validation percentage, then the adjustment simulation is deemed valid. If even one of the absolute monthly differences is greater than the adjustment validation percentage, then the adjustment simulation is deemed not valid. In another example, there can be both an annual threshold of deviation and a monthly threshold of deviation. The absolute annual difference and the absolute monthly difference would need to be less than their respective thresholds for the adjustment simulation to be deemed valid. In another example, a small deviation (approximately 1-10%) above the threshold can be tolerated in one or more months without invalidating the simulation.

An embodiment of the invention can have an adjustment export screen that creates an export file for an adjusted simulation that can be exported and then directly imported into EnergyCAP. This embodiment makes it efficient to send adjustment results to others for viewing with EnergyCAP.

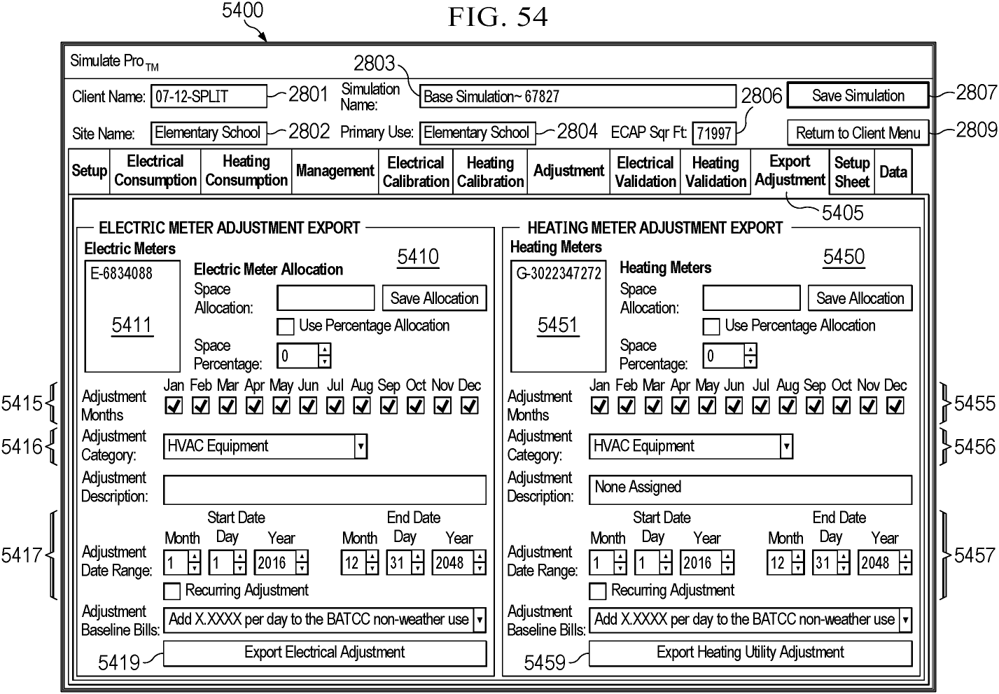

Referring to FIG. 54, electronic form 5400 is shown. Electronic form 5400 is an export file creation screen associated with a simulation. Electronic form 5400 is displayed when the user selects export adjustment tab 5405.

Electronic form 5400 comprises electrical meter adjustment export information 5410 and heating meter adjustment export information 5450.

Electrical meter adjustment export information 5410 comprises display box 5411 for identification of electric meters, and set of tick boxes 5415 to indicate adjustment months. Electrical meter adjustment export information 5410 also comprises display and edit box 5416 to indicate adjustment category, display and edit boxes 5417 for an adjustment date range, and export electrical adjustment button 5419.

Heating meter adjustment export information 5450 comprises display box 5451 for identification of heating utility meters, and set of tick boxes 5455 to indicate adjustment months. Heating meter adjustment export information 5450 also comprises display and edit box 5456 to indicate adjustment category, display and edit boxes 5457 for an adjustment date range, and export heating utility adjustment button 5459.

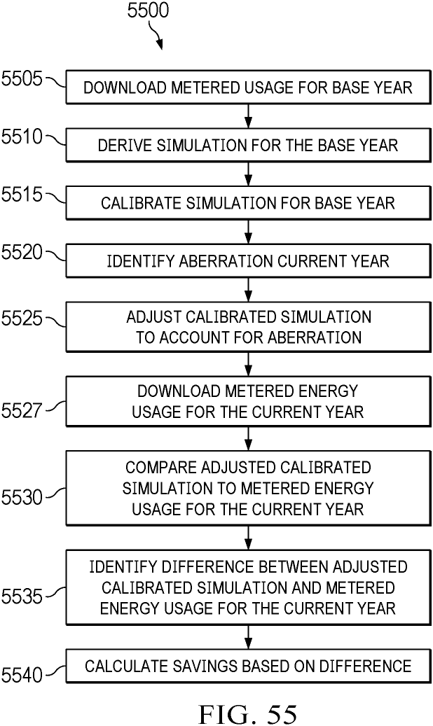

Referring to FIG. 55, a preferred embodiment of a method 5500 of calibrated adjusting a simulation to account for an aberration will be described.

At step 5505, actual metered usage data is downloaded for the base year. In other embodiments, the base year may be a different period of time, such as a single month or any period of months, or any period of years. In a preferred embodiment, the metered usage data is received directly from the EnergyCAP software and reflects, for example, direct download of usage data from the meter from ERCOT.

At step 5510, a simulation is derived corresponding to the base year. As previously described, the baseline simulation results from a model of the weather, equipment, buildings, and usage and occupancy schedule, among other things, for the facility.

At step 5515, the baseline simulation is calibrated for the base year, resulting in a calibrated baseline simulation, as previously described.

At step 5520, an aberration is identified in the current year. As previously described, the aberration can include changes in scheduling, occupancy, the addition or deletion of equipment or other factors that occurred in the current year which did not occur in the base year.

At step 5525, the calibrated simulation is adjusted to account for the aberration. To adjust the calibrated simulation, the model that produces the simulation is modified to match the circumstances which resulted in the aberration. For example, if the aberration consisted of adding additional occupied days, then the model is adjusted by changing the unoccupied days to occupied days for that period of time. Similarly, if equipment is added, then the model is changed to account for the addition of the equipment, resulting in a different energy usage for the aberration period.

At step 5527, metered energy usage is downloaded for the current year.

At step 5530, the adjusted calibrated simulation for the base year is compared to metered energy usage for the current year.

At step 5535, a difference is identified between the adjusted calibrated simulation and the metered energy usage for the current year.

At step 5540, a savings amount for energy usage is calculated based on the difference between the adjusted calibrated simulation and the metered energy usage for the current year. In a preferred embodiment, savings amount is calculated by subtracting the area under the metered consumption for the current year trace from the adjusted baseline trace.

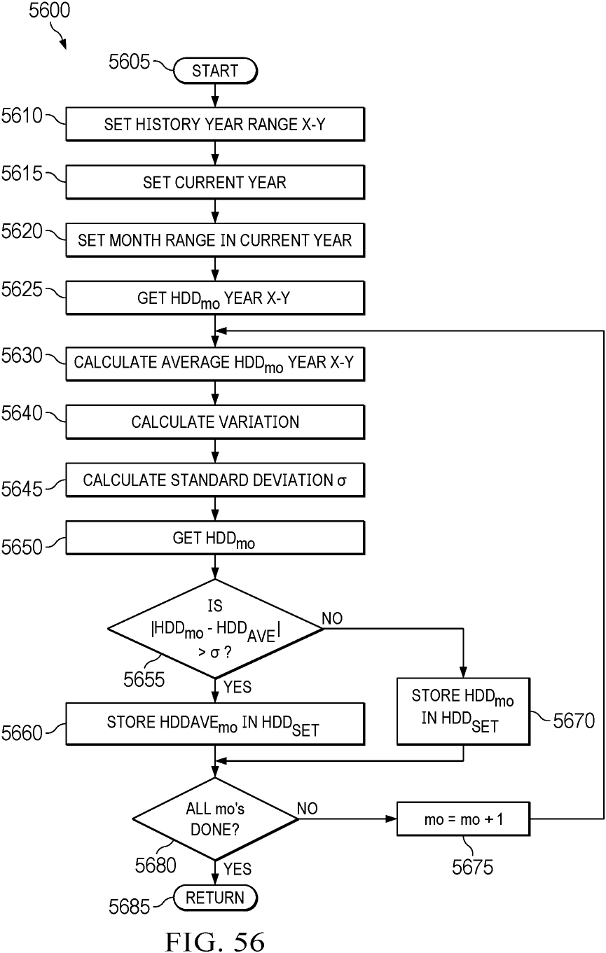

Referring then to FIG. 56, a method of loading a set of monthly heating degree days, as described at step 642, will be further described.

In general, method 5600 derives an average set of heating degree days for each month based on an average of the heating degree days from a historical period. The heating degree days for each month are averaged, year over year, from the set of historical data. In a preferred environment, the historical data is downloaded from Weather Stack, Inc. of Vienna, Austria. In this way, if the heating degree day for any month in the weather model for the current year is an aberration of more than one standard deviation, σ, from the average, it is replaced by the average value in order to make the weather model subject to fewer aberrations and therefore, more accurate.

At step 5605, method 5600 begins.

At step 5610, a history year range, X to Y, is set. For example, a historical year range between the year 2000 and the year 2021.

At step 5615, the current year is identified, for example, the current year may be 2022.

At step 5620, a month range is set for the current year, for example, January through December.

At step 5625, the heating degree data for the first month in the month range is uploaded for each year in the history year range and stored in memory.

At step 5630, the average heating degree day value for the first month of each year in the year range is determined, according to the following equation.

$$A V E H D {D}_{M O} = \frac{{\sum }_{x}^{y} H D {D}_{M O}}{\left(y - x\right)}$$

Where:
HDD_{MO} = heating degree days for specified month “MO”;
x = beginning year in year range; and
y = ending year in year range.

At step 5640, variation, σ², is calculated by summing the deviations in the number of heating degree days for the specified month in the year range, and dividing by the number of years in the year range, according to the following equation.

$$\left(V A R H D D\right) {σ}^{2} = \frac{{\sum }_{x}^{y} {\left(H D {D}_{M O} - A V E H D D\right)}^{2}}{\left(y - x\right)}$$

Where:
HDD_{MO} = heating degree days for specified month “MO”;
AVEHDD_{MO} = average heating degree days for specified month “MO”;
x = beginning year in year range; and
y = ending year in year range.

At step 5645, the standard deviation is calculated according to the following equation.

$$σ = \sqrt{{σ}^{2}}$$

At step 5650, the current heating degree days for the specified month “MO” is retrieved from memory.

At step 5655, the absolute value of the difference between the number of heating degree days for the specified month and average number of heating degree days is compared to the standard deviation. If the absolute value is greater than the standard deviation, the method moves to step 5660. If the absolute value is less than the standard deviation, the method moves to step 5660.

At step 5660, the method stores, the heating degree day average for the specified month in the HDD set in memory.

At step 5670, the method stores, the number of heating degree days for the specified month in the heating degree day set.

At step 5680, a determination is made as to whether or not all months in the month range have been examined. If so, the method moves to step 5685. If not, the method moves to step 5675.

At step 5675, the method advances to the next month in the month range and returns to step 5630.

At step 5685, the method returns the heating degree day set as the set of monthly heating degree days.

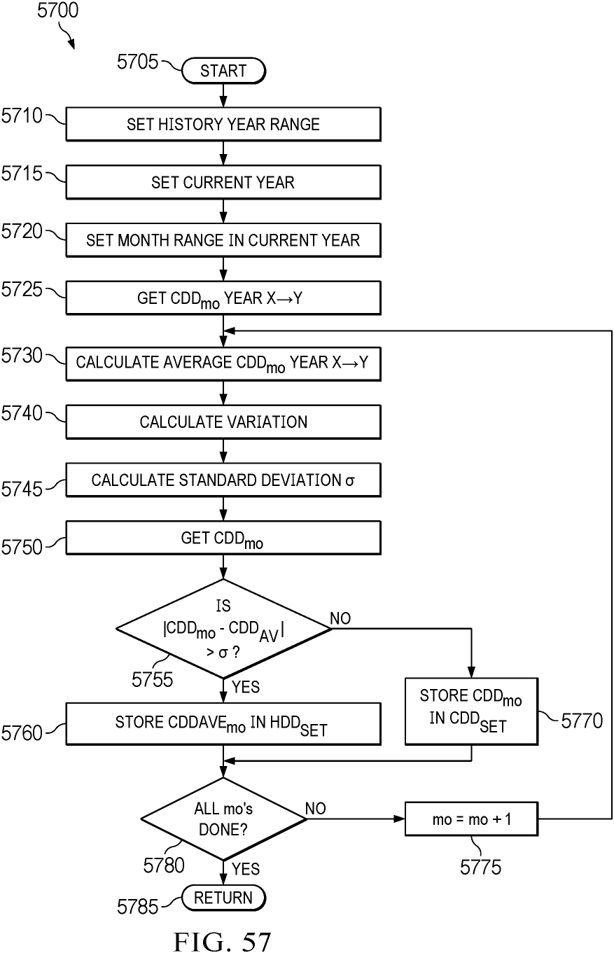

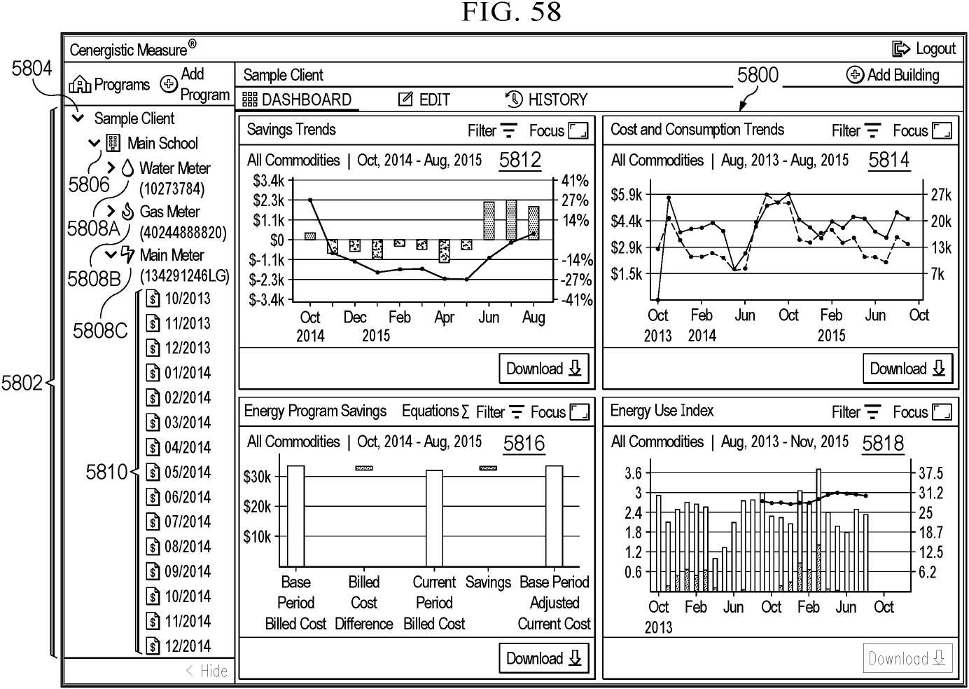

Referring then to FIG. 57, a method of loading a set of monthly cooling degree days, as described at step 642, will be further described.

In general, method 5700 derives an average set of cooling degree days for each month based on an average of the cooling degree days from a historical period. The cooling degree days for each month are averaged, year over year, from the set of historical data. In a preferred environment, the historical data is downloaded from Weather Stack, Inc. of Vienna, Austria. In this way, if the cooling degree day for any month in the weather model for the current year is an aberration of more than one standard deviation, σ, from the average, it is replaced by the average value in order to make the weather model subject to fewer aberrations and therefore, more accurate.

At step 5705, method 5700 begins.

At step 5710, a history year range, X to Y, is set. For example, a historical year range between the year 2000 and the year 2021.

At step 5715, the current year is identified, for example, the current year may be 2022.

At step 5720, a month range is set for the current year, for example, January through December.

At step 5725, the cooling degree data for the first month in the month range is uploaded for each year in the history year range and stored in memory.

At step 5730, the average cooling degree day value for the first month of each year in the year range is determined, according to the following equation.

$$A V E C D {D}_{M O} = \frac{{\sum }_{x}^{y} C D {D}_{M O}}{\left(y - x\right)}$$

Where:
CDD_{MO} = cooling degree days for specified month “MO”;
x = beginning year in year range; and
y = ending year in year range.

At step 5740, variation, σ², is calculated by summing the deviations in the number of cooling degree days for the specified month in the year range and divided by the number of years in the year range, according to the following equation.

$$\left(V A R C D D\right) {σ}^{2} = \frac{{\sum }_{x}^{y} {\left(C D {D}_{M O} - A V E C D D\right)}^{2}}{\left(y - x\right)}$$

Where:
CDD_{MO} = cooling degree days for specified month “MO”;
AVECDD_{MO} = average cooling degree days for specified month “MO”;
x = beginning year in year range; and
y = ending year in year range.

At step 5745, the standard deviation is calculated according to the following equation.

$$σ = \sqrt{{σ}^{2}}$$

At step 5750, the current cooling degree days for the specified month “MO” is retrieved from memory.

At step 5755, the absolute value of the difference between the number of cooling degree days for the specified month and average number of cooling degree days is compared to the standard deviation. If the absolute value is greater than the standard deviation, the method moves to step 5760. If the absolute value is less than the standard deviation, the method moves to step 5760.

At step 5760, the method stores, the cooling degree day average for the specified month in the CDD set in memory.

At step 5770, the method stores, the number of cooling degree days for the specified month in the cooling degree day set.

At step 5780, a determination is made as to whether or not all months in the month range have been examined. If so, the method moves to step 5785. If not, the method moves to step 5775.

At step 5775, the method advances to the next month in the month range and returns to step 5730.

At step 5785, the method returns the cooling degree day set as the set of monthly cooling degree days.

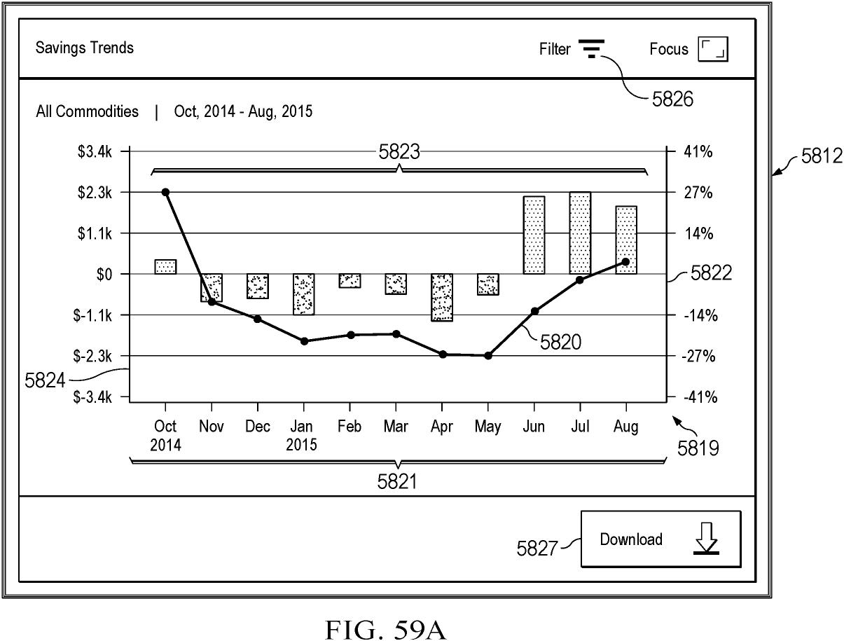

Referring to FIG. 58, display system 5800 will be further described. In one preferred embodiment, system and savings data is displayed on display 170 of dedicated calculation processor 150. Data is accessed through hierarchical tree structure 5802. User ID 5804 allows the client to select which user account is accessed. Building 5806 and individual utility meters 5808A, 5808B and 5808C are listed beneath each user ID. Utility bill data 5810 is stored under the utility meter level, as it was billed from the energy provider.

Display system 5800 includes display selections, namely savings trend functional card 5812, cost and consumption trends functional card 5814, energy program savings functional card 5816 and energy use index functional card 5818. The functional cards display elements populated with data based on the user ID selection.

The energy program savings cards are a simple display method showing the user raw unadjusted utility savings and adjusted utility savings. They provide the equations used to calculate savings, any adjustments made to the data and impacts of utility cost changes in the savings. All source data for the position on the trees and filters set, can be accessed via links. This configuration opens the calculation to full verification.

The system calculates consumption reduction as the primary representation of savings denoted as a “savings calculation”. Consumption reduction is valued as savings using the twelve month rolling average cost of the energy commodity, or the All-In-Rate. The savings calculation has the following basic components.

The system provides “date normalization” utility companies do not bill on the same days of the month. Additionally, the billing days in an individual utility bill varies significantly month over month. The system divides each base year bill into daily consumption units for each day. This allows the current billing period to be compared to the exact same billing period days in the base year. An example is shown below in Table 1.

TABLE 1

| | |
|---|---|
| Jan Base Year Bill Consumption (Jan. 5, 2020 to Feb. 1, 2020 (27 days)) | 30,000 |
| Feb Base Year Bill Consumption (Feb. 1, 2020 to Mar. 5, 2020 (33 Days)) | 30,000 |
| Jan Base Year Bill Daily Units (30,000 / 27 days) | 1,111.11 |
| Feb Base Bill Daily Units (30,000 / 33 Days) | 909.09 |
| Current Bill (Jan. 15, 2021 to Feb. 5, 2021 (21 Days) | 20,000 |
| Assembled Base Years Bill | |
| Jan Base Year Consumption (17 days * 1,111,11) | 18,888.87 |
| Feb Base Year Consumption (4 days * 909.09) | 3,636.36 |
| Base Years Consumption | 22,525.23 |
| Consumption Savings | 2,525.23 |

The system values the consumption of the “All-In-Rate” and displays it. TheAll-In-Rate is the last twelve months’ cost (months prior to the current billing) divided by the last twelve months consumption. This arrives at the annual average cost per unit or the All-In-Rate.

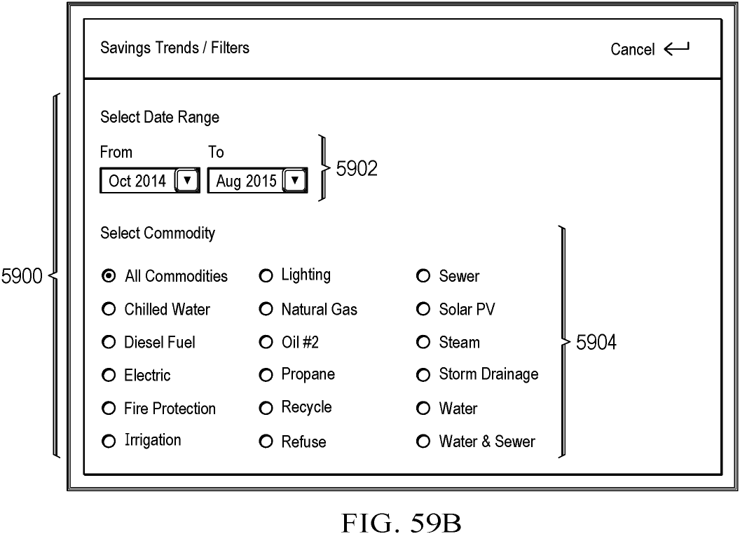

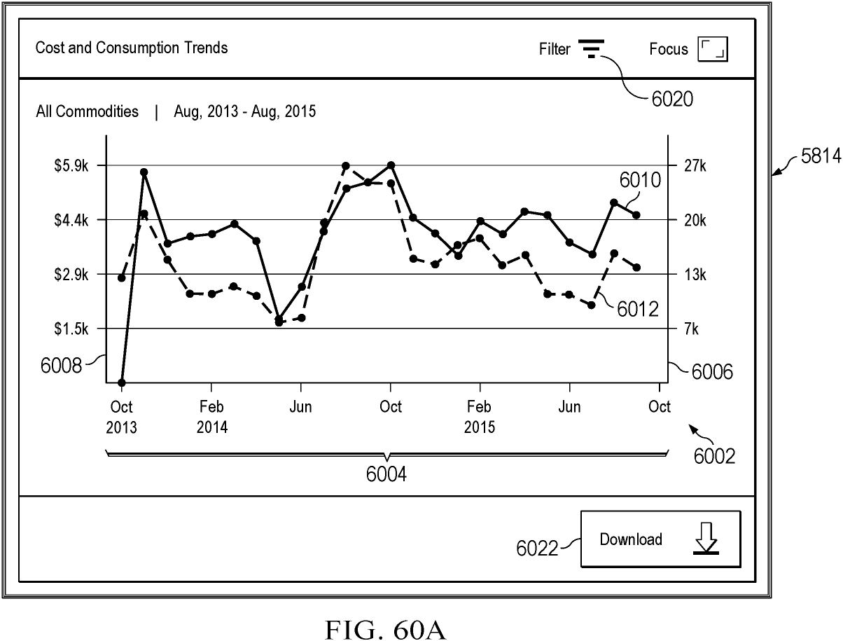

Referring then to FIG. 59A, savings trend functional card 5812 and displayed graph 5819. Graph 5819 is comprised of a date range 5821 shown along the x-axis. Vertical axis 5822 indicates percentage savings. Trend line 5820 is provided, which connects data points, showing cumulative savings as accumulated for each month during date range 5821. Graph 5819 further includes bar graph data 5823, which indicates monthly savings for each month during date range 5821. Vertical axis 5824 indicates the dollar value corresponding to the bar graph data 5823.

Savings trend functional card 5812 is further provided with filter button 5826. When filter button 5826 is chosen, available filters which affect the display of graph 5819 are displayed.

Download button 5827, and one preferred environment creates a summary report of the data which is exported to the administrator device via the RF transceiver.

Referring then to FIG. 59B, filters 5900 will be further described.

Filters 5900 include date range 5902. Date range 5902 is reflected on graph 5819 along the x-axis. Filters 5900 further include commodity selections 5904. In one preferred embodiment, when individual commodity selections are made from commodity selections 5904, each bar in the bar graph is segmented to identify which commodity is displayed. When multiple commodity selections have been made each bar in the bar graph accumulates the savings for each selected commodity.

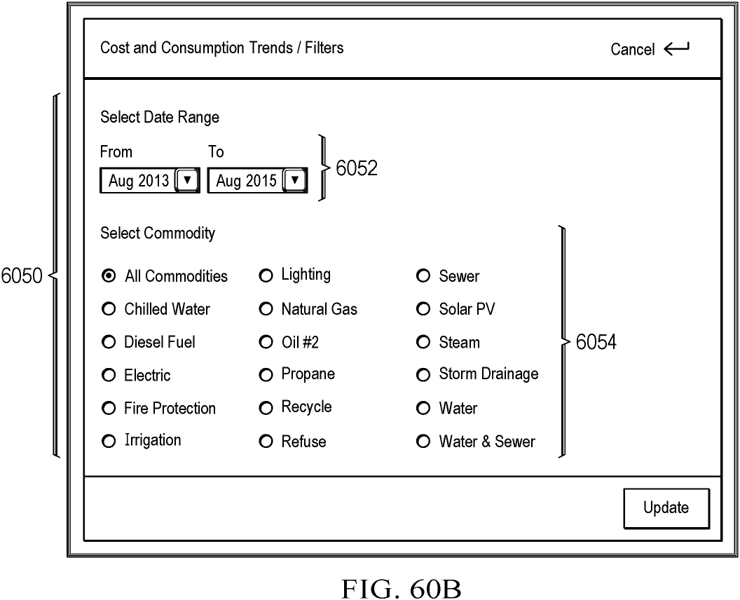

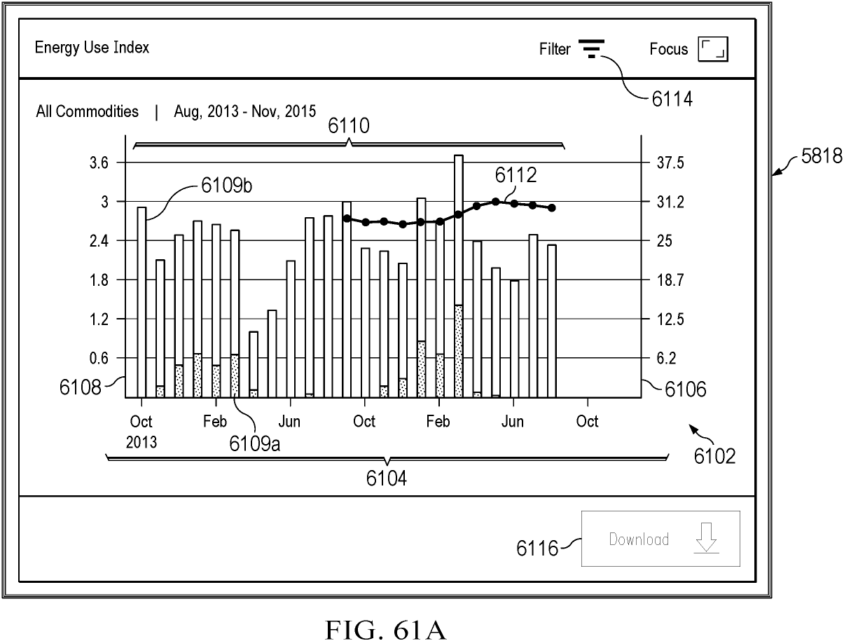

Referring to FIG. 60A, cost and consumption trends functional card 5814 will be further described.

Cost and consumption trends functional card 5814 includes graph 6002. Graph 6002 includes date range 6004 along the x-axis.

Vertical axis 6008 displays a range of costs in dollars. Display line 6012 indicates unadjusted utility bill data for cost data for each month of the date range. Vertical axis 6006 displays a range of commodity usage. Consumption trend line 6010 displays commodity usage for each month during the date range.

In kilo British thermal units or kBTU, utility commodity are converted by the display to the standard unit of kBTU. If any utilities cannot be converted to kBTU (for example, water), the consumption trend line will not be displayed.

Cost and consumption trends functional card 5814 includes filter button 6020. When filter button 6020 is selected, filters are displayed which allow different data to be chosen for display, as will be further described.

Cost and consumption trends functional card 5814 further comprises download button 6022. When download button 6022 is selected, the data which generates graph 6002 is uploaded to the administrator device through the RF transceiver.

Referring then to FIG. 60B, filters 6050 will be further described. Filters 6050 includes date range filters 6052. Date range filters 6052, select which date range shown in date range 6004. Filters 6050 further comprises commodity selection 6054. Allowing selection of different utility commodities used to generate consumption trend line 6010.

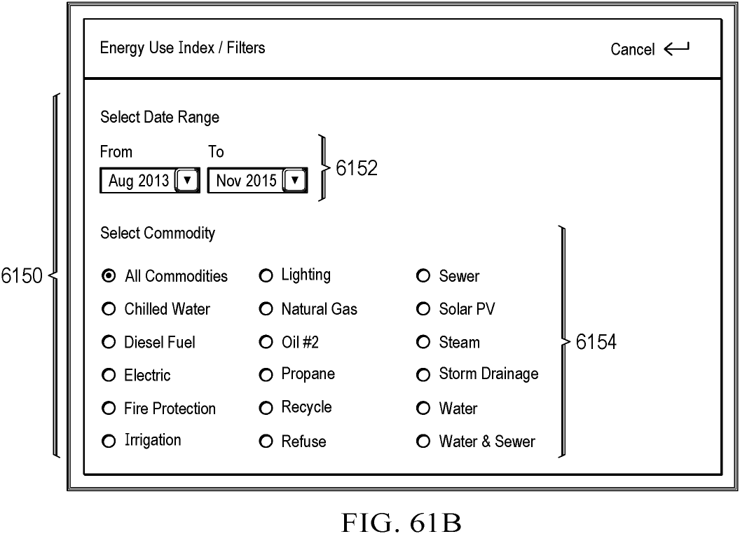

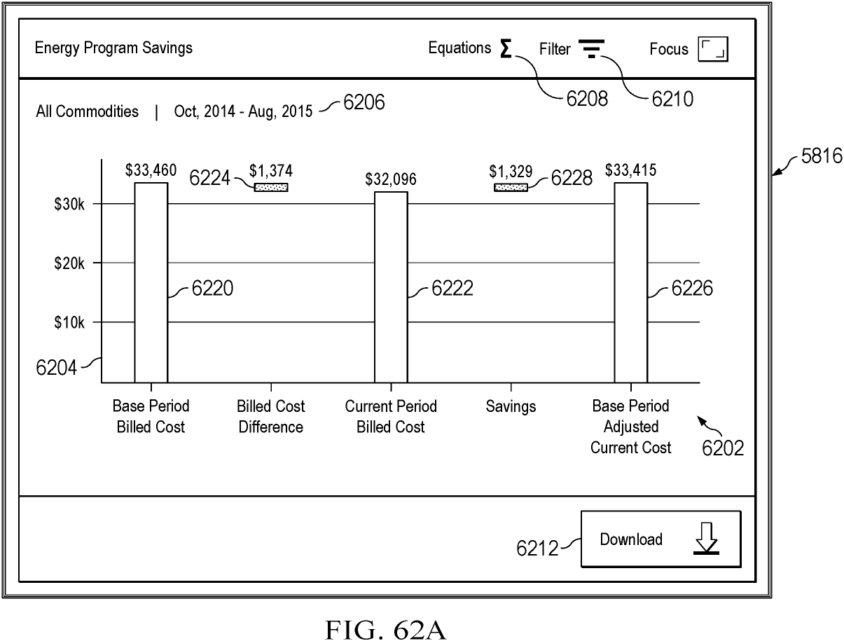

Referring to FIG. 61A, energy use index functional card 5818 will be further described. The energy use index functional card 5818 displays the Energy Use Index (“EUI”) which is energy use expressed as the amount of energy used per gross square foot of building per year. Monthly energy use is converted to a common unit of measure, e.g. kBTU. The formula is as follows:

$$\begin{matrix}M o n t h l y E U I = M o n t h l y e n e r g y c o n s u m p t i o n \left(k B T U\right) \\ / B u i l d i n g g r o s s s q u a r e f o o t a g e\end{matrix}$$

$$A n n u a l E U I = S u m o f t w e l v e m o n t h s m o n t h l y E U I c a l c u l a t i o n s$$

$$\begin{matrix}R o l l i n g E U I = S u m o f t h e l a s t t w e l v e m o n t h s m o n t h l y E U I \\ c a l c u l a t i o n s\end{matrix}$$

Energy use index functional card 6100 includes graph 6102. Graph 6102 includes date range 6104, along the x-axis. Vertical axis 6108 displays monthly EUI value in an appropriate scaled range. Bar graph data 6110 displays monthly EUI values in bar chart form. Each bar in the bar graph data 6110 is a cumulative monthly EUI value, which includes all commodity selections, as will be further described. In this example, each bar displays natural gas portion 6109a and electricity portion 6109b.

Graph 6102 further comprises vertical axis 6106 indicating the ruling EUI or the sum of the last 12 months. Monthly EUI totals range of totals. Graph 6102 further includes trend line 6112, which represents the rolling 12 months EUI.

Energy use index functional card 6100 includes filter button 6114. When filter button 6114 is selected, filters are displayed which allow the user to select which data is displayed in graph 6102.

Energy use index functional card 6100 further includes download button 6116. When download button 6116 is selected, data producing graph 6102 is uploaded to the administrator device through the RF transceiver.

Referring to FIG. 61B, filters 6150 will be further described. Filter 6150 controls the date which is displayed on graph 6102. Filter 6150 includes date range filter 6152. Date range filter 6152 controls the date range displayed at date range 6104.

Commodity selections 6154 control the commodities which are added to produce each bar graph in bar graph data 6110. Each commodity selection is displayed in a separate section of each bar of bar graph data 6110.

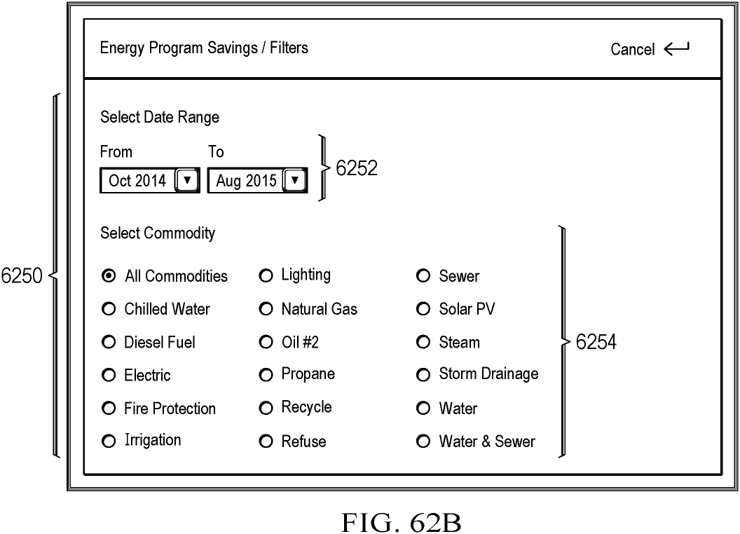

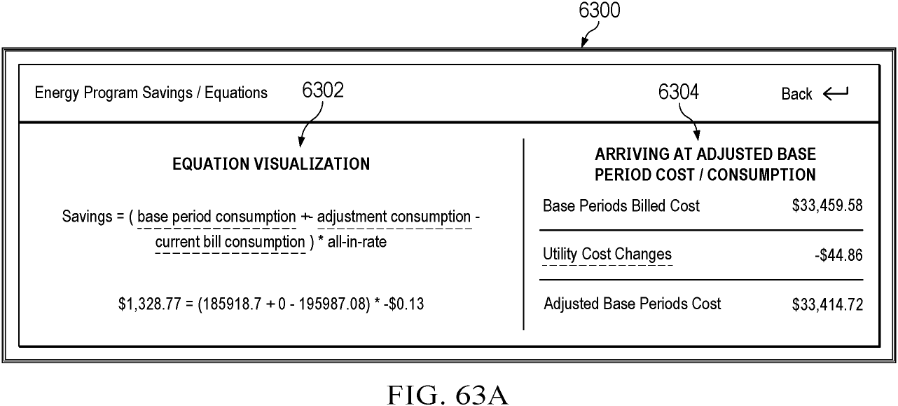

Referring to FIG. 62A, energy program savings functional card 5816 will be further described. Energy program savings functional card 5816 displays applicable date range 6206. Graph 6202 includes vertical axis 6204, showing dollar amounts. “Base Period Billed Cost” 6220 bar displays the aggregate utility bills for the base period from the utility provider data. The base period is the historical past period. “Current Billed Cost” bar 6222 displays the current billing period’s aggregate utility bills. “Billed Cost Difference” bar 6224 displays the mathematical difference between the Base Period Billed Cost and the Current Period Billed Cost known as “unadjusted savings.” “Base Period Adjusted Current Cost” bar 6226 displays the base period billed cost, but changed to reflect physical differences in the building and mechanical systems between the base configuration and the current configuration. “Savings” bar 6228 reflects the mathematical difference between the current period billed cost and the base period adjusted current cost.

Energy program savings functional card 5816 further comprises filter button 6210. When selected, filter button 6210 allows configuration of date ranges and commodities as will be further described. Energy program savings functional card 5816 further comprises download button 6212. When download button 6212 is selected, the data which produces energy program savings functional card 5816 is uploaded to the administrator device through the RF transceiver.

Energy program savings functional card 5816 further comprises equations button 6208. When equations button 6208 is selected, a series of equations is displayed, as will be further described.

Referring then to FIG. 62B, filters 6250 will be further described.

Filters 6250 includes date range filter 6252 and commodities filter 6254. Date range filter 6252, the date range for the current period billed cost.

Filter 6250 further comprises commodities filter 6254. Commodities filter 6254 allows selection of which commodities are included in the aggregate total for the base period bill cost, the current bill cost, and the base period adjusted current cost.

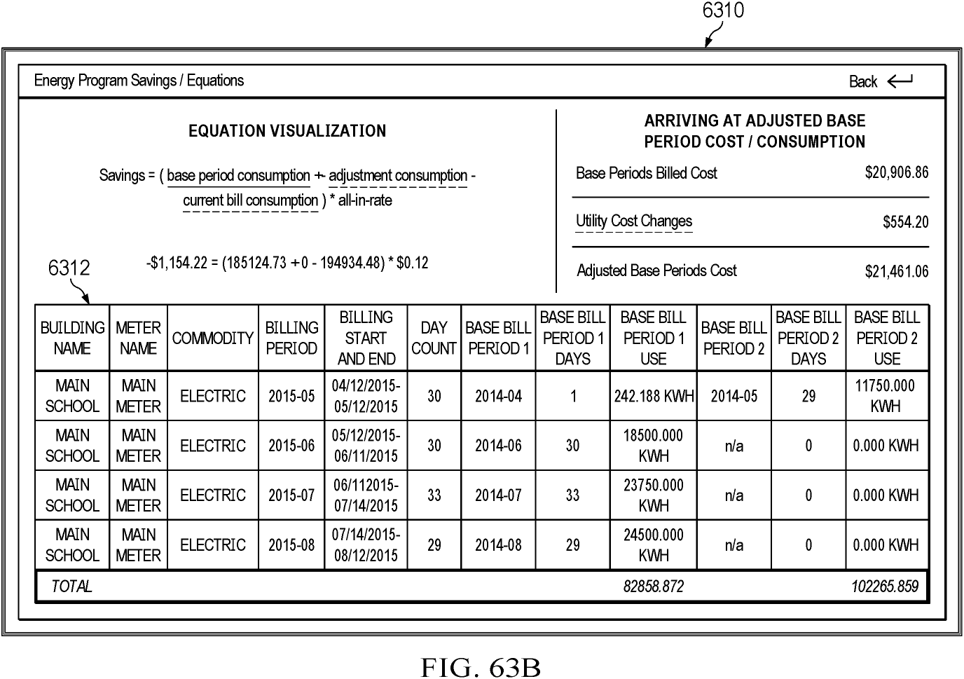

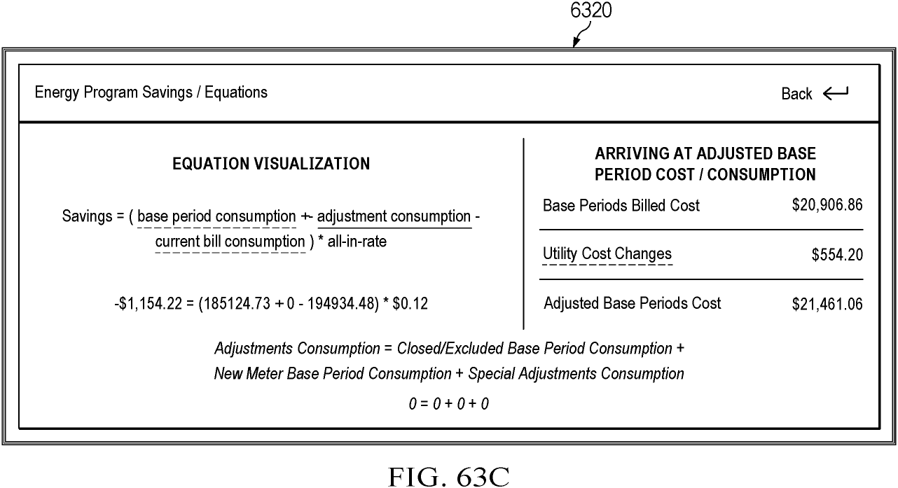

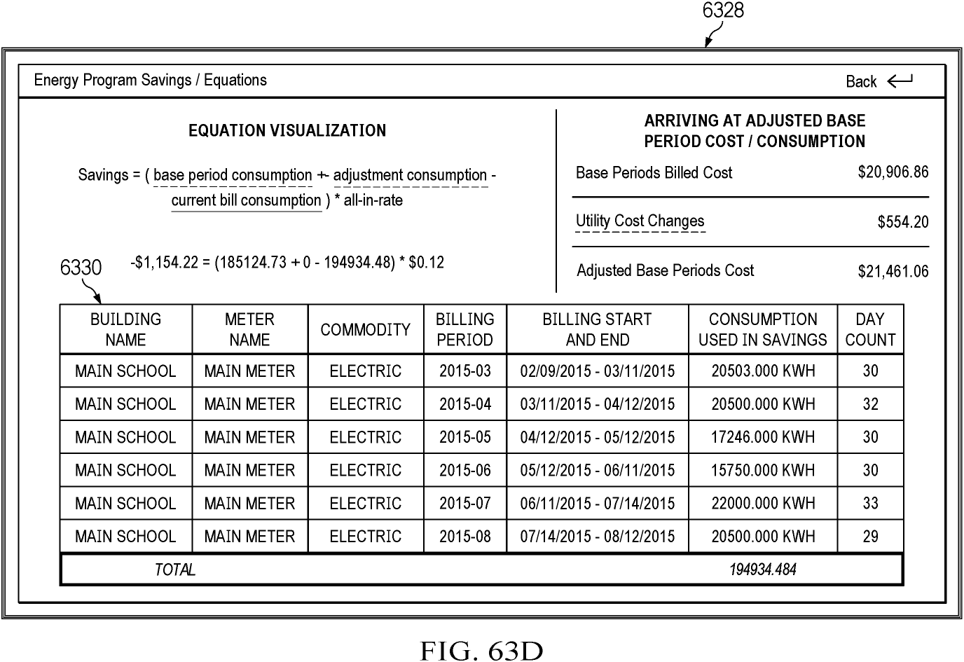

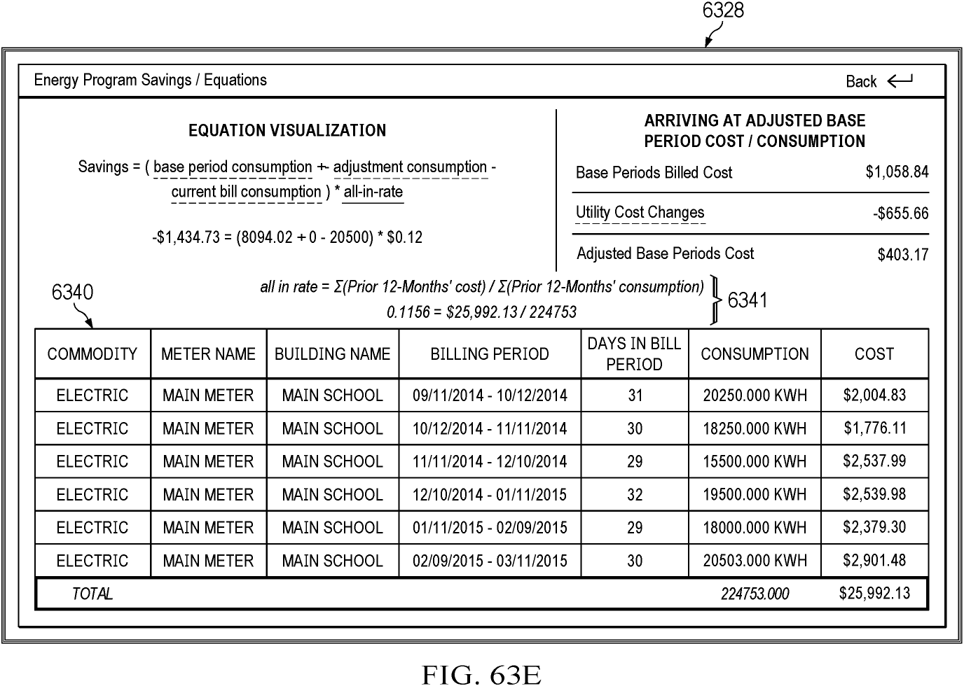

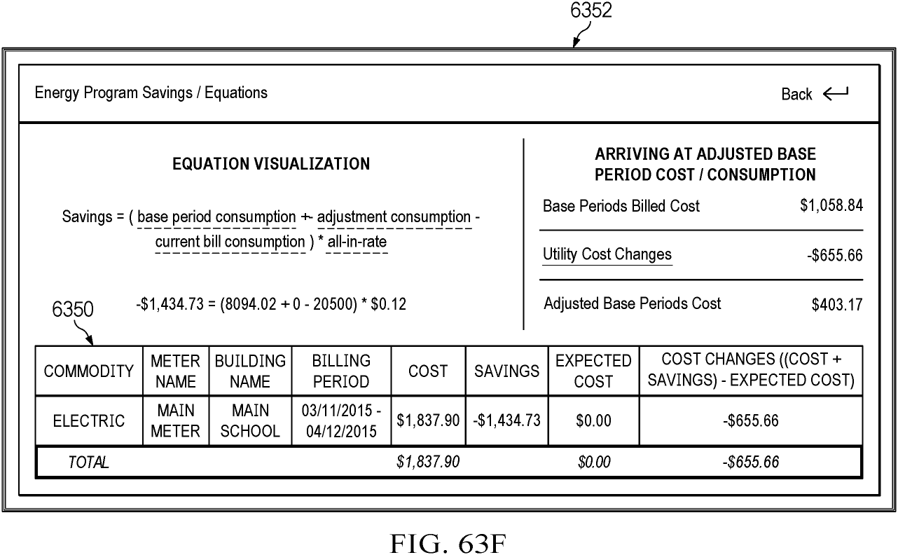

Referring to FIGS. 63A, 63B, 63C, 63D, 63E and 63F, various equations are displayed when equations button 6208 is selected.

Referring to FIG. 63A, the energy program savings equations will be further described.

Energy program savings and equations display 6300 includes equation visualization section 6302 and arriving at adjusted base cost consumption section 6304. Equation visualization section 6302 reflects the following equation.

$$\begin{matrix}S a v i n g s = \left(b a s e p e r i o d c o n s u m p t i o n + a d j u s t m e n t c o n s u m p t i o n\right) \\ \left(- c u r r e n t b i l l c o n s u m p t i o n\right) \times a l l - i n - r a t e\end{matrix}$$

Where:
Base period consumption is the base period billed cost;
Adjustment consumption is the changes made to reflect the physical differences in the building and mechanical system from the base period to the current period;
Current bill consumption is the current period of billed cost; and
All-in rate is the utility bill cost for the date range divided by the utility consumption for the date range.

Arriving at adjusted base period cost consumption section 6304 displays the base period’s billed cost, the utility cost changes, and the adjusted base period’s cost.

Each variable in the equation is an active link which shows the source data used to calculate that variable.

Referring then to FIG. 63B, display 6310 is shown when the active link on the variable base period consumption is selected.

Display 6310 includes data table 6312. Data table is 6312 displays utility consumption data for utility bills for the base period.

Referring to FIG. 63C, when the active link associated with “the adjustment consumption” variable in the equation is selected display 6320 is shown.

“Adjusted Consumption” link displays any consumption adjustments entered into the database. The adjustments include any new meters not included in the base year, any meters that were included in the base year but are not in the current month’s consumption and any special adjustments applied to the data. All adjustments are applied as consumption adjustments to the baseline. Adjustments are performed for any event outside the energy program. Adjustment categories are as follows: Efficiency Upgrades, Operational Changes, Square Footage Changes and Weather Changes. In this example, there are no adjustments. Special adjustments may also account for efficiency upgrades.

Referring to FIG. 63D, when the “Current Bill Consumption” variable link is selected, consumption data from utility bills for the current billing period is displayed in table 6330 in display 6328.

Referring to FIG. 63E, an example of an individual bill of the “All-In-Rate” link displays the data used to calculate the All-In-Rate in table 6340 in display 6328. The equation used to determine the variable All-In-Rate is shown at 6341.

Referring to FIG. 63F, “Utility Cost Changes” link displays the rate changes cost occurring between the base utility billing period and the current billing period in table 6350 of display 6352.

While this invention has been described in reference to a preferred embodiment along with other illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A system for analyzing energy savings of a building energy savings changes comprising:
an energy provider processor, for collecting and storing low integrity energy usage data in a mass storage database;
a data correction processor, operatively connected to the mass storage database, having a first memory;
a dedicated savings calculation processor, operatively connected to the data correction processor, having a second memory; and
the first memory and the second memory including a set of program instructions that when executed cause the system to perform the steps of:
receiving, at the data correction processor, the low integrity energy usage data from the mass storage database;
correcting the low integrity energy usage data, by interpolation to replace at least one missing data point, to derive a first metered energy usage, for the building, for a first time period prior to the energy saving changes;
simulating a hypothetical energy usage, at the dedicated savings calculating processor, for the first time period, to derive a baseline simulation;
calibrating the baseline simulation against the first metered energy usage to derive a calibrated simulation;
identifying an energy usage aberration unrelated to the energy saving changes in a second time period after the first time period;
adjusting the calibrated simulation to account for the energy usage aberration, to derive an adjusted calibrated simulation;
receiving a second metered energy usage, for the building, for the second time period;
comparing the second metered energy usage to the adjusted calibrated simulation;
identifying a difference between the second metered energy usage and the adjusted calibrated simulation; and
calculating an energy savings based on the difference.

2. The system of claim 1, wherein the step of simulating the hypothetical energy usage comprises the further steps of:
applying a set of simulation parameters.

3. The system of claim 2, wherein the set of simulation parameters further comprise:
a set of weather data for the building;
a set of operations parameters for the building; and
a set of physical parameters for the building.

4. The system of claim 3, wherein the set of program instructions further comprises instructions that when executed cause the system to perform the steps of:
deriving the set of weather data by setting a year range;
setting a month designation;
summing a number of heating degree days for each month designation in the year range;
determining an average number of heating degree days for each month designation in the year range;
determining a variation in the number of heating degree days;
determining a standard deviation in the number of heating degree days;
comparing the standard deviation to an absolute value of a difference between the number of heating degree days and the average number of heating degree days;
if the absolute value is greater than the standard deviation, then storing the average number of heating degree days in the set of weather data; and
if the absolute value is not greater than the standard deviation, then storing the number of heating degree days in the set of weather data.

5. The system of claim 3, wherein the set of program instructions further comprises instructions that when executed cause the system to perform the steps of:
deriving the set of weather data by setting a year range;
setting a month designation;
summing a number of cooling degree days for each month designation in the year range;
determining an average number of cooling degree days for each month designation in the year range;
determining a variation in the number of cooling degree days;
determining a standard deviation in the number of cooling degree days;
comparing the standard deviation to an absolute value of a difference between the number of cooling degree days and the average number of cooling degree days;
if the absolute value is greater than the standard deviation then storing the average number of cooling degree days in the set of weather data; and
if the absolute value is not greater than the standard deviation then storing the number of cooling degree days in the set of weather data.

6. The system of claim 3, wherein the set of simulation parameters further comprise:
at least one energy usage function.

7. The system of claim 6, wherein the at least one energy usage function further comprises:
a first electrical energy consumption function, related to the set of simulation parameters, for a set of lighting systems of a building;
a second electrical energy consumption function, related to the set of simulation parameters, for a set of plug loads of the building;
a third electrical energy consumption function, related to the set of simulation parameters, for a set of heating systems of the building;
a fourth electrical energy consumption function, related to the set of simulation parameters, for a set of cooling systems of the building;
a fifth electrical energy consumption function, related to the set of simulation parameters, for a set of hot water systems of the building;
a sixth electrical energy consumption function, related to the set of simulation parameters, for a set of fans of the building; and
a seventh electrical energy consumption function, related to the set of simulation parameters, for a set of pump motors of the building.

8. The system of claim 7, wherein the step of calibrating the baseline simulation further comprises:
applying a validation tolerance for a third time period;
deriving a comparison between the baseline simulation to the first metered energy usage for the third time period;
if the comparison fails to meet the validation tolerance, then adjusting the baseline simulation; and
if the comparison meets the validation tolerance, then identifying the baseline simulation as the calibrated simulation.

9. The system of claim 8, wherein the step of identifying the energy usage aberration further comprises:
identifying an energy usage condition during the second time period that did not exist during the first time period.

10. The system of claim 9, wherein the step of adjusting the calibrated simulation further comprises:
modifying a set of simulation parameters, for the calibrated simulation, corresponding to the energy usage condition.

11. The system of claim 8, wherein the step of calculating the energy savings further comprises:
subtracting the second metered energy usage from the adjusted calibrated simulation.

12. The system of claim 11, wherein the set of program instructions further comprise instructions that when executed cause the system to perform the steps of:
generating a set of energy program savings cards to display the energy savings.

13. The system of claim 12, wherein the set of energy program savings cards further comprises one of a group of a savings trends card, a cost and consumption trends card, an energy program savings card, and an energy use index card.

14. The system of claim 13, wherein the savings trends card further comprises:
a cumulative savings display and a monthly savings display; and
a data selection switch for modifying an input data set related to the cumulative savings display and the monthly savings display.

15. The system of claim 13, wherein the cost and consumption trends card further comprises:
an unadjusted utility bill data display and a commodity usage display; and
a data selection switch for modifying an input data set related to the unadjusted utility bill data display and the commodity usage display.

16. The system of claim 13, wherein the energy use index card further comprises:
a monthly energy use index display and a rolling annual energy use index; and
a data selection switch for modifying an input data set related to the monthly energy use index display and the rolling annual energy use index.

17. The system of claim 13, wherein the energy program savings card further comprises a display of:
a base period billed cost;
a current period billed cost;
a base period adjusted current cost;
a first difference between the base period billed cost and the current billed cost; and
a second difference between the current period billed cost and the base period adjusted current cost.

18. The system of claim 17, wherein the energy program savings card further comprises: an energy program savings equation display;
a base period consumption display;
an adjustment consumption display;
a current bill consumption display; and
an all-in-rate display.

19. The system of claim 18, wherein the energy program savings equation display further comprises a first equation of the form:
$$\begin{matrix}s a v i n g s = \left(b a s e p e r i o d c o n s u m p t i o n + a d j u s t m e n t c o n s u m p t i o n\right) \\ \left(- c u r r e n t b i l l c o n s u m p t i o n\right) \times a l l - i n - r a t e .\end{matrix}$$
.

20. The system of claim 19, wherein the all-in-rate display is calculated by a second equation of the form:
$$a l l - i n - r a t e = \frac{\sum \left(p r i o r 12 m o n t h ' s c o s t\right)}{\sum \left(p r i o r 12 m o n t h ' s c o n s u m p t i o n\right)} .$$
.
